(19) United States
(12) Patent Application Publication
(10) Pub. No.: US 2026/0303599 A1
(43) Pub. Date: Oct. 1, 2026

(54) SYSTEMS AND METHODS FOR CONTROLLING ACCESS TO A DIGITAL TWIN OF A CHEMICAL PRODUCT

(71) Applicant: BASE SE, Ludwigshafen am Rhein (DE)

(72) Inventors: Felipe BUSTILLO MEDINA, Madrid (ES); George Valentin UTUTUI, Madrid (ES); Guel BEKCIOGLU-NEFF, Ludwigshafen am Rhein (DE); Gabriele ECKARDT, Ludwigshafen am Rhein (DE); Claudia Elena HERRERA GARCIA, Madrid (ES); Carsten HOFF, Ludwigshafen am Rhein (DE)

(21) Appl. No.: 19/474,873

(22) PCT Filed: Mar. 28, 2024
(86) PCT No.: PCT/EP2024/058428

§ 371 Date: Oct. 13, 2025

(30) Foreign Application Priority Data
Apr. 12, 2023 (EP) 23167518.2

(51) Int. Cl. H04L 9/40

(52) U.S. Cl. CPC H04L 63/10

(57) ABSTRACT

The present disclosure relates to an apparatus and a system for controlling access to a digital twin of a physical entity of a chemical product produced from one or more chemical input materials and a respective computer program element, a computer-implemented method for controlling access to a digital twin of a physical entity of a chemical product produced from one or more chemical input materials and a respective computer program element, a computer-implemented method for authorizing access by a decentral data providing network node to a digital twin of a physical entity of a chemical product, respective apparatuses and a respective computer program element, a computer-implemented method for processing a digital twin or a part thereof of a physical entity of a chemical product and a respective computer program element, and a computer-implemented method for authorizing access to a digital twin or a part thereof of a physical entity of a chemical product by a decentral data consuming network node using a digital access element associated with the chemical product and a respective computer program element.

### TECHNICAL FIELD

The present disclosure relates to an apparatus and a system for controlling access to a digital twin of a physical entity of a chemical product produced from one or more chemical input materials and a respective computer program element, a computer-implemented method for controlling access to a digital twin of a physical entity of a chemical product produced from one or more chemical input materials and a respective computer program element, a computer-implemented method for authorizing access by a decentral data providing network node to a digital twin of a physical entity of a chemical product, respective apparatuses and a respective computer program element, a computer-implemented method for processing a digital twin or a part thereof of a physical entity of a chemical product and a respective computer program element, and a computer-implemented method for authorizing access to a digital twin or a part thereof of a physical entity of a chemical product by a decentral data consuming network node using a digital access element associated with the chemical product and a respective computer program element.

### TECHNICAL BACKGROUND

In the supply of chemical products multiple regulatory requirements need to be met, which differ depending on the chemical product. For instance, in automotive supply chains chemical companies provide standardized information using the International Chemical Product Data System (IMDS). Such system allows to collect data along the entire automotive supply chain. Participants in the automotive supply chain register with the IMDS service and maintain product entries in the central database as provided and hosted by a third-party provider.

Systems like IMDS are static regarding data, prone to error and cumbersome in handling or maintenance. Owing to the highly specific and centralized setup of such systems, exchange and sharing of chemicals data is laborious. Hence, there is a need to simplify and/or customize sharing or exchange of chemical product data from chemical industry to chemical supply chain participants while allowing the data owner of the chemical product data to control the access to said data.

### SUMMARY OF THE INVENTION

In an aspect, the disclosure relates to an apparatus for controlling access to a digital twin of a physical entity of a chemical product produced from one or more chemical input materials, wherein the access to the digital twin by one or more decentral data consuming network node(s) of a decentral network is controlled by a decentral data providing network node associated with the digital twin and wherein the digital twin includes a decentral digital twin identifier and at least one measured physical and/or chemical property of the chemical product and/or at least one physical and/or chemical property determined from collected data associated with the production and/or the use of the chemical product, the apparatus comprising:
at least one decentral digital twin identifier providing unit configured to provide the decentral digital twin identifier,
at least one mapping data providing unit configured to provide mapping data including data related to the chemical product produced from the one or more chemical input materials interrelated with respective decentral participant identifier(s) associated with decentral participant node(s), wherein the mapping data is generated from the data related to the chemical product produced from the one or more chemical input materials and data related to the decentral participant node(s),
at least one access data generating unit configured to generate access data for at least part of the digital twin based on the mapping data, wherein the access data include the decentral digital twin identifier and one or more authorization rule(s) associated with the decentral digital twin identifier, wherein the one or more authorization rule(s) define access to and/or usage of at least part of the digital twin for decentral data consuming network node(s) associated with the decentral participant identifier(s) included in the mapping data,
the decentral data providing network node associated with the digital twin, wherein the decentral data providing network node is configured to control access by the one or more decentral data consuming network node(s) to at least part of the digital twin according to the generated access data.

In another aspect, the disclosure relates to a system for controlling access to a digital twin of a physical entity of a chemical product produced from one or more chemical input materials, wherein the access to the digital twin by one or more decentral data consuming network node(s) of a decentral network is controlled by a decentral data providing network node associated with the digital twin and wherein the digital twin includes a decentral digital twin identifier and at least one measured physical and/or chemical property of the chemical product and/or at least one physical and/or chemical property determined from collected data associated with the production and/or the use of the chemical product, the system comprising:
optionally a digital twin provider layer configured to provide the digital twin of the physical entity of the chemical product,
an access provider layer configured to
   to provide the decentral digital twin identifier included in the digital twin
   provide mapping data including data related to the chemical product produced from the one or more chemical input materials interrelated with respective decentral participant identifier(s) associated with decentral participant node(s), wherein the mapping data is generated from the data related to the chemical product produced from the one or more chemical input materials and data related to the decentral participant node(s),
   generate access data for at least part of the digital twin based on the mapping data, wherein the access data include the decentral digital twin identifier and one or more authorization rule(s) associated with the decentral digital twin identifier, wherein the one or more authorization rule(s) define access to and/or usage of at last part of the digital twin for decentral data consuming network node(s) associated with the decentral participant identifier(s) included in the mapping data, and
   control—by the decentral data providing network node according to the generated access data—access by the one or more decentral data consuming network node(s) to at least part of the digital twin.

In an aspect the disclosure relates to a computer-implemented method for controlling access to a digital twin of a physical entity of a chemical product produced from one or more chemical input materials, wherein the access to the digital twin by one or more decentral data consuming network node(s) of a decentral network is controlled by a decentral data providing network node associated with the digital twin and wherein the digital twin includes a decentral digital twin identifier and at least one measured physical and/or chemical property of the chemical product and/or at least one physical and/or chemical property determined from collected data associated with the production and/or the use of the chemical product, the method comprising:
providing the decentral digital twin identifier,
providing mapping data including data related to the chemical product produced from the one or more chemical input materials interrelated with respective decentral participant identifier(s) associated with decentral participant node(s), wherein the mapping data is generated from the data related to the chemical product produced from the one or more chemical input materials and data related to the decentral participant node(s),
generating access data for at least part of the digital twin based on the mapping data, wherein the access data include the decentral digital twin identifier and one or more authorization rule(s) associated with the decentral digital twin identifier, wherein the one or more authorization rule(s) define access to and/or usage of at last part of the digital twin for decentral data consuming network node(s) associated with the decentral participant identifier(s) included in the mapping data,
providing the generated access data to the decentral data providing network node for controlling access to at least part of the digital twin by the one or more decentral data consuming network node(s) according to the access data.

In yet another aspect the disclosure relates to a computer-implemented method for authorizing access by a decentral data providing network node to a digital twin of a physical entity of a chemical product, wherein the digital twin includes a decentral digital twin identifier and at least one measured physical and/or chemical property of the chemical product and/or at least one physical and/or chemical property determined from collected data associated with the production and/or the use of the chemical product and wherein access data for at least part of the digital twin has been generated and provided to the decentral data providing network node by the apparatus or system for controlling access to the digital twin or according to the computer-implemented method for controlling access to the digital twin, the method comprising:
receiving at the decentral data providing network node a request to access the digital twin or a part thereof from a decentral data consuming network node, the request including the decentral digital twin identifier and a decentral participant identifier associated with the decentral data consuming node,
determining access data based on the received decentral digital twin identifier,
validating the request by applying the at least part of the determined access data to the received request based on the received decentral participant identifier,
if the request is validated, providing the digital twin or a part thereof based on the received decentral digital twin identifier, applying at least part of the determined access data to the provided digital twin or the part thereof, and providing the digital twin or the part thereof according to the applied access data to the decentral data consuming network node, or
if the request is not validated, denying access to the digital twin or the part thereof according to the applied access data.

In yet another aspect, the disclosure relates to an apparatus for authorizing access by a decentral data providing network node to a digital twin of a physical entity of a chemical product, wherein the digital twin includes a decentral digital twin identifier and at least one measured physical and/or chemical property of the chemical product and/or at least one physical and/or chemical property determined from collected data associated with the production and/or the use of the chemical product and wherein access data for at least part of the digital twin has been generated and provided to the decentral data providing network node by the apparatus or system for controlling access to the digital twin or according to the computer-implemented method for controlling access to the digital twin, the apparatus comprising:
a digital twin provider configured to provide the digital twin of the physical entity of the chemical product,
the decentral data providing network node configured to
   receive a request to access the digital twin or a part thereof from a decentral data consuming network node, the request including a decentral digital twin identifier associated with the digital twin and a decentral participant identifier associated with the decentral data consuming node,
   gathering the digital twin or a part thereof from the digital twin provider based on the received decentral digital twin identifier,
   determining, based on the received decentral digital twin identifier and decentral participant identifier, access data and applying the determined access data to the gathered digital twin or the part thereof,
   providing the digital twin or the part thereof according to the applied access data to the decentral data consuming network node or denying access to the digital twin or the part thereof according to the applied access data.

In yet another aspect, the disclosure relates to a computer-implemented method for processing a digital twin or a part thereof of a physical entity of a chemical product, wherein the digital twin includes a decentral digital twin identifier and at least one measured physical and/or chemical property of the chemical product and/or at least one physical and/or chemical property determined from collected data associated with the production and/or the use of the chemical product, the method comprising the steps of:
providing the digital twin or a part thereof to a decentral data consuming network node by the apparatus for authorizing access or via the computer-implemented method for authorizing access disclosed herein,
processing provided the digital twin or the part thereof, and
providing an output based on the processing.

In yet another aspect, the disclosure relates to a computer-implemented method for authorizing access to a digital twin or a part thereof of a physical entity of a chemical product by a decentral data consuming network node using a digital access element associated with the chemical product, wherein the digital twin includes a decentral digital twin identifier and at least one measured physical and/or chemical property of the chemical product and/or at least one physical and/or chemical property determined from collected data associated with the production and/or the use of the chemical product, the method comprising the steps:
providing the digital access element including a decentral passport identifier and digital twin location data, wherein the decentral passport identifier is or is associated with the decentral digital twin identifier,
providing-based on the provided digital access element, the decentral digital twin identifier and a decentral participant identifier associated with a decentral data consuming network node requesting access to the digital twin-access to the digital twin as authorized by the apparatus disclosed herein or via the computer-implemented method disclosed herein.

In another the disclosure relates to a computer element, such as a computer readable storage medium, a computer program or a computer program product, comprising instructions, which when executed by a computing node or a computing system, direct the computing node or computing system to carry out the steps of the computer-implemented methods disclosed herein.

In another aspect the disclosure relates to a computer element, such as a computer readable storage medium, a computer program or a computer program product, comprising instructions, which when executed by the apparatuses or systems disclosed herein, direct the apparatuses or systems to carry out steps the apparatuses or systems disclosed herein are configured to execute.

Any disclosure, embodiments and examples described herein relate to the methods, the systems, apparatuses, and computer elements lined out above and below. Advantageously, the benefits provided by any of the embodiments and examples equally apply to all other embodiments and examples.

### Embodiments

The methods, apparatuses, systems, and computer elements disclosed herein provide an efficient, secure and robust way robust way for sharing or exchanging data associated with chemical products across different decentral network nodes associated with different participants of chemical value chains under control a decentral data providing network node associated with the data owner of the digital twin. In particular, access to the digital twin is controlled by the decentral data providing network node based on the unique relationship between the decentral digital twin identifier and the one or more authorization rule(s). The authorization rule(s) define access to and/or usage of at least part of the digital twin for decentral data consuming network node(s) associated with respective decentral participant identifier(s) and may hence be used to filter the decentral participant node(s) requesting access to the digital twin or a part thereof based on the decentral participant identifier associated with the decentral participant node and the decentral digital twin identifier associated with the digital twin to be accessed. The party controlling the decentral data providing network node, such as the data owner of the digital twin, may hence control access to the digital twin or a part thereof via said decentral data providing network node using the access data based on the decentral participant identifier associated with the decentral data consuming network node requesting access to the digital twin or a part thereof and the decentral digital twin identifier associated with the digital twin to be accessed. By filtering decentral data consuming network node(s) requesting access to the digital twin based on the access data, the digital twin or parts thereof can be securely exchanged and shared under the sovereignty of the data owner of the digital twin and undesired access to the digital twin by decentral network participants via associated decentral data consuming network nodes can be avoided. This allows for controlled access to the digital twin or parts thereof by further upstream participants of the chemical supply chain. Moreover, access to the digital twin or a part thereof by multiple decentral data consuming network nodes associated with different consumers of different chemical products produced by the chemical production and/or different participants of the chemical supply chain can be controlled via the decentral data providing service using the access data and the decentral digital twin identifier. The different access data may be generated for different parts of the digital twin, such as different data sets contained in the digital twin, hence allowing to control the access to the digital twin on a more granular level.

In the following, embodiments of the present disclosure will be outlined by ways of examples. It is to be understood that the present disclosure is not limited to said embodiments and/or examples.

In an embodiment, the digital twin of the chemical product may be a digital representation of a physical entity of the chemical product with a defined semantic description of said physical entity of the chemical product. The digital twin of the physical entity of the chemical product is hence a digital version of said physical entity. Once created, the digital twin can be used to represent the physical entity of the chemical product in a digital representation of a real-world system. The digital twin may be uniquely linked to the physical chemical product via at least the decentral digital twin identifier. The digital twin may be created such that it is identical in form and behavior of the corresponding chemical product. Additionally, the digital twin may mirror the properties of the chemical product during its lifetime. For example, sensors may capture real-time (or near real-time) data, such as transport data or use data, from the physical chemical product to relay it back to a remote digital twin. The digital twin may then be updated to maintain its correspondence to the physical entity of the chemical product. Hence, the digital twin may at any time represent the current state of the physical entity of the chemical product. The digital twin may contain a decentral digital twin identifier. The decentral digital twin identifier may be associated with a physical entity of the chemical product the digital twin is associated with. The decentral digital twin identifier may be associated with the physical entity of the chemical product the digital twin is generated for. The decentral digital twin identifier may be associated with decentral identifiers of chemical materials used to produce the chemical product. The decentral identifier may be associated with products, components, component assemblies and/or end products produced using the chemical product. This allows to track the chemical product within the value chain. The decentral digital twin identifier may or may be assigned to a physical identifier connected to the chemical product. The physical identifier may be any identifier for the produced chemical product, such as a batch number or a part number. The physical identifier may comprise a passive or active element, e.g. bar code, QR-code, RFID-tag, but is not limited thereto. The physical identifier may include markers embedded in materials or similar physical arrangement that allows to digitally identify the chemical product. The digital twin may further contain a chemical product identifier.

The digital twin may be generated by a decentral participant node. The decentral participant node may be in communication with the decentral data providing network node. The decentral participant node may be associated with the decentral data providing network node. The digital twin may be generated by gathering data containing the at least one measured and/or determined physical and/or chemical property, providing a decentral digital twin identifier associated with the gathered data, generating digital twin data by applying at least one aspect model associated with chemical products to the gathered data and generating the digital twin including the provided decentral digital twin identifier and the digital twin data. The aspect model may contain a semantic description of the respective data set. The semantic description may include the structure of at least a portion of the respective data set, and/or properties of the respective data set. The properties of the respective data set may include data types. The properties of the respective data set may include possible or allowable values and/or value ranges. The properties of the respective data set may be a physical unit of parameter(s) described by values contained in the respective data set. At least one aspect model may be related to environmental attribute(s) associated with chemical products. The environmental attribute(s) may relate to recyclate content of chemical products, renewable content of chemical products, bio-based content of chemical products, emission data associated with chemical products and/or certificates associated with chemical products. Use of aspect model(s) related to environmental attribute(s) allows to generate digital twin data reflecting the respective environmental attribute(s) of the chemical product, hence allowing the sharing of said attributes in a secure and efficient manner via the generated digital twin data. One aspect model may be related to exactly one environmental attribute. This may allow to achieve a higher level of granularity concerning the access of environmental attributes associated with the chemical product, thus allowing to define authorization rules for each environmental attribute separately (e.g. via its corresponding data set). One aspect model may be related to at least two different environmental attributes. This may allow to reduce the number of data sets that need to be generated.

The data may be gathered based on a chemical product identifier associated with the chemical product. Gathering the data may include retrieving or receiving the data. For instance, the data may be received or retrieved based on the chemical product identifier. The data may be gathered from one or more distributed data sources, wherein at least one of the distributed data sources contains data instances that relate to said data. The data instances include at least one measured physical and/or chemical property of the chemical product and/or at least one physical and/or chemical property determined from collected data associated with the production of the chemical product. The measured physical and/or chemical property may be measured after production of the chemical product. The determined physical and/or chemical property may be determined from data collected before, during and/or after production of the chemical product.

Digital twin data may be generated by applying the respective retrieved aspect model to the gathered data. The digital twin data may contain one or more data sets having a defined data structure. Each data set may be generated by applying an aspect model to the gathered data. The number of retrieved aspect models may thus equal the number of data sets generated by applying the retrieved aspect models. Each generated data set may contain the data structure and data defined by the respective aspect model used for its generation. Use of at least one aspect model ensures reliable data transfer and compliance with the respective decentralized data standard hence ensuring efficient processing of the transferred data. Each data set may be associated with the decentral digital twin identifier. Each chemical product data set may be associated with a data set identifier. The decentral identifier may include the digital twin identifier and the chemical product data set identifier. This allows to uniquely identify each data set contained in the digital twin by using the digital twin identifier in combination with the data set identifier associated with said data set.

Generating the digital twin may include assigning the decentral digital twin identifier to at least part of the digital twin data. The decentral digital twin identifier may be linked to each of the at least part of the data sets. For instance, the decentral digital twin identifier may be interrelated with each of said data sets. If the decentral digital twin identifier contains digital twin data set identifiers, each digital twin data set identifier may be linked to a data set. Use of a combination of decentral digital twin identifier and digital twin data set identifier hence allows to define authorization rules on data set level, hence allowing a more granular access to digital twin data.

Generating the digital twin may include generating digital twin location data and assigning the generated digital twin location data to the decentral digital twin identifier. Digital twin location data may include a digital representation pointing to the digital twin. Digital twin location data may include digital representation(s) pointing to the data set(s). The digital representations may point directly or indirectly to the storage location of the digital twin/digital twin data. The digital twin location data may be included in the digital twin. The digital twin location data may be assigned to the decentral digital twin identifier. The digital twin location data may be used-in combination with the decentral identifier-to access the digital twin data. For instance, the decentral digital twin identifier and corresponding digital twin location data may be used by a decentral data consuming network node to request the digital twin data, as described later on in relation to the digital access element. The digital twin location data may correspond to a DID document associated with or including the decentral digital twin identifier (e.g. DID) and digital representation(s) pointing to the digital twin data. The DID document or parts thereof may be propagated to a distributed ledger. The DID document or parts thereof may be used to retrieve the digital representation(s) using the DID as described later on.

The digital twin may be generated by the data owner of the digital twin data. The data owner of the digital twin data may be the chemical production producing the chemical product. The data owner of the digital twin data may be the legal entity operating the chemical production producing the chemical product. The data owner of the digital twin data may be the natural person operating the chemical production producing the chemical product. The digital twin may be generated on behalf of the data owner of the digital twin data. For instance, the digital twin may be generated by a third party based on a service provided by the third party to the data owner.

In an embodiment, the chemical product may be a chemical product obtained from at least one chemical reaction using one or more chemical input materials. Chemical reactions may include any chemical reaction commonly known in the state of the art in which the reactants are converted to one or more different chemical products. Chemical reactions may involve the use of catalysts, enzymes, bacteria, etc. to achieve the chemical reaction between the reactants. The chemical product may include natural chemical products. Natural chemical products may include any chemical product that is produced by nature without human interaction or intervention, i.e. any unprocessed chemical substance that is found in nature, such as chemicals from plants, micro-organisms, animals, the earth and the sea or any chemical substance that is found in nature and extracted using a process that does not change its chemical composition. Natural chemical products may include biologicals like enzymes as well naturally occurring inorganic or organic chemical products. Natural chemical products may be isolated and purified prior to their use or they can be used in unisolated and/or unpurified form. Chemical products may be synthetic chemical products. Synthetic chemical products may include chemical products produced with human interaction or intervention. Synthetic chemical products may be produced with the same chemical reactions occurring in nature or with different chemical reactions. The chemical product may include a raw material. The chemical product may include a chemical material produced by reacting at least two raw materials. The chemical product may include a component. The chemical product may include a component assembly. The chemical product may include an end product.

The chemical product may be produced by a chemical production from one or more chemical input materials. The chemical input materials may include raw materials, intermediate chemical products or chemical products received from a supplier. The chemical production may be a chemical production network including multiple interlinked processing steps. The chemical production network may be an integrated chemical production network with interrelated production chains. The chemical production network may include multiple different production chains that have at least one intermediate product in common. The chemical production network may include multiple stages of the chemical value chain. The chemical production network may include multiple production chains that produce from one or more inbound material(s) as input chemical products as output. The chemical production network may include multiple tiers of a chemical value chain. The chemical production network may include a physically interconnected arrangement of production sites. The production sites may be at the same location or at different locations. In the latter case, the production sites may be interconnected by means of dedicated transportation systems such as pipelines, supply chain vehicles, like trucks, supply chain ships or other cargo transportation means. The chemical production may be controlled by an operating system. The operating system may be configured to perform the methods disclosed herein. The operating system may comprise the apparatuses and systems disclosed herein. The chemical product may comprise a physical identifier. The physical identifier may be present on the packaging of the produced chemical product. The physical identifier may be a code, such as a QR code or an embossed code, an NFT tag or the like. The physical identifier may be assigned to the decentral identifier of the digital twin to uniquely link the digital twin and hence the digital twin data with the physical entity of the chemical product.

In an embodiment, physical entity may relate to the physical embodiment of the chemical product. The physical entity may be any chemical product in the chemical supply chain and/or the chemical value chain. The physical entity of the chemical product may be a raw material or basic substance, a chemical product, a chemical material, a chemical formulation, a chemical mixture, a component, a component assembly, an end product or a combination thereof.

In an embodiment, the decentral data providing network node may comprise computer-executable instructions for providing and/or processing data within a decentral network, such as the digital twin of the chemical product, by a decentral data consuming network node. The decentral data providing network node may be associated with or connected to one or more dedicated data storage(s) storing the digital twin. The decentral data providing network node may be directly or indirectly connected to the data storage(s) storing the digital twin. Hence, the decentral data providing network node may be associated with the digital twin. The dedicated data storage(s) may be under control of the data owner of the digital twin data. The data owner may have access to the dedicated data storage(s).

In an embodiment, the decentral data consuming network node may comprise computer-executable instructions for accessing and/or processing data within a decentral network, such as digital twin data, provided by a decentral data providing network node. The decentral data consuming network node may be controlled or owned by or associated with a consumer of the chemical product. The consumer may be any entity processing the chemical product. The consumer may be any entity operating a production configured to process the chemical product. Processing may include using the chemical product to produce further chemical products, component, assemblies or end products. The consumer may be an upstream participant of the chemical value chain the produced chemical product is associated with, e.g. the chemical product is used in. For instance, the consumer may be a discrete product processor, such as a discrete product producer or a participant of the recycling process of the discrete product. Discrete products may be finished products that are distinct items capable of being easily identifiable, for example by counting. Examples of discrete products include automobiles, airplanes, shoes, etc. A discrete product may be broken down at the end of its lifecycle so that its components can be recycled. The consumer may receive the chemical product from the entity producing the chemical product, such as a chemical product producer. Via the decentral data consuming network node, the consumer of the chemical product may access the digital twin or a part thereof associated with supplied chemical products, thus allowing to improve production or recycling by using the accessed data. For instance, the accessed data may be used to enhance the properties of the resulting further chemical product, component or discrete product or the overall production efficiency. In another instance, the accessed data associated with the supplied chemical product and may be used control the production involving the supplied chemical product. In yet another instance, the accessed data may be used to reliably determine the chemical composition of the components to be recycled, thus improving recycling efficiency by determining the correct recycling process, recycling parameters, recycling plant, etc.

In an embodiment, the decentral network may be a decentral peer-to-peer communication network. The decentral network may include participant network nodes associated with participants of the chemical supply chain and may be configured to perform data transactions. The decentral participant node may comprise a network node of the decentral network. The network nodes associated with participants of the chemical supply chain may be associated with raw chemical product supplier, intermediate chemical products manufacturer, intermediate part manufacturer, component manufacturer, component assembly manufacturer or end product manufacturer. The data transactions may be based on a transaction protocol including authentication and/or authorization mechanism(s). Based on the authentication and/or authorization mechanism(s) a peer-to-peer communication between decentral network nodes associated with participants of the chemical supply chain may be established. The one or more authentication mechanism(s) may be associated with or linked to the decentral digital twin identifier and/or the decentral passport identifier. The one or more authentication mechanism(s) associated with the decentral digital twin identifier and/or the decentral passport identifier may be accessible by the decentral data providing network node and/or the decentral data consuming network node. The decentral configuration allows for more efficient use of computing resources and strengthens control by the data owners of the decentral network.

In an embodiment, the decentral data providing network node and the one or more decentral data consuming network node(s) may be part of the decentral network. The decentral data consuming network node and the decentral data providing network node may be regarded as decentral participant node(s) of the decentral network.

In an embodiment, the decentral digital twin identifier and/or the decentral passport identifier may comprise any unique identifier uniquely associated with the digital twin data and optionally a data owner of the digital twin data. The decentral digital twin identifier and/or the decentral passport identifier may connect the physical entity of the chemical product to the digital twin data. The decentral digital twin identifier and/or the decentral passport identifier may include one or more Universally Unique Identifier(s) (UUID(s)) and/or one or more Decentralized Identifier(s) (DID(s)). The one or more DID(s) and/or UUID(s) may be associated with the digital twin and/or the digital twin data. The one or more DID(s) and/or UUID(s) may further be associated with the chemical product. For instance, the decentral digital twin identifier and/or the decentral passport identifier may include a digital twin identifier associated with the digital twin and one or digital twin data identifier(s) associated with sets of digital twin data contained in the digital twin. The decentral digital twin identifier and/or the decentral passport identifier may further include a chemical product identifier associated with the chemical product. Any combination of UUID(s) and DID(s) may be possible. For instance, the decentral digital twin identifier and/or the decentral passport identifier may be a DID while the digital twin data identifier(s) may be UUID(s). In another instance, the decentral digital twin identifier and/or the decentral passport identifier, and the digital twin data identifier(s) may be UUIDs. The decentral digital twin identifier and/or the decentral passport identifier may be associated with any participant of the chemical supply chain including raw chemical product supplier, intermediate chemical products manufacturer, intermediate part manufacturer, component manufacturer, component assembly manufacturer or end product manufacturer. The decentral digital twin identifier and/or the decentral passport identifier may be associated with a machine, a system, or a device used for producing the raw material, the basic substance, the chemical product, the intermediate product, the component, the component assembly or the end product, or a collection of such machine(s), device(s) and/or system(s). The decentral digital twin identifier and/or the decentral passport identifier may be issued by a central or decentral identity issuer. The decentral digital twin identifier and/or the decentral passport identifier may be generated by the data owner or on behalf of the data owner of the digital twin data. The decentral digital twin identifier and/or the decentral passport identifier may include authentication information. Via the decentral digital twin identifier and/or the decentral passport identifier and its unique association with the digital twin data of the digital twin associated with the chemical product and optionally the data owner of the digital twin data, access to the digital twin data, such sets of digital twin data, may be controlled by the data owner of the digital twin data. This contrasts with central authority schemes, where identifiers are provided by such central authority and access to data is controlled by such central authority. Decentral in this context refers to the usage of the decentral digital twin identifier and/or the decentral passport identifier in implementations as controlled by the data owner.

In an embodiment, the decentral participant identifier may comprise any identifier uniquely associated with a participant of a decentral network and/or with a production site of a participant of the decentral network. The participant of the decentral network may be a consumer of the chemical product, e.g. may consume the chemical product received from or supplied by the chemical product producer. The production site of a participant of the decentral network may use the received/supplied chemical product to produce further products, such as further chemical products, parts, components, component assemblies and/or end products. The decentral participant identifier may include letters and/or numbers. The decentral participant identifier may include one or more Universally Unique Identifier(s) (UUID(s)) and/or one or more Decentralized Identifier(s) (DID(s)). The decentral participant identifier may be associated with or may include a verifiable claim or credential. The verifiable claim may be issued by a central or decentral identity issuer making one or more claims about a subject, such as a consumer entity being a trustworthy participant of the decentral network. For instance, the issuer may make a claim about a consumer (e.g. the customer entity) the DID as decentral participant identifier is associated with. The verifiable claim may include those claim(s) as well as proof instructions to prove that claim(s) have not been tampered with and were indeed issued by the claims issuer. The verifiable claim may also include duration information metadata that defines a period of time that the verifiable claim is valid for use or that defines a specific number of times that the verifiable claim is authorized for use. The verifiable claim may also include a DID of the claims issuer and/or the subject, such as a consumer entity. The verifiable claim may be signed by the claims issuer. The claims issuer may provide the verifiable claim to a claims holder, such as the consumer entity, for presentation to any relying party that relies upon the veracity of those claims, such as a decentral data provider. The signature of the verifiable claim may be validated with a public key associated with the claims issuer to determine that the customer entity is a trusted entity within the decentral network. The verifiable credential may be presented by the decentral data consuming network node and may be used by the decentral data providing network node to verify that the decentral participant associated with the decentral data consuming network node is a trusted entity within the decentral network prior to providing access to the digital twin, hence ensuring that the digital twin can be exchanged in a secure and controlled manner within the decentral network. The decentral participant identifier may be different from the data related to the chemical product produced from the one or more chemical input materials. In contrast to the data related to the chemical product which may not be unique within the decentral network, the decentral participant identifier is unique within the decentral network. Hence, the decentral participant identifier allows to uniquely identify a participant and/or a site of the participant of the decentral network. The decentral participant identifier may be generated by a central or decentral node of the decentral network. The decentral participant identifier may be provided to all participants of the decentral network. The decentral participant identifier may be associated with the name of the participant of the decentral network. The decentral participant identifier may be associated with the name of the site, such as a production site, of the participant of the decentral network. Decentral in this context refers to the usage of the decentral participant identifier in implementations as controlled by the decentral data consuming network node associated with a decentral participant.

In an embodiment, the one or more authorization rules may comprise computer-executable instructions for authorizing data access for decentral data consuming network node(s). The set of authorization rules may include rules that determine under which conditions digital twin may be accessed (e.g. access policies) and/or used (e.g. usage policies). The computer-executable instructions may allow access to the digital twin associated with the decentral digital twin identifier, deny access to the digital twin associated with the decentral digital twin identifier, to modify access to the digital twin associated with the decentral digital twin identifier or to modify the digital twin associated with decentral digital twin identifier.

In an embodiment, the chemical property may be a property of the chemical product that becomes evident during, or after, a chemical reaction. Hence, the chemical property may be any quality that can be established only by changing the chemical identity of the chemical product. Examples of chemical properties include heat of combustion, enthalpy of formation, toxicity, chemical stability in a given environment, flammability, oxidation state(s), ability to corrode, combustibility, acidity and basicity, chemical product composition, recyclate content used for producing or manufacturing the chemical product, bio-based content used for producing or manufacturing the chemical product, renewable content used for producing or manufacturing the chemical product and pH value.

In an embodiment, physical property may be any property that is measurable. Hence, the value of a physical property describes a state of the chemical product. Examples of physical properties include absorption, brittleness, boiling point, capacitance, color, concentration, density, ductility, distribution, efficacy, elasticity, electric charge, electrical conductivity, electrical impedance, electric potential, flow rate, fluidity, hardness, heat capacity, inductance, intrinsic impedance, luminance, luminescence, luster, mass, melting point, opacity, permeability, permittivity, plasticity, pressure, radiance, resistivity, reflectivity, refractive index, solubility, specific heat, strength, stiffness, temperature, tension, thermal conductivity, thermal resistance, viscosity, volume and wave impedance.

In an embodiment, the measured at least one physical and/or chemical property is obtained by sensors configured to measure the physical and/or chemical property. The sensor may be included in a measuring device. The sensor may correspond to the measuring device. For example, the physical and/or chemical property may include a property provided by sensors of a mobile device such as a camera, or measurement devices configured to measure at least one physical and/or chemical property.

In an embodiment, the data associated with the production of the chemical product is collected before, during and/or after production of the chemical product. The collected chemical product data may be used to determine at least one physical and/or chemical property of the produced chemical product. For instance, emission data of the chemical product may be determined based on chemical product data collected during production of the chemical product. Data associated with the production of the chemical product may include chemical production data from the production of the chemical product. Data associated with the production of the chemical product may include monitoring and/or control data associated with the production of the chemical product.

In an embodiment, data associated with the use of the chemical product is collected via at least one identifier associated with the chemical product. The data may be collected during and/or after use of the chemical product. Collected data may include at least one measured physical and/or chemical property of the used chemical product. The measured physical and/or chemical property may include the chemical and/or physical properties described previously. The data may be collected with a suitable sensor configured to measure the chemical and/or physical property. The sensor data may be interrelated with the identifier associated with the chemical product. The chemical and/or physical property determined from the sensor data may be interrelated with the identifier associated with the chemical product. The identifier may be the chemical product identifier. The identifier may be the decentral digital twin identifier. The decentral digital twin identifier may be linked to other decentral product identifier(s) according to a physical relation of the chemical product entity with other physical entities e.g. those produced using the chemical product or those produced from the chemical product. This way decentral participant node(s) of the decentral network may be able to interpret the relation of the decentral digital twin identifier corresponding to the physical relation of the physical chemical entity to other physical entities. The linking of the decentral digital twin identifier with other decentral product identifier(s) allows to determine the decentral participant node(s) storing the collected data associated with the use of the chemical product or the determined physical and/or chemical property. The collected data and/or the determined chemical and/or physical property may be provided by said decentral participant node(s) and may be stored within the digital twin. For instance, a new data set may be generated by applying an aspect model associated with the use of the chemical product and said new data set may be used to update the digital twin.

In an embodiment, the digital twin further includes a chemical product name, chemical product declaration data, chemical product safety data, certificate of analysis data associated with the chemical product, certificates associated with the chemical product or a combination thereof. The digital twin may include different classes of data (hereinafter denoted as digital twin data). At least one class of such data may include data required by regulation or regulatory data for chemicals. Such data may include chemical product declaration data, chemical product safety data and certificate of analysis data. At least one class of such data may include emission data, recyclate content data bio-based content data and/or at least one physical and/or chemical property determined from collected data associated with the production of the chemical product. Each class may be associated with authorization rule(s), as described later on. The authorization rule(s) for each class may differ from each other. This allows to define access to the digital twin on a more granular level, hence increasing the security and avoiding undesired access to a class containing more sensitive information, like the composition of the chemical product, by unauthorized decentral data consuming services.

In an embodiment, emission data may comprise any data related to environmental footprint. The environmental footprint may refer to an entity and its associated environmental footprint. The environmental footprint may be entity specific. For instance, the environmental footprint may relate to a product, a company, a process such as a manufacturing process, a raw material or basic substance, a chemical product or material, a component, a component assembly, an end product, combinations thereof or additional entity-specific relations. Emission data may include data relating to the carbon footprint of the chemical product or a Product Carbon Footprint (PCF). Emission data may include data relating to greenhouse gas emissions e.g. released in production of the chemical product. Emission data may include data related to greenhouse gas emissions. Greenhouse gas emissions may include emissions such as carbon dioxide (CO₂) emission, methane (CH₄) emission, nitrous oxide (N₂O) emission, hydrofluorocarbons (HFCs) emission, perfluorocarbons (PFCs) emission, sulphurhexafluoride (SF₆) emission, nitrogen trifluoride (NF₃) emission, combinations thereof and additional emissions. Emission data may include data related to greenhouse gas emissions of an entities or companies own operations (production, power plants and waste incineration). Scope 2 may comprise emissions from energy production which is sourced externally. Scope 3 may comprise all other emissions along the value chain. Specifically, this may include the greenhouse gas emissions of raw materials obtained from suppliers. Product Carbon Footprint (PCF) may sum up greenhouse gas emissions and removals from the consecutive and interlinked process steps related to a particular product. Cradle-to-gate PCF may sum up greenhouse gas emissions based on selected process steps: e.g. from the extraction of resources up to the factory gate where the product leaves the company. Such PCFs may be called partial PCFs. In order to achieve such summation, each company providing any products may provide the scope 1 and scope 2 contributions to the PCF for each of its products.

In an embodiment, recyclate content data, bio-based content data and renewable content data may comprise any data related to the recyclate content or the bio-based content or the renewable content used for producing or manufacturing a physical entity of the chemical product.

In an embodiment, the digital twin may include at least two different measured and/or determined physical and/or chemical properties being present in different data sets (e.g. digital twin data). Data points within different data sets may overlap. The data sets may correspond to a data structure obtained upon applying an aspect model to gathered data associated with the physical entity of the chemical product as described previously. The data set may include values and/or value ranges defined in the aspect model used to generate the data set. Hence, each data set contains the data structure and data defined by the aspect model used for its generation. This ensures that each data set has a defined structure and contains defined data, thus allowing to simplify data exchange and processing of the exchanged data on chemical products.

In an embodiment, the decentral data providing network node is associated with a data owner of the digital twin and/or the digital twin data. The data owner may include an entity generating the digital twin. The data owner may include any entity generating the digital twin data or data set(s). The data generating node may be coupled to the entity producing or owning the physical entity of the chemical products from or for which data is generated. The digital twin data may be generated by a third-party entity on behalf of the entity producing or owning the physical entity of the chemical products from or for which data is generated. The data owner may be the chemical product producer. The data owner may hence directly or indirectly own the digital twin and digital twin data. The digital twin and digital twin data may be stored in a database of or associated with the data owner. The digital twin and digital twin data may be stored in a database of or under control by the data owner. The digital twin and digital twin may be stored in a database accessible by the data owner. The data owner may control access to the digital twin and digital twin, for instance via the decentral data providing network node associated with the data owner. The digital twin and digital twin may be associated with the data owner. In this sense, the data owner is to be construed broadly as the entity having access to the digital twin and digital twin and controlling access via the decentral data providing network node to the digital twin or a part thereof by data consuming services of the decentral network.

In an embodiment, the decentral digital twin identifier is provided in response to a request received at the decentral digital twin providing unit. The request may contain the decentral digital twin identifier. The request may contain a chemical product identifier associated with the chemical product and the decentral digital twin identifier providing unit may be configured to provide the decentral digital twin identifier based on the received chemical product identifier. For instance, the decentral digital twin identifier providing unit may retrieve the decentral digital twin identifier from a database storing the digital twin based on the chemical product identifier.

In an embodiment, the data related to the chemical product produced from the one or more chemical input materials includes a consumer identifier associated with the chemical product. The consumer identifier may be associated with a consumer of the chemical product. The consumer identifier may be associated with participants of the chemical product ecosystem receiving or consuming the chemical product. The consumer identifier may be any identifier uniquely associated with a consumer of a chemical product within a chemical production producing the chemical product. The consumer identifier may be any identifier uniquely associated with a consumer of a chemical product within an entity operating a chemical production producing the chemical product. The consumer identifier may be an identifier used by the chemical product producer. The consumer identifier may not be a unique identifier within the decentral network. Hence, the consumer identifier may only be unique within the chemical production producing the chemical product from one or more chemical input materials. The consumer identifier may be associated with a chemical product supplied to a consumer the consumer identifier is associated with. The consumer identifier may be associated with a chemical product identifier associated with the chemical product. Hence, the respective consumer identifier(s) may be identified based on a chemical product identifier associated with the chemical product. The consumer identifier may be any string, number or a combination thereof.

In an embodiment, the data related to the chemical product produced from the one or more chemical input materials further includes a chemical product identifier associated with the chemical product. This allows to link the data related to the chemical product to the physical entity of the respective chemical product.

In an embodiment, the decentral participant node(s) associated with the decentral participant identifier(s) are associated with participants of the decentral network. The participants may be consumers of the chemical product. The decentral participant node(s) may correspond to decentral data consuming network node(s) associated with participants of the decentral network. The decentral participant node(s) are hence at least indirectly associated with participant(s) of the decentral network.

In an embodiment, the data related to the decentral participant node(s) includes the decentral participant identifier(s) associated with said participant node(s). The data related to the decentral participant node(s) may further include data related to participant(s) associated with said decentral participant node(s). Data related to participant(s) may include the name and/or the address of the participant(s).

In an embodiment, generating the mapping data includes interrelating data related to the chemical product produced from the one or more chemical input materials with respective decentral participants identifier(s) contained in the data related to the decentral participant node(s) based on a relationship representation according to which the data related to the chemical product is associated with the data related to the decentral participant node(s). The data related to the chemical product produced from the one or more chemical input materials may be determined based on the chemical product identifier associated with the chemical product. The data related to the chemical product produced from the one or more chemical input materials may be retrieved from one or more data storage media, such as distributed database(s) based on the chemical product identifier. The relationship representation may specify consumer(s) associated with the chemical product and/or the chemical product associated with consumer(s). The relationship representation may specify the consumer(s) based on consumer identifier(s), such as the consumer identifier(s) contained in the data related to the chemical product, and associated decentral network identifier(s), such as decentral network identifier(s) contained in the data related to the decentral participant node(s). The relationship representation may correspond to a data structure containing the relationship between the chemical product, the consumer identifier(s) and the decentral participant identifier(s). The data structure may include further information associated with the consumer identifier(s) and/or the decentral participant identifier(s), such as the name(s) and/or the addresses associated with said identifier(s). The relationship representation may be generated by determining the data related to the decentral participant(s) which is associated with the data related to the chemical product. For instance, the relationship representation may be generated by matching the name(s) and/or addresses contained in the data related to the chemical product with the names and/or addresses contained in the data related to the decentral participant node(s) and—based on said matching —interrelating the data related to the chemical product with the decentral participant identifier(s).

In an embodiment, providing the mapping data includes generating the mapping data and providing the generated mapping data. The generated mapping data may be stored on a data storage medium, such as a database. The database may be a persistent or non-persistent log.

In an embodiment, generating mapping data includes verifying the data related to the decentral participant node(s). Verification may be done prior to generation of the mapping data. Verification may be done after generation of the mapping data. Verification ensures that the identity of the decentral network participant(s) associated with the decentral participant node(s) and hence with the decentral participant identifier(s) is matching the identity of the consumer of the chemical product, e.g. is matching the data related to the chemical product and hence avoids generation of incorrect mapping data which would result in generation of incorrect access data and hence access to the digital twin by incorrect decentral data consuming network node(s). Verification may be based on a verifiable claim associated with the respective decentral participant identifier. The verifier may be the data owner of the digital twin. The verifier may be the entity performing the computer-implemented method for controlling access to the digital twin as disclosed herein. The verifier may be the unit providing the mapping data. The verifier may verify the claim using a verifiable data registry. Verifying ensures that only trusted decentral participant identifier(s) are contained in the mapping data used to generate the access data, hence ensuring that access to the digital twin or a part thereof may only be authorized for trusted decentral data consuming network node(s) of the decentral network.

In an embodiment, the access data further includes a digital representation pointing to the digital twin or a part thereof. Access data may include digital representation(s) pointing to data set(s) included in the digital twin data. Access data may include multiple digital representation(s), each representation pointing to different parts of the digital twin data, such as different data sets. The digital representation(s) may point directly or indirectly to the storage location of the digital twin. The digital representation(s) may comprise at least one interface to the decentral data providing network node. The digital representation(s) may further include at least one interface to a decentral data consuming network node. The digital representation(s) may include an endpoint for data exchange or sharing (resource endpoint) or an endpoint for service interaction (service endpoint), that is uniquely identified via a communication protocol.

In an embodiment, generating access data includes providing authorization rules being associated with the data related to the chemical product and/or with a chemical product identifier and selecting authorization rules based on the mapping data.

In an embodiment, the one or more authorization rules may be generated based on the decentral participant identifier(s) contained in the mapping data. For instance, authorization rules that are specific to decentral participant identifier(s) may be generated. In another instance, authorization rules that are specific to a particular location may be generated based on the decentral participant identifier contained in the mapping data.

In an embodiment, one or more authorization rules may be generated based on the data related to the chemical product contained in the mapping data. For instance, obligations of decentral data consuming network nodes(s) accessing and using the digital twin or a part thereof may be generated based on the data related to the chemical product.

In an embodiment, the one or more authorization rules include one or more rules that are specific to the decentral participant identifier(s). For instance, the one or more authorization rules may include one or more rules that are specific to the decentral participant identifier(s) associated with decentral participant nodes(s) allowed to access the digital twin or a part thereof. Hence, access to the digital twin or a part thereof for decentral participant network node(s) being associated with decentral participant identifier(s) not contained in the set of authorization rules will be denied. The number of decentral network participants and hence associated decentral data consuming network nodes having access to the digital twin or a part thereof may therefore be restricted using decentral participant identifier(s). This enables to control access to the digital twin or a part thereof by the unique liking of the decentral digital twin identifier and the authorization rules via filtering of decentral data consuming network nodes based on the decentral participant identifier associated with each decentral data consuming network node.

In an embodiment, the one or more authorization rules include one or more local rules that are specific to a particular location, wherein the location is associated with a jurisdiction and the local rule for the location is associated with legal requirements related to the supply of chemical products. The local rules may include instructions configured to provide access to the digital twin or a part thereof. The location may be the location of the decentral data consuming network node. The location may be the location of the decentral network participant associated with the decentral data consuming network node. The location may be the location of the entity operated by the decentral network participant. The location may be determined based on the decentral participant identifier associated with the decentral data consuming network node requesting access to the digital twin or a part thereof.

In an embodiment, the one or more authorization rules include one or more rules that are specific to attribute values associated with a decentral network participant. The attribute values associated with the participant may be associated with or correspond to the role of the participant within the chemical product ecosystem. The role may be a raw material supplier, a chemical product producer, an OEM, a recycler, etc. For instance, the one or more authorization rules may include one or more attribute values that are specific to participant(s) associated with decentral data consuming network node(s) allowed to access the digital twin or a part thereof. Hence, access to the digital twin or a part thereof for decentral data consuming network node(s) being associated with participant(s) not contained in the set of authorization rules will be denied.

In an embodiment, the one or more authorization rule(s) include at least one regulatory instruction configured to provide access to digital twin or a part thereof relating to regulatory requirements for the supply of chemical products.

In an embodiment, the one or more authorization rule(s) include one or more of prescribed rules relating to emission data, production data, recyclate content data, bio-based content data, provenance data, labour conditions data or combinations thereof.

In an embodiment, the one or more authorization rule(s) include obligations of decentral data consuming network node(s) associated with respective decentral participant identifier(s) and/or obligations of decentral network node(s) using the digital twin or a part thereof accessed by data consuming network node(s) associated with respective decentral participant identifier(s). Such obligations may include data transaction logging, usage policies for processing or use of accessed digital twin or a part thereof, mapping to access prescriptions or the like. Usage policies for processing or use of the accessed digital twin or a part thereof may include conditions for a time restriction of the usage of the accessed digital twin or the part thereof. For instance, the usage policies may contain duration data being indicative of a duration the digital twin or the part thereof may be accessed by decentral data consuming network node(s). After the duration has elapsed, the digital twin or the part thereof may no longer be accessed by said decentral data consuming network node(s). Usage policies for processing or use may include one or more prescribed processing rules relating to the processing of emission data, production data, recyclate content data, bio-based content data, provenance data, labour conditions data or combinations thereof by a decentral data consuming network node associated with a decentral participant identifier. Usage policies including one or more prescribed processing rules may be enforced by applications using the accessed digital twin or the part thereof. Usage policies for processing or use may include obligations associated with a purpose the accessed digital twin or the part thereof is allowed to be processed for or used for. For instance, such usage policies may define that the accessed digital twin or the part thereof is only used in the context of emission data calculations. Usage policies associated with a purpose may be enforced by applications using the accessed digital twin or the part thereof.

In an embodiment, authorization rule(s) defining usage of the digital twin or a part thereof includes one or more aggregation rules relating to the digital twin or the part thereof. The aggregation rule(s) may relate to bill of material data contained in said digital twin or the part thereof. A bill of materials may relate to a production configuration. The production configuration may include a list of the chemical materials or components, the quantities of each needed to manufacture the respective product or combinations thereof. The bill of materials may include products as they are designed (engineering bill of materials), as they are ordered (sales bill of materials), as they are built (manufacturing bill of materials), or as they are maintained (service bill of materials). In chemical industry, the bill of material may include a formula, a recipe, or a ingredients list.

In an embodiment, the access data is generated for at least part of the digital twin. In another embodiment, the access data is generated for each data set contained in the digital twin data. This allows to define the access data on a data set level, hence providing a more granular access to the digital twin data since different access data may be generated and applied to different data sets. The access data may be associated with the respective data set via a data set identifier associated with the respective data set. The data set identifier may be included in the decentral digital twin identifier. For instance, access data containing less strict authorization rules may be bound to a data set containing data accessible by several decentral data consuming network node(s), such as material safety data, while access data containing strict authorization rules may be bound to a data set containing data accessible by only a small number of decentral data consuming network node(s), such as chemical product composition data.

In an embodiment, access of the digital twin by a decentral data consuming network node is based on the decentral digital twin identifier and the decentral participant identifier associated with the decentral data consuming network node requesting access to the digital twin or a par thereof. For instance, the decentral data consuming network node may provide the decentral digital twin identifier and the decentral participant identifier associated with said decentral data consuming network node to the decentral data providing network node. Based on the provided decentral digital twin identifier, the decentral data providing network node may request or retrieve the digital twin or the part thereof associated with said decentral digital twin identifier. Based on the provided decentral digital twin identifier and decentral participant identifier, the decentral data providing network node may apply access data to the received or retrieved digital twin or the part thereof as described later on.

In an embodiment, access to the digital twin may be controlled by the decentral data providing network node based on the decentral participant identifier and the access data. This enables to control access to digital twin by the decentral data providing network node based on the unique relationship between the decentral digital twin identifier and the one or more authorization rule(s) by using authorization rule(s) to filter decentral data consuming network node(s) requesting access to the digital twin or a part thereof based on the decentral participant identifier(s) associated with said decentral data consuming network node(s).

In an embodiment, the decentral data providing network node may further be associated with the data owner of the digital twin or parts thereof, such as data set(s). The data owner may be the chemical product producer. The data owner may be a data owner a previously described. The decentral data providing network node may be directly or indirectly connected to one or more dedicated data storage(s) storing the digital twin. The dedicated data storage(s) may be under control of the data owner of the digital twin. The data owner may have access to the dedicated data storage(s). The data owner may hence control access to the digital twin via the decentral data providing network node based on the decentral digital twin identifier and associated access data. This allows to retain full control of the digital twin by the data owner but at the same time enabling sharing of the digital twin under controlled conditions by using access data associated with said digital twin.

In an embodiment, the decentral data consuming network node may be controlled or owned by the consumer of the chemical product. The consumer may be the recipient of the chemical product. The consumer may be a chemical product processor. Via the decentral data consuming network node, the consumer may retrieve and/or receive at least part of the digital twin associated with the received chemical product(s), thus allowing to improve production of products containing the chemical product(s) or to improve recycling of a product by using the retrieved and/or retrieved data. Use of the data during production of discrete materials or components thereof may allow to improve production processes using said data, for example by controlling the production processes based on said data, to enhance the properties of the resulting component or discrete product or the overall production efficiency. Use of the data during recycling processes may allow to reliably determine the chemical composition of the components to be recycled, thus improving recycling efficiency by determining the correct recycling process(es), recycling parameters, recycling plant(s), etc.

In an embodiment, the access data may be stored in a database of or associated with the decentral data providing network node. Providing the access data to the decentral data providing network node allows to store the digital twin separately from the decentral data providing network node, thus ensuring a higher level of security since appropriate authentication and authorization schemes can be implemented for communications between the downstream database(s) storing the digital twin and the decentral data providing network node. Moreover, only minimum amount of data is stored in the database associated with the decentral data providing network node, hence reducing the risk of unwanted data leakage in case the contents of the database of the decentral data providing network node are accessed unauthorized.

In an embodiment of the method for authorizing access to the digital twin or the apparatus for authorizing access to the digital twin, the request may be received based on a digital access element containing a decentral passport identifier associated with the chemical product and digital twin location data. The decentral passport identifier may correspond to the decentral digital twin identifier contained in the digital twin or may be associated with the decentral digital twin identifier. The digital twin location data may include a digital representation pointing to the decentral data providing network node associated with the digital twin. The digital access element may correspond to a DID document associated with the decentral digital twin identifier or decentral passport identifier, said DID document including the decentral digital twin identifier or decentral passport identifier in the form of a decentralized identifier (DID). The digital access element may be retrieved from a central or decentral repository. The digital access element may be retrieved based on the decentral digital twin identifier associated with a physical identifier of the chemical product. For instance, the decentral identifier may be embedded in the physical identifier. In another instance, the chemical product identifier may be embedded in the physical identifier and the chemical product identifier may be used to retrieve the associated decentral digital twin identifier and—based on said decentral digital twin identifier, the digital access element.

In an embodiment of the method for authorizing access to the digital twin or the apparatus for authorizing access to the digital twin, the access data is applied prior to access of the digital twin or the part thereof or during run-time on access of the digital twin or the part thereof.

In an embodiment of the method for authorizing access to the digital twin, the method includes a step of authenticating a decentral network node for access to the digital twin associated with the chemical product. Authenticating may include receiving a request to authenticate the decentral network node. The request may include a decentral network node identifier associated with the decentral network node. The request may include the decentral participant identifier associated with the decentral data consuming network node. The request may include the decentral participant identifier associated with the decentral data providing network node. Authentication may further include providing one or more authentication mechanisms associated with the decentral network node identifier. The authentication mechanisms may be provided from at least one authentication data registry. The authentication data registry may be a central registry node such as a central file system, a centrally managed distributed database, and/or a centrally managed peer-to-peer network. The central configuration allows for more control and standardization via a central node. The authentication data registry may be a decentral registry such as a distributed ledger, a decentralized file system, a distributed database, and/or a peer-to-peer network. The decentral configuration allows for more efficient use of computing resources and strengthens control by the data owner. In addition, the decentral configuration is independent from centrally managed nodes and increases reliability and flexibility of the system. The authentication mechanisms may be provided in response to a request from the decentral network node to the authentication registry. Based on the authentication mechanism, a request to generate authentication data may be provided. The authentication data received in response to the request may be verified and access to the chemical product data set(s) may be authorized if the authentication is verified, or access may be denied, if the authentication is not verified. The access may be authorized by the apparatus or computer-implemented method for authorizing access.

The decentral network node may be a decentral data providing network node associated with a decentral participant identifier, wherein the authentication of the decentral data providing network node includes providing the decentral participant identifier and providing one or more authentication mechanisms related to the decentral participant identifier from at least one authentication data registry. The decentral network node may be a decentral data consuming network node associated with a decentral participant identifier, wherein the authentication of the decentral data consuming network node includes providing the decentral participant identifier and providing one or more authentication mechanisms related to the decentral participant identifier from at least one authentication data registry.

The decentral network node to be authenticated may provide a dynamic token from at least one authentication data registry and/or an identity token to be presented in the authentication request to the decentral network node performing the verification. For instance, the decentral data consuming network node may provide a dynamic token from at least one authentication data registry and/or an identity token to be presented in the authentication request to the decentral data providing network node. In another instance, the decentral data providing network node provides a dynamic token from at least one authentication data registry and/or an identity token to be presented in the authentication request to the decentral data consuming network node.

The verifying decentral network node may grant access to another decentral network node to be authenticated based on verification of the dynamic token and/or the identity token by the verifying decentral network node. The decentral network node to be authenticated may grant access to the verifying decentral network node based on verification of the dynamic token and/or the identity token by the decentral network node to be authenticated. For instance, the decentral data consuming network node is granted access to the decentral data providing network node based on verification of the dynamic token and/or the identity token by the decentral data providing network node. In another instance, the decentral data providing network node may grant access to the decentral data consuming network node based on verification of the dynamic token and/or the identity token by the decentral data providing network node.

The authentication process may be implemented as part of the decentral data providing network node or the decentral data consuming network node. The authentication process may be provided by a separate authentication service accessible for the decentral data providing network node and/or the decentral data consuming network node. In the authentication process, one decentral network node may act as verifying service and the other decentral network node may act as service to be authenticated.

At least one authentication mechanism may be based on a private-public-key infrastructure, a digital certificate issued by a certificate issuer, a biometric authentication service or combinations thereof. The public key may be included in the digital access element. The digital access element may include the decentral passport identifier, access data and the public key. The digital access element may be recorded on at least one authentication registry. In response to an authentication request by a decentral data service, authentication data including a cryptographic signature encrypted by the private key of the requesting decentral data service may be provided. The provided authentication data may be validated based on the at least one authentication mechanism. Validation may include retrieving the public key from the authentication data registry, decrypting the cryptographic signature using the retrieved public key and in response to a valid decryption result, determine if the authentication request is valid. Access to digital twin data may be granted, if the authentication request is valid, or access to digital twin data may be denied, if the authentication request is not valid.

The authorization process may be performed for decentral data consuming network node(s). The authorization may be performed by the decentral data providing network node. The authorization process may be performed before authentication of the decentral data consuming network node. The authorization process may be performed in parallel to the authentication of the decentral data consuming network node. The authorization process may be performed after authentication of the decentral data consuming network node. The authorization process may only be performed upon the authentication process being successful. On successful authorization, the decentral data providing network node may provide access to the digital twin based on the access data. On successful authorization, the decentral data providing network node may provide modified access to the digital twin or access to a modified digital twin based on the access data.

### BRIEF DESCRIPTION OF THE SEVERAL VIEWS OF THE DRAWINGS

In the following, the present disclosure is further described with reference to the enclosed figures. The same reference numbers in the drawings and this disclosure are intended to refer to the same or like elements, components, and/or parts.

FIG. 1A to FIG. 1C illustrate example embodiments of a centralized computing environment (FIG. 1A), a decentralized computing environment (FIG. 1B) and a distributed computing environment (FIG. 1C).

FIG. 2 illustrates an example of a chemical production controlled by an operating system including a digital twin management system.

FIG. 3 illustrates an example of a production system providing a chemical product associated with a one or more digital twin(s).

FIG. 4A illustrates an example apparatus for controlling access to a digital twin of a physical entity of a chemical product produced from one or more chemical input materials.

FIG. 4B illustrates an example of a system for controlling access to a digital twin of a physical entity of a chemical product produced from one or more chemical input materials.

FIG. 5A illustrates a first example of a linkage between a digital twin of a chemical product and a digital access element via the decentral digital twin identifier.

FIG. 5B illustrates a second example of a linkage between a digital twin of a chemical product and digital access elements via the decentral digital twin identifier.

FIG. 6A illustrates an example of access data including a decentral digital twin identifier and one or more authorization rule(s).

FIG. 6B illustrates a further example of access data including a decentral digital twin identifier and one or more authorization rule(s).

FIG. 7A illustrates an example of an apparatus and associated methods for controlling access to a digital twin of a chemical product produced from one or more chemical input materials by a chemical production.

FIG. 7B illustrates an example of an apparatus and associated methods for controlling access and authorizing access to a digital twin of a chemical product produced from one or more chemical input materials by a chemical production.

FIG. 7B illustrates an example of an apparatus and associated methods for accessing a digital twin of a chemical product produced from one or more chemical input materials by a chemical production using a digital access element.

FIG. 8 illustrates a flow chart of a computer-implemented method for generating a digital twin of a physical entity of a chemical product in accordance with an example embodiment of the present disclosure.

FIG. 9 illustrates a flow chart of a computer-implemented method for controlling access to a digital twin of a physical entity of a chemical product in accordance with an example embodiment of the present disclosure.

FIGS. 10A, 10B illustrate examples of relationship representations which may be used to generate mapping data.

FIG. 11 illustrates a flow chart of a computer-implemented method for authorizing access by a decentral data providing network node to a digital twin of a physical entity of a chemical product in accordance with an example embodiment of the present disclosure.

FIG. 12 shows a schematic illustration for authorizing access by a decentral data providing network node to a digital twin or a part thereof associated with a chemical product using a digital access element.

FIG. 13 illustrates a flow chart a computer-implemented method for processing a digital twin or a part thereof of a physical entity of a chemical product in accordance with an example embodiment of the present disclosure.

FIG. 14 illustrates a computer-implemented method for authorizing access to a digital twin or a part thereof of a physical entity of a chemical product by a decentral data consuming network node using a digital access element associated with the chemical product in accordance with an example embodiment of the present disclosure.

FIG. 15 illustrates an example of a digital access element including DID owner data, DID document data and decentral identity infrastructure.

FIG. 16 illustrates an example of a digital access element including certificate-based data, ID-based digital access element data and decentral identity infrastructure.

FIGS. 17A, 17B illustrate examples of authentication protocols between a decentral data consuming network node and a decentral data providing network node.

### DETAILED DESCRIPTION

The following embodiments are mere examples for implementing the computer-implemented methods, apparatuses, systems, and computer elements disclosed herein and shall not be considered limiting.

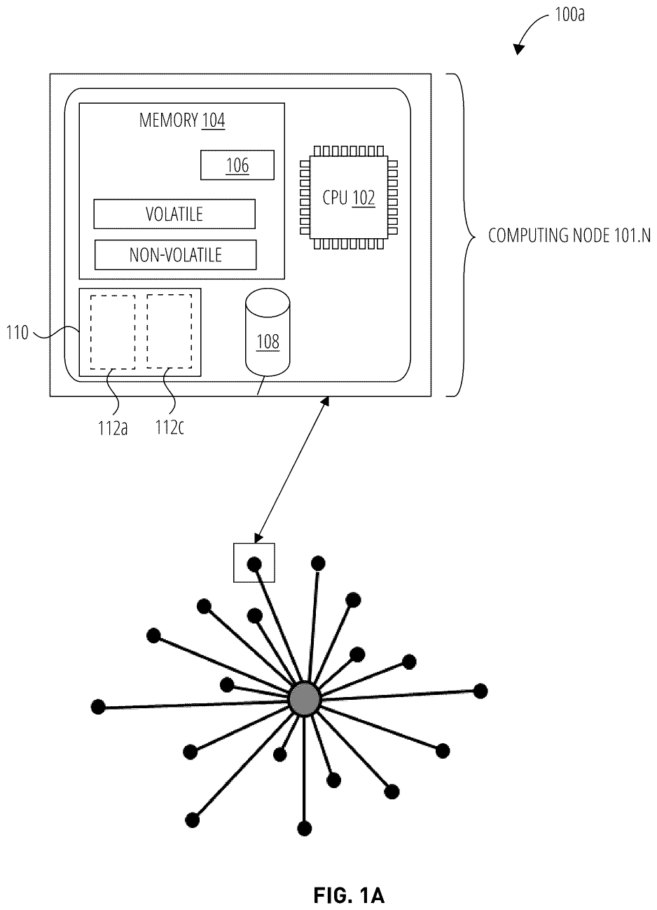

FIG. 1A to FIG. 1C illustrate different computing environments, central, decentral and distributed. The methods, apparatuses, systems, digital twins, digital access elements, uses, computer elements of this disclosure may be implemented in decentral or at least partially decentral computing environments. In particular, for data sharing or exchange in ecosystems of multiple players different challenges exist. Data sovereignty may be viewed as a core challenge. It can be defined as a natural person's or corporate entity's capability of being entirely self-determined with regard to its data. To enable this particular capability related aspects, including requirements for secure and trusted data exchange in business ecosystems, may be implemented across the chemical value chain. In particular, chemical industry requires tailored solutions to deliver chemical products in a more sustainable way by using digital ecosystems.

FIG. 1A illustrates an example embodiment of a centralized computing system 100a comprising a central computing node (filled circle in the middle) and several peripheral computing nodes 101.1 to 101.N (denoted as filled circles in the periphery). The computing system may include one or more computing nodes, a system of nodes or combinations thereof.

In this example, the peripheral computing nodes 101.1 to 101.N may be connected to one central computing system (or server). In another example, the peripheral computing nodes 101.1 to 101.N may be attached to the central computing node via e.g. a terminal server (not shown). The majority of functions may be carried out by, or obtained from the central computing node (also called remote centralized location). One peripheral computing node 101.N has been expanded to provide an overview of the components present in the peripheral computing node. The central computing node may comprise the same components as described in relation to the peripheral computing node 101.N. Each computing node 101, 101.1 to 101.N may include at least one hardware processor 102 and memory 104.

The computing nodes 101, 101.1 . . . 101.N may include program code which is schematically represented as a plurality of structures 106. The multiple structures 106 may be referred to as an executable component, executable instructions, computer-executable instructions or instructions. Executable component or any equivalent thereof may be the name for a structure that is well understood to one of ordinary skill in the art in the field of computing as being a structure that can be software, hardware, or a combination thereof or which can be implemented in software, hardware, or a combination. For instance, when implemented in software, one of ordinary skill in the art would understand that the structure of an executable component includes software objects, routines, methods, and so forth, that is executed on the computing nodes 101, 101.1 . . . 101.N, whether such an executable component exists in the heap of a computing node 101, 101.1 . . . 101.N, or whether the executable component exists on computer-readable storage media. In such a case, one of ordinary skill in the art will recognize that the structure of the executable component exists on a computer-readable medium such that, when interpreted by one or more processors of a computing node 101, 101.1 . . . 101.N (e.g. by a processor thread), the computing node 101, 101.1 . . . 101.N is caused to perform a function. Such a structure may be computer-readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing. Examples of executable components implemented in hardware include hardcoded or hard-wired logic gates, that are implemented exclusively or near-exclusively in hardware, such as within a field-programmable gate array (FPGA), an application-specific integrated circuit (ASIC), or any other specialized circuit. In this description, the words component, agent, manager, service, engine, module, virtual machine or the like are used synonymous with executable component.

The processor 102 of each computing node 101, 101.1 . . . 101.N may direct the operation of each computing node 101, 101.1 . . . 101.N in response to having executed computer-executable instructions that constitute an executable component. For example, such computer-executable instructions may be embodied on one or more computer-readable media that form a computer program product. The computer-executable instructions may be stored in the memory 104 of each computing node 101, 101.1 . . . 101.N. Computer-executable instructions comprise, for example, instructions and data which, when executed at a processor 101, cause a general purpose computing node 101, 101.1 . . . 101.N, special purpose computing node 101, 101.1 . . . 101.N, or special purpose processing device to perform a certain function or group of functions. Alternatively, or in addition, the computer-executable instructions may configure the computing node 101, 101.1 . . . 101.N to perform a certain function or group of functions. The computer executable instructions may be, for example, binaries or even instructions that undergo some translation (such as compilation) before direct execution by the processors, such as intermediate format instructions such as assembly language, or even source code.

Each computing node 101, 101.1 . . . 101.N may contain communication channels 108 that allow each computing node 101.1 . . . 101.N to communicate with the central computing node 101, for example, a network enabling the transport of electronic data between computing nodes 101, 101.1 . . . 101.N and/or modules and/or other electronic devices. When information is transferred or provided over a network or another communications connection (either hardwired, wireless, or a combination of hardwired or wireless) to a computing node 101, 101.1 . . . 101.N, the computing node 101, 101.1 . . . 101.N may view the connection as a transmission medium. Transmission media can include the network and/or data links which can be used to carry desired program code means in the form of computer-executable instructions or data structures and which can be accessed by a general-purpose or special-purpose computing nodes 101, 101.1 . . . 101.N. Combinations of the above may also be included within the scope of computer-readable media.

The computing node(s) 101, 101.1 to 101.N may further comprise a user interface system 110 for use in interfacing with a user. The user interface system 110 may include output mechanisms 110A as well as input mechanisms 110B. The principles described herein are not limited to the precise output mechanisms 110A or input mechanisms 110B as such will depend on the nature of the device. However, output mechanisms 110A might include, for instance, displays, speakers, displays, tactile output, holograms and so forth. Examples of input mechanisms 110B might include, for instance, microphones, touchscreens, holograms, cameras, keyboards, mouse or other pointer input, sensors of any type, and so forth.

FIG. 1B illustrates an example embodiment of a decentralized computing environment 100b with several computing nodes 101.1′ to 101.N′ denoted as filled circles. In contrast to the centralized computing environment 100a illustrated in FIG. 1A, the computing nodes 101.1′ to 101.N′ of the decentralized computing environment are not connected to a central computing node and are thus not under control of a central computing node. Instead, resources, both hardware and software, may be allocated to each individual computing node 101.1′ . . . 101.N′ (local or remote computing system) and data may be distributed among various computing nodes 101.1′ . . . 101.N′ to perform the tasks. Thus, in a decentral system environment, program modules may be located in both local and remote memory storage devices. One computing node 101.N′ has been expanded to provide an overview of the components present in the computing node 101.N′. In this example, the computing node 101.N′ comprises the same components as described in relation to FIG. 1A.

FIG. 1C illustrates an example embodiment of a distributed computing environment 100c. In this example, the distributed cloud computing environment 100c may contain the following computing resources: mobile device(s) 114, applications 116, databases 118, data storage 120 and server(s) 122. The cloud computing environment 100c may be deployed as public cloud 124, private cloud 126 or hybrid cloud 128. A private cloud 126 may be owned by an organization and only the members of the organization with proper access can use the private cloud 126, rendering the data in the private cloud at least confidential. In contrast, data stored in a public cloud 124 may be open to anyone over the internet. The hybrid cloud 128 may be a combination of both private and public clouds 124, 126 and may allow to keep some of the data confidential while other data may be publicly available.

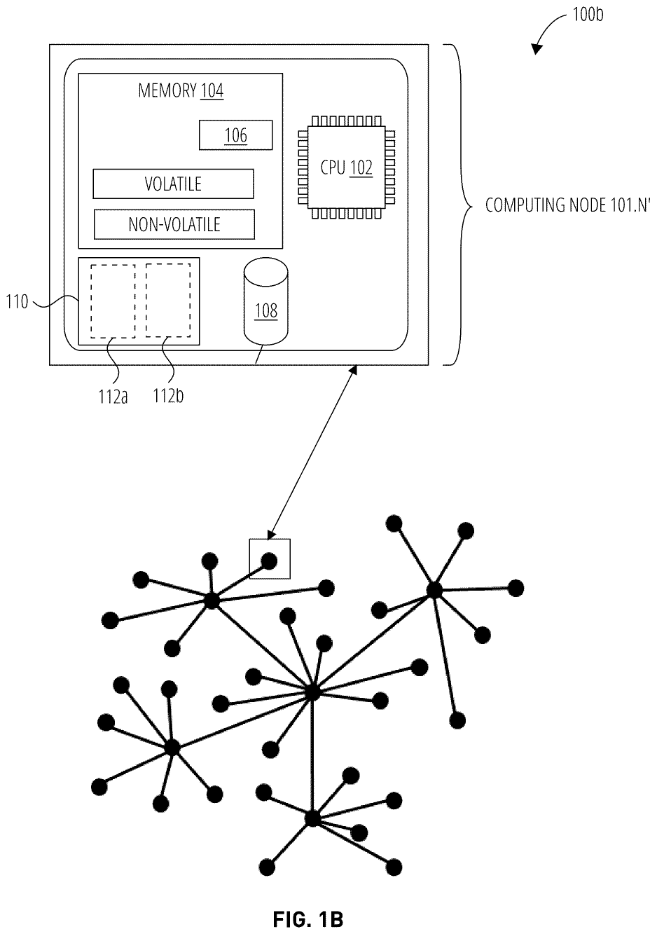

FIG. 2 illustrates an example of a chemical production 204 producing one or more chemical products(s) from one or more inbound material(s) 202 in connection with an operating system 208 including a digital twin management system. The operating system 208 may be used to operate the chemical production 204, for example by managing different production chains present within the chemical production. For producing one or more chemical product(s) 206, different chemical materials 202 (also called inbound material 202 hereinafter) may be provided as physical inputs from material providers or suppliers. The physical inputs to the chemical production 204 may include chemical materials, such raw materials, intermediate materials or a combination thereof. Raw materials may be virgin or recycled raw materials.

The inbound material 202 may be fed into the chemical production 204 at any entry point. The inbound material 202 may be fed into the chemical production 204 at the start of the chemical production 204. The inbound materials may be considered input for the chemical production 204.

The chemical production 204 may be a chemical production network including multiple interlinked processing steps. The chemical production network may be an integrated chemical production network with interrelated production chains. The chemical production network may include multiple different production chains that have at least one intermediate product in common. The chemical production network may include multiple stages of the chemical value chain. The chemical production network may include multiple production chains that produce from one or more inbound material(s) as input chemical products as output. The chemical production network may include multiple tiers of a chemical value chain. The chemical production network may include a physically interconnected arrangement of production sites. The production sites may be at the same location or at different locations. In the latter case, the production sites may be interconnected by means of dedicated transportation systems such as pipelines, supply chain vehicles, like trucks, supply chain ships or other cargo transportation means.

The chemical production 204 may include multiple production steps. The production steps included in the chemical production 204 may be defined by the system boundary of the chemical production 204. The system boundary may be defined by location or control over production processes. The system boundary may be defined by the site of the chemical production 204. The system boundary may be defined by production processes controlled by one entity or multiple entities jointly. The system boundary may be defined by value chain with staggered production processes to an end product, which may be controlled by multiple entities separately.

The chemical production 204 may convert inbound material 202 to one or more chemical products 206 that exit the chemical production 204. The conversion may be performed via intermediate chemical products. The conversion may be a chemical reaction or any other processing step, such as physical processing. The chemical reaction may result in a mixture of different chemical product(s) since the yield of the chemical reaction may be less than 100%. Hence, a chemical reaction of one or more starting materials, such as inbound material(s) 202, may result in a mixture of different chemical product(s). Chemical reactions may therefore be characterized by a one-to-many or many-to-many relationship between starting materials and resulting reaction productions. This is in contrast to discrete manufacturing, where a many-to-one relationship between parts/components and assemblies is existing, e.g. the result of a discrete manufacturing step is a concrete and predictable assembly. Since the yield of a chemical reaction is not 100%, the amount of desired chemical product 206 (e.g. chemical product(s) to be supplied to upstream participants of the chemical ecosystem) is less than the theoretical amount of said chemical product calculated from the amount of starting materials. Such mixtures typically require separation of the different chemical products contained in said mixture. This allows to avoid a negative influence of impurities and unreacted inbound material(s) 202 on the further processing of the chemical product 206. Separation may include distillation, washing, extraction, crystallization and recrystallization. The resulting mixture may contain unreacted starting material, such as unreacted inbound material 202. Unreacted starting material may be reintroduced into the chemical reaction to reduce the amount of required starting material. The resulting mixture may contain desired chemical product(s) 206 to be supplied to upstream participants of the chemical ecosystem, such as chemical product consumers or chemical product processors. The resulting mixture may contain intermediate chemical product(s) used as input material in further chemical reactions performed within the chemical production 204. This allows to reduce the amount of waste associated with the disposal of said intermediate chemical products and/or the amount of energy associated with transportation of these intermediate products to another chemical production. The resulting mixture may contain waste chemical product(s), e.g. chemical product(s) which cannot be used any further and which need to be disposed, for example by burning. Waste chemical products may be produced from undesired chemical side reactions.

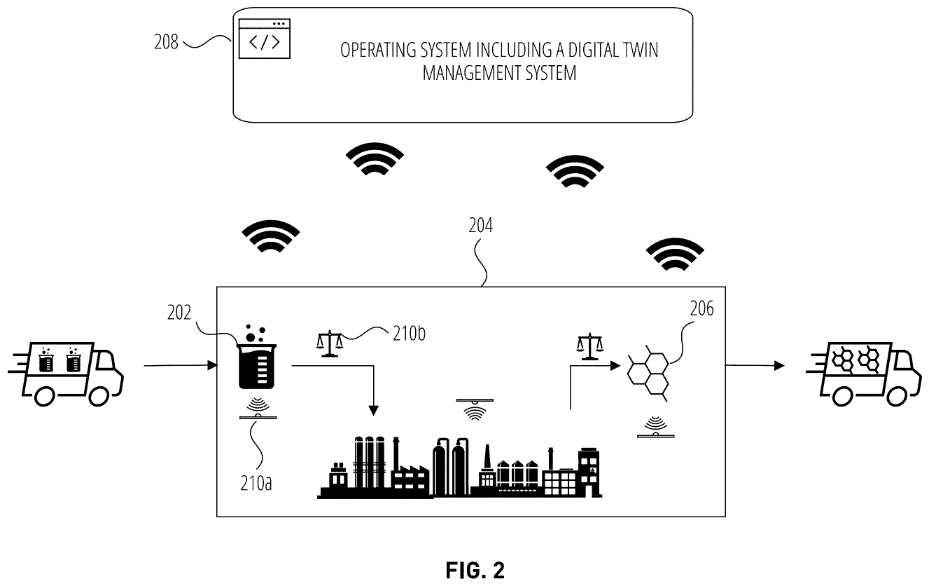

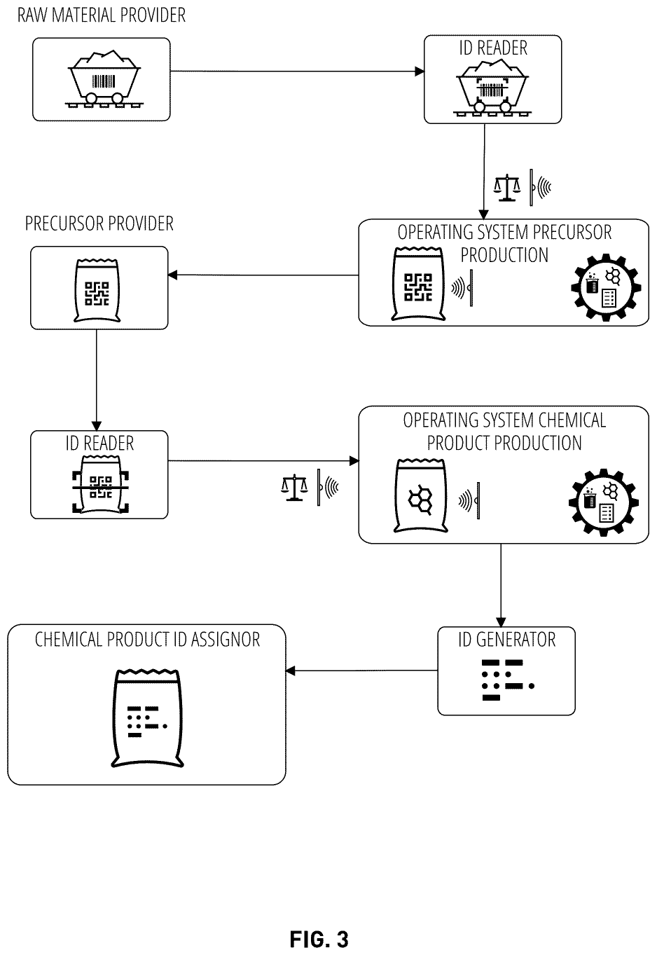

The chemical production 204 may comprise a plurality of sensors 210a, 210b. The sensors 210a, 210b may measure at least one chemical and/or physical property of the chemical product(s) 206 produced by the chemical production 204. The sensors 210a, 210b may measure at least one chemical and/or physical property of the inbound material(s) 202 provided to the chemical production 204. The sensors 210a, 210b may include sensors 2010b configured to determine the amount of inbound material(s) 202 and/or produced chemical product(s). Examples of such sensors may include scales or flow meters. The sensors 210a, 210b may include sensors 210a configured to measure at least one chemical and/or physical property of the inbound material(s) 202. Measurement of chemical and/or physical properties of the inbound material(s) 202 allows to control production processes based on the measured data. The sensors 210a, 210b may include sensors 210a configured to determine chemical and/or physical properties of the produced chemical product 206. Sensors 210a configured to measure chemical properties may measure data associated with or corresponding to the heat of combustion, enthalpy of formation, toxicity, chemical stability in a given environment, flammability, oxidation state(s), ability to corrode, combustibility, acidity and basicity and pH value. Sensors 210a configured to measure physical properties may measure data associated with or corresponding to absorption, brittleness, boiling point, capacitance, color, concentration, density, ductility, distribution, efficacy, elasticity, electric charge, electrical conductivity, electrical impedance, electric potential, flow rate, fluidity, hardness, heat capacity, inductance, intrinsic impedance, luminance, luminescence, luster, mass, melting point, opacity, permeability, permittivity, plasticity, pressure, radiance, resistivity, reflectivity, refractive index, solubility, specific heat, strength, stiffness, temperature, tension, thermal conductivity, thermal resistance, viscosity, volume and wave impedance. Data measured by sensors 210a, 210b may be stored in one or more databases, for example databases contained in data source layer 420 of FIG. 4B. The one or more databases may be distributed databases. The stored data may be interrelated with input material identifier(s) and/or chemical product identifier(s), respectively.

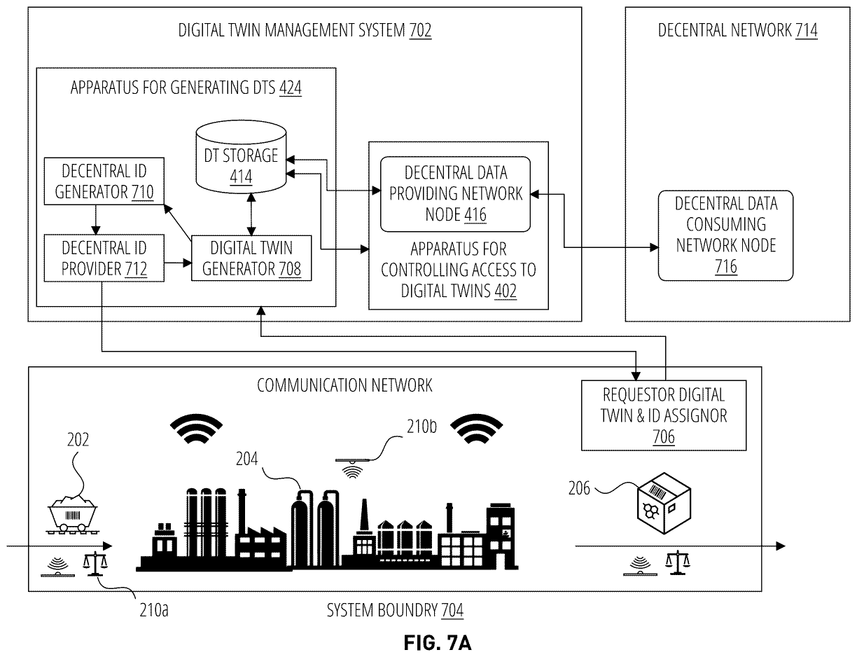

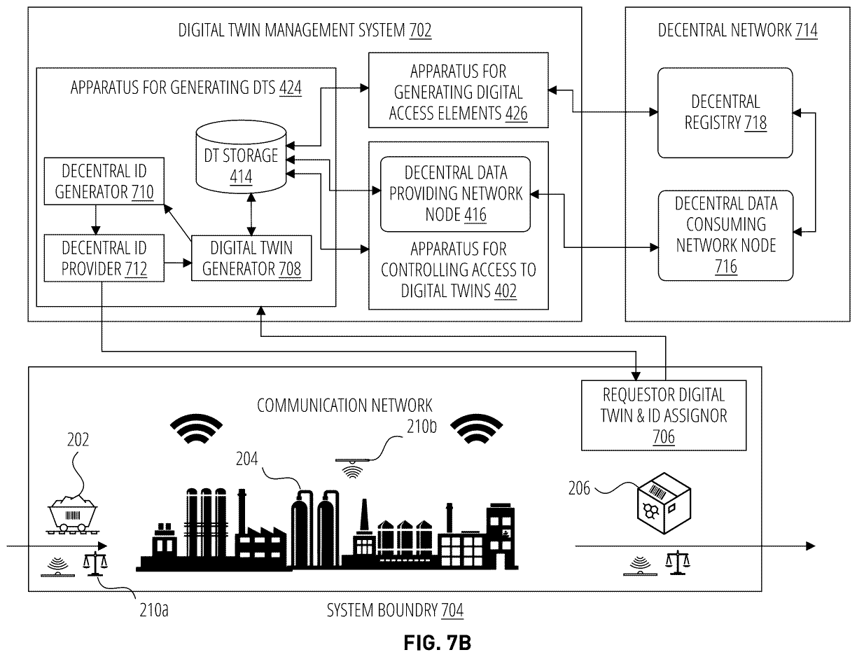

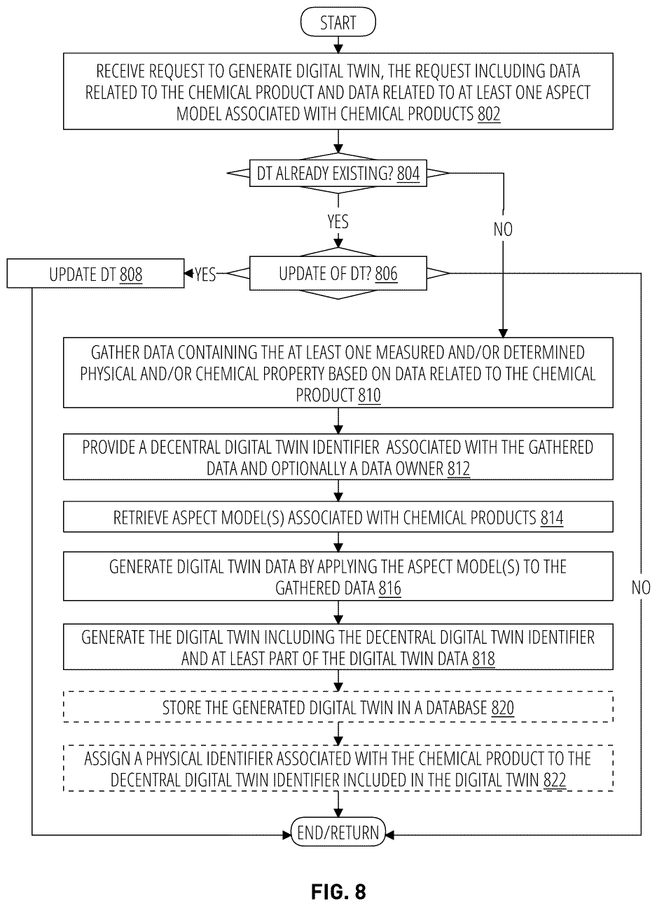

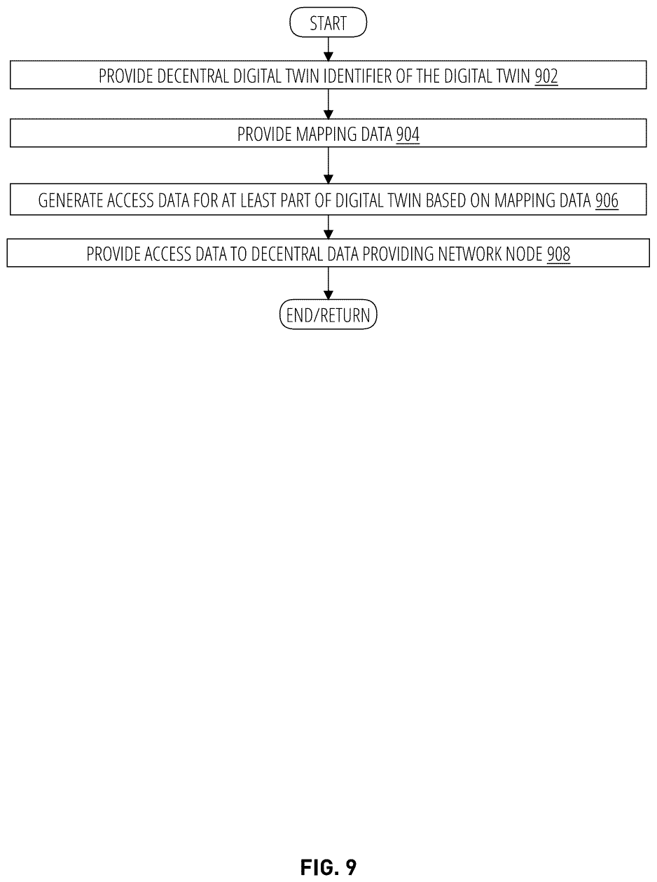

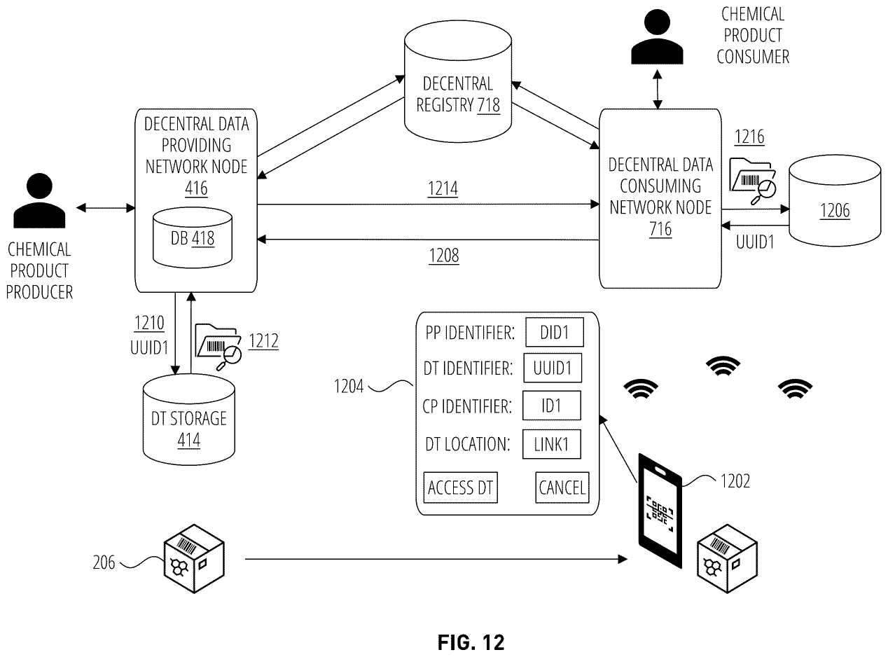

The operating system 208 of the chemical production may monitor and/or control the chemical production 204 based on operating parameters associated with the different processes performed by the chemical production 204. One process step monitored and/or controlled may be the feed of inbound materials 202 or the release of produced chemical product(s) 206. Another process step monitored and/or controlled may be the separation of chemical product(s) contained in mixtures resulting from chemical reactions performed within the chemical production 204. Another process step monitored and/or controlled may be the determination of chemical and/or physical properties of produced chemical product(s) 206 from data collected associated with the production of the chemical product, such as data measured by sensors 210a, 210b before, during and/or after production of the chemical product(s) 206. Another process step monitored and/or controlled may the generation of digital twins, for example using the computer-implemented method and apparatus for generating digital twins, such as the apparatus described in the context of FIGS. 7A, 7B and 8. Yet another process step monitored and/or controlled may be the control of access to generated digital twins by one or more decentral data consuming network nodes, for example as described in the context of FIGS. 4A, 4B, 7A, 7B and 9. Yet another process step monitored and/or controlled may be the generation of digital access elements associated with digital twins of produced chemical products, for example as described in the context of FIG. 7B. Yet another process step monitored and/or controlled may be the authorization of access to the generated digital twin, for example as described in the context of FIGS. 11, 12 and 14.

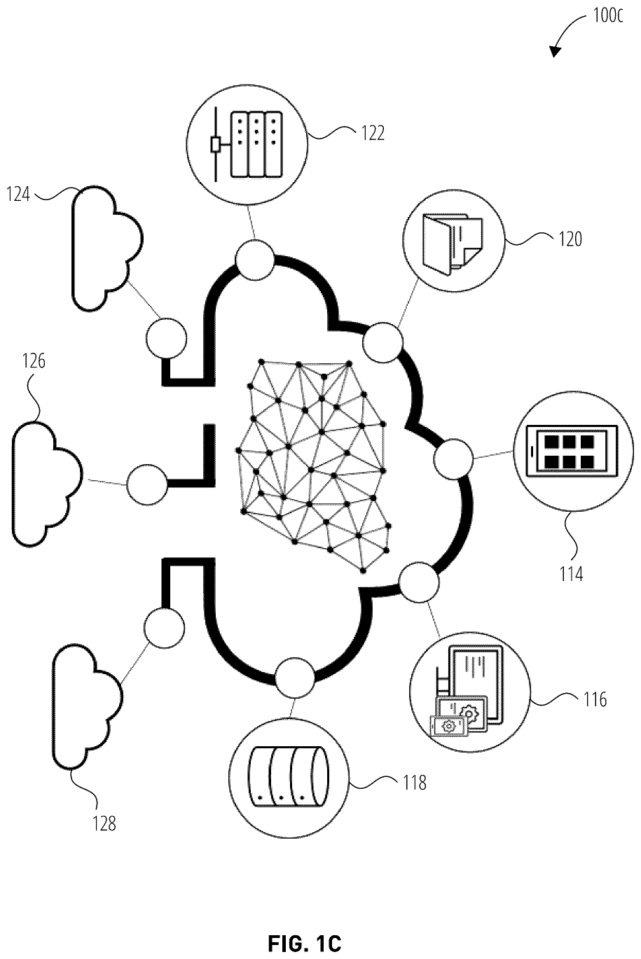

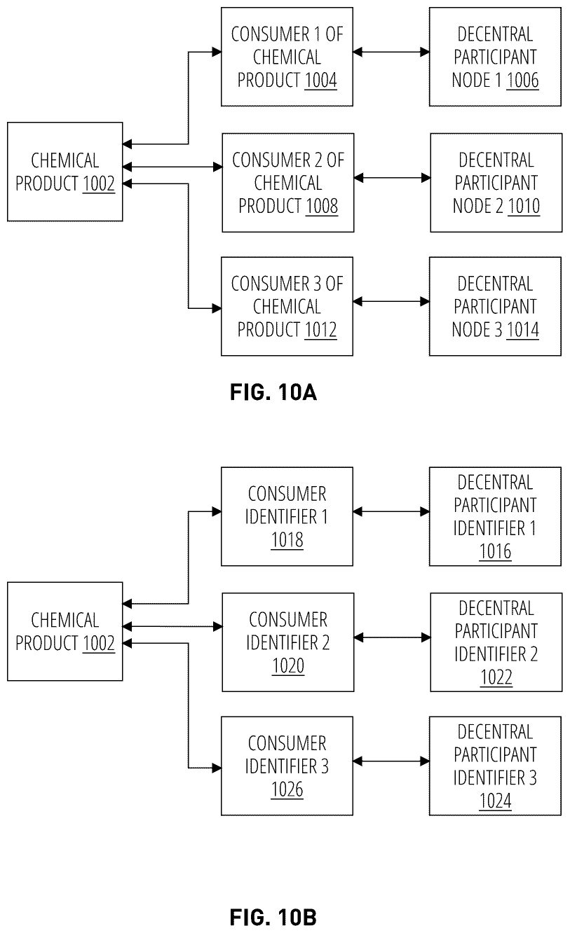

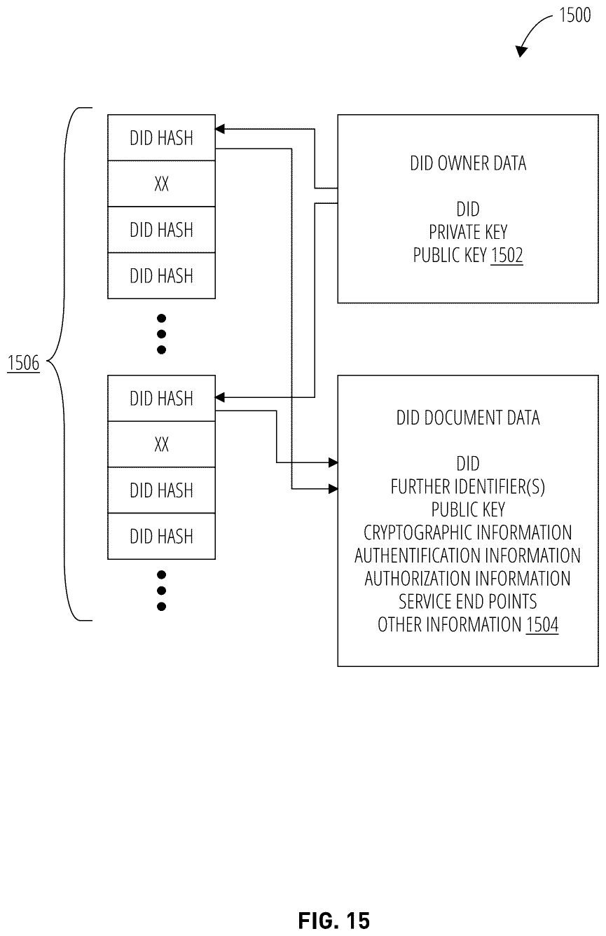

The operating system 208 may be configured to determine physical and/or chemical properties of the chemical product from collected data associated with the production of the chemical product. The operating system 208 may be configured to generate a digital twin of a chemical product, for example as described in the context of FIGS. 3 and 8. The operating system 208 may be configured to generate a digital access element, for example as described in the context of FIG. 14. The operating system may be configured to control access to the digital twin, for example as described in the context of FIG. 9. The operating system may be configured to authorize access to the digital twin, for example as described in the context of FIGS. 11 and 14.

FIG. 3 illustrates an example for generating digital twins for different chemical products in the chemical ecosystem. FIG. 3 specifically illustrates an example for generating a digital twin for a precursor material (e.g. intermediate chemical product) and for generating a digital twin for a chemical product produced at least in part from said precursor material. The chemical product, such as chemical product 206, may be produced by a chemical production 204 comprising an operating system 208, for example as described in the context of FIG. 2.

The production of a chemical product may comprise a two-step process: 1) production of intermediate chemical product(s) from one or more inbound material(s), and 2) production of the chemical product at least in part from the intermediate chemical product(s). To produce the intermediate chemical product(s), inbound materials may be used as physical inputs. The inbound materials may be provided from raw material provider(s). The inbound materials may include virgin or recycled materials. The inbound materials may be provided to an intermediate chemical product production as inbound material 202. The intermediate chemical product production may be a chemical production 204 as described in the context of FIG. 2. The inbound materials may comprise a physical identifier. The physical identifier may be or may be associated with a decentral inbound material identifier. The decentral inbound material identifier may be associated with a digital twin of the inbound materials. The operating system, such as the operating system 208 described in the context of FIG. 2, of the intermediate chemical product production may comprise or be in communication with an ID reader configured to read the physical identifier and to determine the decentral inbound material identifier associated with said physical identifier. The decentral inbound material identifier may be associated with a digital twin or a part thereof of the respective inbound material. The digital twin of the inbound materials may be generated as described in the context of FIG. 7 below. The digital twin may include a measured physical and/or chemical property and/or a physical and/or chemical property determined from collected data associated with the production and/or the use of the inbound material. The physical and/or chemical property may be measured with sensors as described in the context of FIG. 2. The physical and/or chemical property may be determined from collected data as described in the context of FIG. 2. The digital twin may further include the inbound material name, inbound material producer, inbound material declaration data, inbound material safety data, emission data such as CO₂ footprint and/or PCF data, recyclate content data, biobased content data, certificate of analysis data associated with the inbound material, certificates associated with the inbound material or a combination thereof.

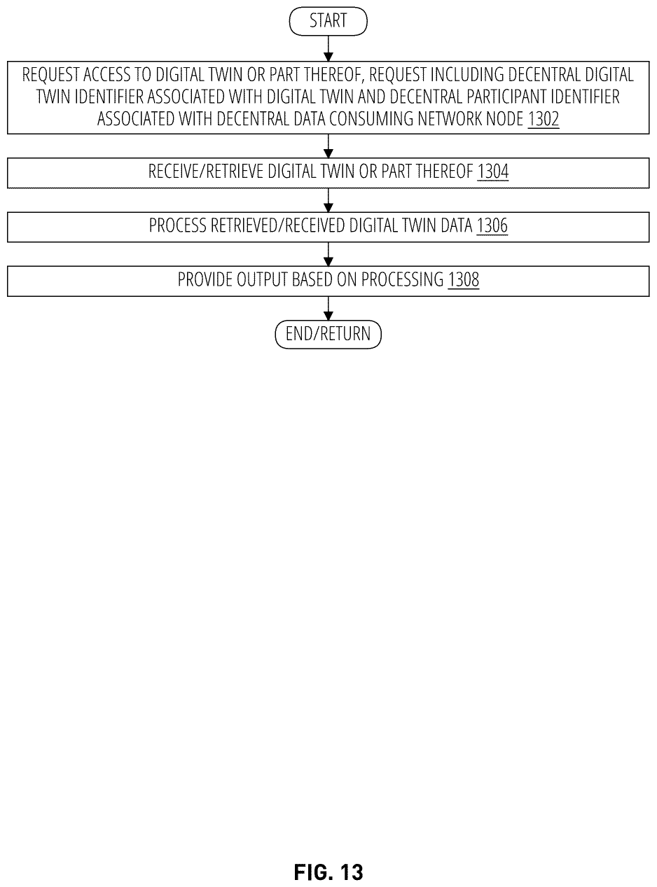

The operating system may be configured to access the digital twin or a part thereof of inbound material(s) provided to the intermediate chemical product production based on the determined decentral inbound material identifier(s) e.g. from decentral data providing network node(s) associated with the inbound material provider(s) (see for example FIG. 12). Such data may be used to operate the chemical production producing the intermediate chemical product(s). For instance, if the inbound material(s) are recycled material(s), production steps purifying the recycled material(s) may be performed. For instance, if the inbound material(s) are virgin materials, purification steps may be omitted. The intermediate chemical product(s) may be formed by chemically reacting the inbound material(s) and/or by physically processing the inbound material(s). Chemical reactions may include polymerization, precipitation and other chemical reactions commonly known. Physical processing may include mixing, grinding, extruding, etc .. The intermediate chemical product production may include sensors, such as sensors 210a, 210b, measuring physical and/or chemical properties of the intermediate chemical product(s) produced by the intermediate chemical product production as described in the context of FIG. 2. The operating system may be configured to determine physical and/or chemical properties from collected data associated with the production of the intermediate chemical product(s), for example as described in the context of FIG. 2.

The operating system may be configured to generate digital twin(s) for the produced intermediate chemical product(s) as described in the context of FIG. 7 below. Each digital twin may include a decentral intermediate chemical product identifier and at least one chemical and/or physical property of the respective intermediate chemical product measured by sensors 210a, 210b and/or at least one physical and/or chemical property of the respective intermediate chemical product determined from collected data. The digital twin may further include decentral inbound material identifier(s) of inbound material(s) used to produce the respective intermediate chemical product. This allows to track the inbound materials used to produce the respective intermediate chemical product. The digital twin may further include data previously described in relation with the digital twin of the inbound material(s). Intermediate chemical product digital access element(s) may be generated, for example as described in the context of FIG. 14. The produced intermediate chemical product(s) may be packaged, and the packaging may include a physical identifier, such as a QR code, an embossed code or an optical holographic code, such as zero-order diffractive microstructure. The physical identifier may be assigned to the respective decentral intermediate chemical product identifier of the digital twin and/or the respective decentral passport identifier of the intermediate chemical product digital access element. The assignment of the physical identifier and the decentral intermediate chemical product identifier may be executed through an ID assignor running locally, in a decentral system and/or in a distributed system. For instance, the packaging line may comprise a labelling device detecting the packaging of the produced intermediate chemical product(s). Based on such recognition, a requestor may generate a request to generate the digital twin and the respective decentral intermediate chemical product identifier included in the generated digital twin may be assigned, for example by the ID assignor, to the respective physical identifier (see also FIGS. 7A, 7B below). Assigning may include encoding the respective decentral intermediate chemical product identifier in a physical identifier and providing the physical identifier, such as a code, to the labelling device configured to attach the physical identifier to the respective intermediate chemical product, such as the packaging of the respective intermediate chemical product. The ID assignor may be part of the labelling device or may be a separate device.

In a second step, the intermediate chemical product(s) produced in step 1) may be provided to a chemical production as inbound material 202 to produce the chemical product 206. The chemical production may be the chemical production 204 described in the context of FIG. 2. The chemical production may be the chemical production producing the intermediate chemical product(s). The chemical production may be different from the chemical production producing the intermediate chemical product(s). Apart from the intermediate chemical product(s) produced in step 1), further inbound material(s) may be provided to the chemical production and may be used to produce the chemical product 206. The intermediate chemical product(s) may comprise recycled intermediate chemical product(s) and/or intermediate chemical product(s) produced by a different intermediate chemical product production than the intermediate chemical product production described in the context of step 1). Such intermediate chemical product(s) may be associated with a physical identifier. The physical identifier may be associated with a decentral intermediate chemical product identifier via which the digital twin or a part thereof of the respective intermediate chemical product may be accessible. An ID reader may be used to read the physical identifier associated with the respective decentral intermediate chemical product identifier as described above. The digital twin or a part thereof may be retrieved via a decentral data consuming network node using the decentral intermediate chemical product identifier as described above.

Production data from the intermediate chemical product production of the intermediate chemical product may be used by the operating system, such as operating system 208 described in the context of FIG. 2, of the chemical production to produce the chemical product 206 as described above. The chemical production may include sensors, such as sensors 210a, 210b, measuring physical and/or chemical properties of the chemical product produced by the chemical production as described in the context of FIG. 2. The operating system may be configured to determine physical and/or chemical properties from collected data associated with the production of the chemical product, for example as described in the context of FIG. 2.

The operating system may be configured to generate a digital twin for the produced or packaged chemical product as described above. The digital twin may include a decentral chemical product identifier and at least one measured and/or determined physical and/or chemical property as outlined above. The digital twin may include decentral intermediate chemical product identifier(s). This allows to track the intermediate chemical product(s) used to produce the chemical product and also indirectly the inbound material(s) used to produce the intermediate chemical product(s). The digital twin may include further data as outlined above, such as the producer name, producer brand, producer identifier, chemical product name, chemical product brand and chemical product identifier.

A digital access element associated with the chemical product may be generated, for example as described in the context of FIG. 14. The decentral chemical product identifier and/or the digital access element may be associated with the chemical product via a physical identifier as described above. The digital access element may include a decentral passport identifier and access data. Access data may include a digital representation pointing to the digital twin or parts thereof. The decentral passport identifier may correspond to or be associated with the decentral chemical product identifier.

FIG. 4A illustrates an example apparatus 402 for controlling access to a digital twin of a physical entity of a chemical product produced from one or more chemical input materials. The access to the digital twin by one or more decentral data consuming network nodes (not shown, see for example FIGS. 7A, 7B) may be controlled by decentral data providing network node 416 associated with the digital twin. The decentral data providing network node may be associated with or connected to data storage(s) storing the digital twin (not shown, see for example FIGS. 7A, 7B)

The apparatus 402 may be included in the operating system 208 of a chemical production 204 producing chemical products from one or more inbound materials (see for example FIG. 2). The chemical products may be intermediate chemical products. The chemical productions may be chemical end products. The apparatus 402 may be communicatively coupled to the operating system 208 of a chemical production 204 producing chemical products. The apparatus 402 may be configured to control access to a digital twin of a chemical product, for example using the method described in the context of FIG. 9.

Apparatus 402 may be coupled to a digital twin (DT) storage 414. DT storage 414 may store digital twins of chemical products. Each digital twins stored in DT storage 414 may include a decentral digital twin identifier and at least one measured and/or determined chemical and/or physical property as previously described. Each digital twin may include further data, such as described in the context of FIG. 3 above. The digital twins stored in DT storage 414 may be generated by an apparatus for generating digital twins (not shown, see for example FIGS. 7A, 7B) using the method described in FIG. 8 below.

Apparatus 402 may comprise a decentral digital twin identifier (ID) providing unit 404 configured to provide the decentral digital twin identifier of the respective digital twin of the chemical product. In this embodiment, the decentral ID providing unit 404 is shown as a separate unit. In another embodiment, the decentral ID providing unit 404 may be part of the access data generator 410. The decentral ID providing unit 404 may provide the decentral digital twin identifier provided in response to a request received at said unit 404. The request may contain the decentral digital twin identifier. The request may contain a chemical product identifier associated with the chemical product and the decentral digital twin identifier providing unit may be configured to provide the decentral digital twin identifier based on the received chemical product identifier. For instance, the decentral digital twin identifier providing unit may retrieve the decentral digital twin identifier from DT storage 414 storing the digital twin based on the chemical product identifier. The request may be generated by the apparatus for generating digital twins after the respective digital twin has been generated. The request may be received from an input/output device (not shown) connected to the decentral ID providing unit 404. For instance, a user may trigger generation of access data via said input/output device, for example by providing the decentral digital twin identifier or the chemical product identifier associated with the respective chemical product.

Apparatus 402 may further comprise a mapping data provider 406 configure to provide mapping data. The mapping data may include data related to the chemical product produced from the one or more chemical input materials interrelated with respective decentral participant identifier(s) associated with decentral participant node(s). The decentral participant node(s) may be decentral data consuming network nodes. The decentral data consuming network nodes may be associated with participants of the chemical product ecosystem receiving or consuming the chemical product (e.g. with consumers of the chemical product). The mapping data may be generated from the data related to the chemical product produced from the one or more input materials and data related to the decentral participant node(s). The data related to the chemical product and the data related to the decentral participant node(s) may be stored in identifier DB 408. The data related to the chemical product may include consumer identifier(s) associated with the chemical product. The consumer identifier(s) may be associated with consumer(s) of the chemical product. The consumer identifier(s) may be associated with participant(s) of the chemical product ecosystem receiving or consuming the chemical product. The consumer identifier(s) may be associated with a chemical product supplied to consumer(s) the consumer identifier(s) is/are associated with. The consumer identifier(s) may be associated with a chemical product identifier associated with the chemical product. The consumer identifier(s) may be interrelated with the chemical product identifier associated with the chemical product. This allows to identify consumer identifier(s) associated with a chemical product using the chemical product identifier associated with said chemical product. The data related to the participant node(s) may include the decentral participant identifier(s) associated with said participant node(s).

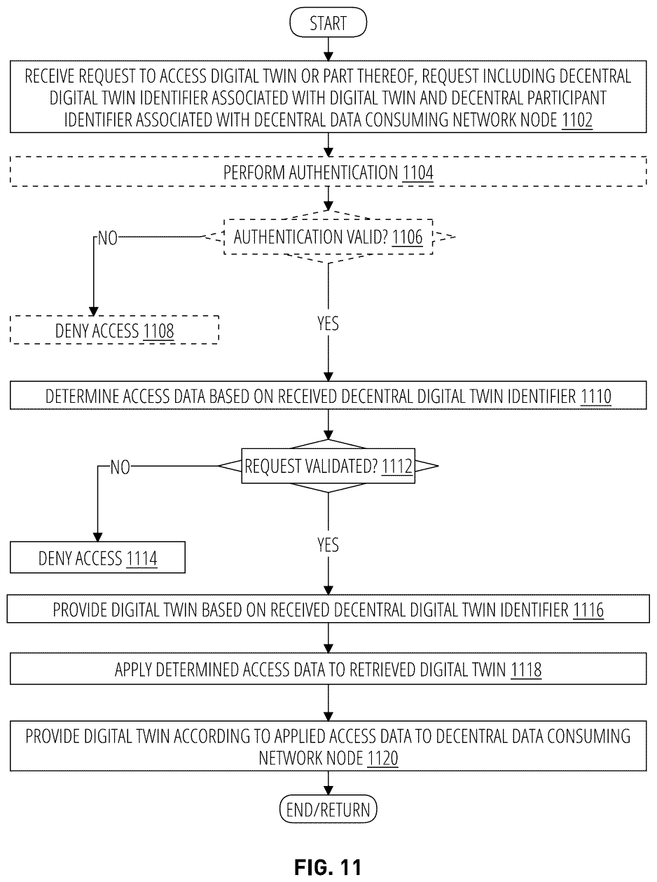

The mapping data provider 406 may further be configured to generate the mapping data. The mapping data provider may be configured to interrelate data related to the chemical product produced from the one or more chemical input materials with respective decentral participants identifier(s) contained in the data related to the decentral participant node(s) based on a relationship representation according to which the data related to the chemical product is associated with the data related to the decentral participant node(s). The relationship representation may specify consumer(s) associated with the chemical product and/or the chemical product associated with consumer(s). The relationship representation may specify the consumer(s) based on consumer identifier(s), such as the consumer identifier(s) contained in the data related to the chemical product, and associated decentral network identifier(s), such as decentral network identifier(s) contained in the data related to the decentral participant node(s). The relationship representation may correspond to a data structure containing the relationship between the chemical product, the consumer identifier(s) and the decentral participant identifier(s). Examples of such relationship representations are illustrated in FIG. 10A and FIG. 10B. The relationship representation may be stored in the identifier DB 408.

Mapping data provider 406 may be configured to verify the data related to the decentral participant node(s). Verification may be done prior to generation of the mapping data or after generation of the mapping data. Verification may be based on a verifiable claim associated with the respective decentral participant identifier as described previously. Verifying ensures that only trusted decentral participant identifier(s) are contained in the mapping data used to generate the access data, hence ensuring that access to the digital twin or a part thereof may only be authorized for trusted decentral data consuming network node(s) of the decentral network.

Apparatus 402 may further comprise an access data generator 410. The access data generator may be connected to the mapping data provider 406, decentral ID provider 404 and rule DB 412. The rule DB 412 may store authorization rule(s) associated with the data related to the chemical product and/or with a chemical product identifier. The access data generator 410 may comprise the mapping data provider 406 (not shown). The access data generator 410 may be configured to generated access data for at least part of the digital twin based on the mapping data provided by mapping data provider 406. The access data generator 410 may be configured to generate access data for each data set contained in the digital twin data. This allows to define the access data on a data set level, hence providing a more granular access to the digital twin data since different access data may be generated and applied to different data sets. The access data generator 410 may be configured to generate access data by selecting authorization rule(s) stored in rule DB 412 based on the provided mapping data. For instance, rule DB 412 may store authorization rule(s) associated with customer identifier(s) and/or with a chemical product identifier. The access data generator 410 may be configured to generate one or more authorization rules based on the decentral participant identifier(s) contained in the mapping data provided by mapping data provider 406. Access data generator 401 may be configured to generate one or more authorization rules based on the data related to the chemical product contained in the mapping data provided by mapping data provider 406.

The access data may include the decentral digital twin identifier provided by decentral ID provider 404 and one or more authorization rule(s) associated with the decentral digital twin identifier. The access data may further include a digital representation pointing to the digital twin or parts thereof. The digital representation may point to DT storage 414 storing the respective digital twin of the chemical product. The access data generator 410 may be configured to generate the digital representation. The one or more authorization rule(s) may define access to and/or usage of at least part of the digital twin for decentral data consuming network node(s) associated with the decentral participant identifier(s) included in the provided mapping data. The one or more authorization rules may include one or more rules that are specific to the decentral participant identifier(s). This enables to control access to the digital twin or a part thereof by the unique liking of the decentral digital twin identifier and the authorization rules via filtering of decentral data consuming network nodes based on the decentral participant identifier associated with each decentral data consuming network node. The one or more authorization rules may include one or more local rules that are specific to a particular location, wherein the location is associated with a jurisdiction and the local rule for the location is associated with legal requirements related to the supply of chemical products. The one or more authorization rules may include one or more rules that are specific to attribute values associated with the participant within the chemical product ecosystem. The attribute values associated with the participant may be associated with or correspond to the role of the participant within the chemical product ecosystem. The one or more authorization rule(s) may include at least one regulatory instruction configured to provide access to digital twin or a part thereof relating to regulatory requirements for the supply of chemical products. the one or more authorization rule(s) may include one or more of prescribed rules relating to emission data, production data, recyclate content data, bio-based content data, provenance data, labour conditions data or combinations thereof. The one or more authorization rule(s) may include obligations of decentral data consuming network node(s) associated with respective decentral participant identifier(s) and/or obligations of decentral network node(s) using the digital twin or a part thereof accessed by data consuming network node(s) associated with respective decentral participant identifier(s).

The access data generator 410 may be configured to provide the generated access data to a decentral data providing network node 416. The decentral data providing network node 416 may be part of apparatus 402. The decentral data providing network node 416 may be in communication with apparatus 402 (not shown). The decentral data providing network node may be part of a decentral network. The decentral data providing network node 416 may comprise database 418. The decentral data providing network node 416 may be configured to store the access data provided by access data generator 410 in database 418. The decentral data providing network node may be configured to control access by decentral data consuming network nodes to the digital twin data based on the decentral digital twin identifier associated with the digital twin of the chemical product and respective access data stored in database 418. This enables to control access to digital twin by the decentral data providing network node based on the unique relationship between the decentral digital twin identifier and the one or more authorization rule(s) by using authorization rule(s) to filter decentral data consuming network node(s) requesting access to the digital twin or a part thereof based on the decentral participant identifier(s) associated with said decentral data consuming network node(s). Decentral data providing network node 416 may be associated with the data owner of the digital twin or a part thereof. The data owner may be the chemical product producer.

FIG. 4B illustrates an example of a system for controlling access to a digital twin of a physical entity of a chemical product produced from one or more chemical input materials. produced from one or more chemical input materials. The access to the digital twin by one or more decentral data consuming network nodes (not shown, see for example FIGS. 7A, 7B) may be controlled by decentral data providing network node 416 associated with the digital twin. The decentral data providing network node may be associated with or connected to data storage(s) storing the digital twin (not shown, see for example FIGS. 7A, 7B)

The system 400b may be included in the operating system 208 of a chemical production 204 producing chemical products from one or more inbound materials (see for example FIG. 2). The chemical products may be intermediate chemical products. The chemical productions may be chemical end products. The system 400b may be communicatively coupled to the operating system 208 of a chemical production 204 producing chemical products. The system 400b may be configured to control access to a digital twin of a chemical product, for example using the method described in the context of FIG. 9.

System 400b may comprise a data source layer 420. The data source layer 420 may comprise one or more distributed data sources. The one or more distributed data sources may be distributed databases. The distributed data source may be a data lake comprising data associated with chemical products from a plurality of distributed data sources. The one or more distributed data sources may contain at least one measured and/or determined chemical and/or physical property of chemical products, such as chemical products 206 produced by chemical production 204 from one or more inbound materials 202 as described in the context of FIGS. 2 and 3. The at least one physical and/or chemical property may be measured using sensors, such as sensors 210a, 210b, and the measured chemical and/or physical property/properties may be stored in the distributed data sources. The at least one physical and/or chemical property may be determined from data acquired from sensors, such as sensors 210a, 210b, before, during and/or after production and the determined chemical and/or physical property/properties may be stored in the distributed data sources. The one or more distributed data sources may further contain chemical product names, chemical product producer, chemical product declaration data, chemical product safety data, emission data, recyclate content data, biobased content data, certificate of analysis data associated with the chemical products, certificates associated with the chemical products or a combination thereof.

The data source layer 420 may be owned or controlled by the data owner of the data associated with chemical product data. The data source layer 404 may be associated with the data owner of the data associated with chemical product data. The data source layer 420 may be connected, for example via a communication interface such as a network or an API, to the digital twin provider layer 428. The data source layer 420 may be connected to a service layer 422 being present in between the data source layer and the data gathering unit 412. Hence, the service layer 422 may be optional in some implementations of the system illustrated in FIG. 4B.

The service layer 422 may be configured to gather data according to predefined selection criteria. The service layer 422 may be configured to apply one or more semantic models on the gathered data to generate a uniform data collection. The service layer 422 may be configured to provide the uniform data collection to a data streaming platform included in the service layer 422. The streaming platform may include a platform that is deployed across a number of hosts, clusters, data centers, and/or other collections of computing resources. The streaming platform may include one or more client processes that generate records of activity and publish the records to one or more event streams. For instance, when a certain type of activity occurs in the data source layer 420, for example provision of a new uniform data collection, production of a new batch of chemical product, measurement or determination of chemical and/or physical property/properties of the produced chemical product, etc., the one or more client processes may generate a record of the activity and publish said record to one or more event streams. The data streaming platform may then propagate the record to one or more components subscribing to the same event streams(s). The data propagated to one or more components may be stored in a database present within the service layer 422 or the digital twin provider layer 428. The data streaming platform thus allows activity occurring in multiple distributed data sources of the data source layer 420 to be captured and transmitted in a unified, scalable manner.

Digital twin provider layer 428 may be configured to provide digital twins of chemical products. Each digital twin may include a decentral digital twin identifier and at least one measured and/or determined physical and/or chemical property. The digital twins may be linked to the chemical products via decentral digital twin identifier. The digital twin provider layer 428 may comprise a digital twin storage for storing digital twins, such as DT storage 414. The digital twin storage may be included in the apparatus for generating digital twins 424. The digital twin provider layer 428 may be configured to generate digital twins of chemical products based on data gathered from data source layer 420, such as measured and/or determined physical and/or chemical property/properties stored in data source layer 420. The digital twins may be generated by an apparatus for generating digital twins 424 (see also FIGS. 7A and 7B). The digital twins may be generated by apparatus 424 using the method described in the context of FIG. 8.

Digital twin provider layer 428 may further comprise an apparatus for generating digital access elements 426, this apparatus being generally optional. Apparatus 428 may generate digital access elements associated with digital twins generated by apparatus 424. Each digital access element may comprise a decentral passport identifier and digital twin location data. The decentral passport identifier may correspond to or be associated with the decentral digital twin identifier of the respective digital twin the digital access element is associated with. The digital access elements generated by apparatus 426 may be provided to the access provider layer 430 (see also FIG. 7B). The digital access elements may be used by decentral data consuming network nodes to access the digital twin associated with the digital access element via the decentral passport identifier.

System 400b may further comprise access provider layer 430 configured to control access to digital twins of chemical products produced from one or more inbound materials. The access provider layer 430 may comprise an apparatus for controlling access to digital twins, such as apparatus 402 described in the context of FIG. 4A. Access to digital twins may be controlled by the decentral data provider network node of access provider layer 430 based on access data generated by apparatus 402 and the respective decentral digital twin identifier associated with the digital twin to be accessed. Access provider layer 430 may be configured to authorize access to a digital twin of a physical entity of a chemical product. The access may be authorized by decentral data providing network node based on the decentral digital twin identifier associated with the digital twin, the access data associated with the decentral digital twin identifier and the decentral participant identifier associated with the decentral data consuming network node requesting access to the digital twin or a par thereof.

System 400b allows to achieve availability, integrity and confidentiality of the digital twin or a part thereof. The access provider layer allows to configure and ensure technically that only defined decentral network participants can access and retrieve the digital twin or a part thereof. For instance, separation of the digital twin generation and the consumption of the digital twin allows to achieve a high and stabile availability of the digital twin within the decentral network.

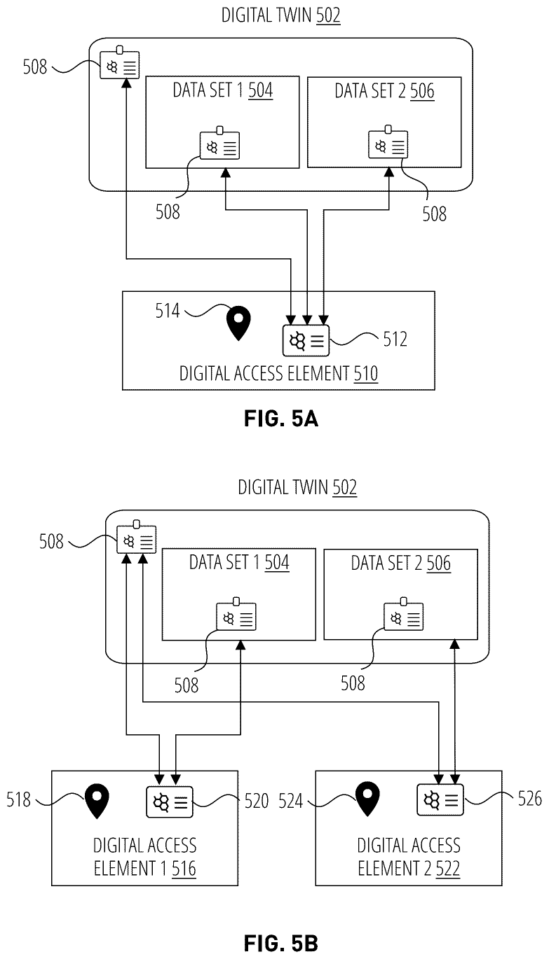

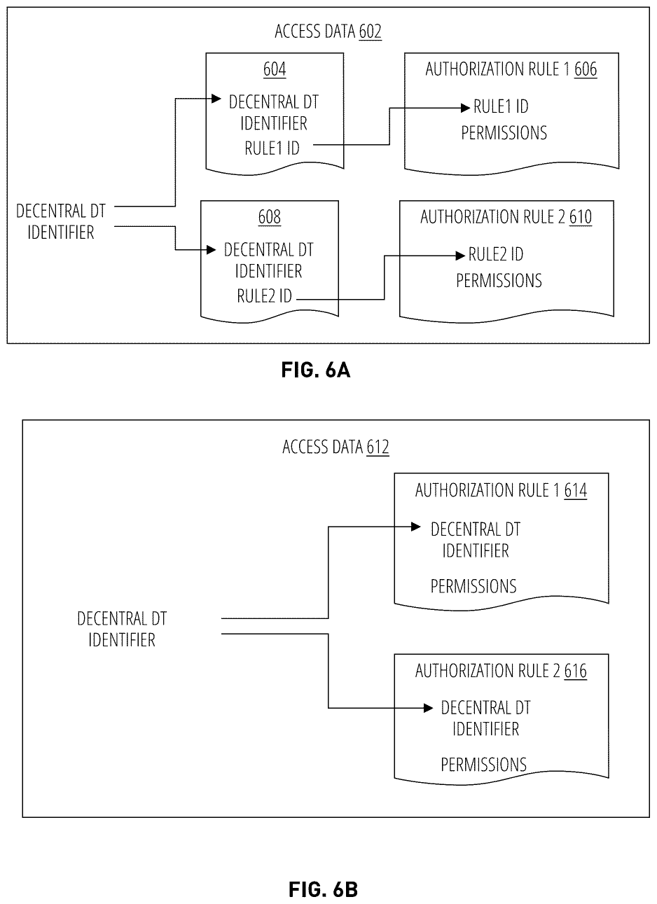

FIG. 6A illustrates a first example of a linkage between the data sets of a digital twin and a digital access element via the decentral digital twin identifier. The digital twin 502 may be generated as described in the context of FIGS. 7A and 8. The digital twin 502 may be stored in DT storage 414. The digital access element 510 associated with the physical entity of the chemical product may be generated as described in FIG. 7B. The data sets 504, 506 associated with the digital twin 502 are each assigned to the decentral digital twin identifier 508. Use of said decentral digital twin identifier 508 hence allows to identify all existing data sets contained in digital twin 502. The decentral digital twin identifier 508 may include further identifiers, such as data set identifiers of data sets 504, 506. This allows to uniquely identify the data sets contained in the digital twin using the decentral digital twin identifier 508 and the respective data set identifier.

The digital access element 510 contains a decentral passport identifier 512. The decentral passport identifier 512 may be a decentral identifier linked to the decentral digital twin identifier 508 included in the digital twin. The decentral passport identifier 512 may correspond to the decentral digital twin identifier 508 included in the digital twin 502. The latter avoids generation of a new decentral identifier and linking of the newly generated decentral identifier to the decentral digital twin identifier included in the digital twin.

The digital access element further contains digital twin location data 514. The digital twin location data 514 may include digital representation(s) pointing directly or indirectly to the storage structure storing the digital twin or a part thereof (e.g. data sets 504, 506), such as DT storage 414 (not shown). The digital twin location data 514 may include a digital representation pointing to the decentral data providing network node associated with DT storage 414 (not shown).

The digital access element 510 is linked via the decentral passport identifier 512 to the digital twin 502 and hence also to the data sets contained in the digital twin, thus allowing to retrieve the digital twin or a part thereof (e.g. the data set 504, 506) using the decentral passport identifier 512 and digital twin location data 514 included in the digital access element 510 as described in the context of FIG. 12.

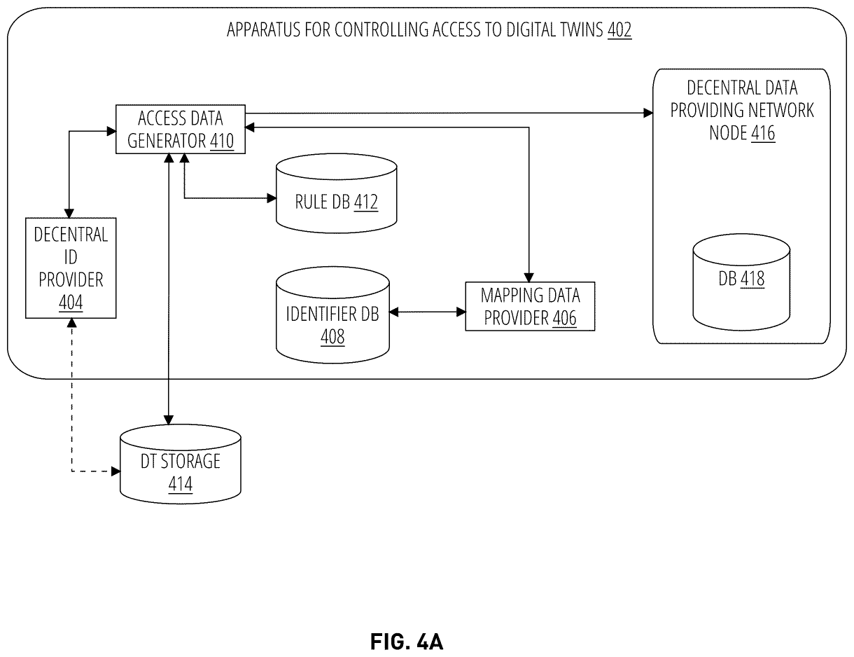

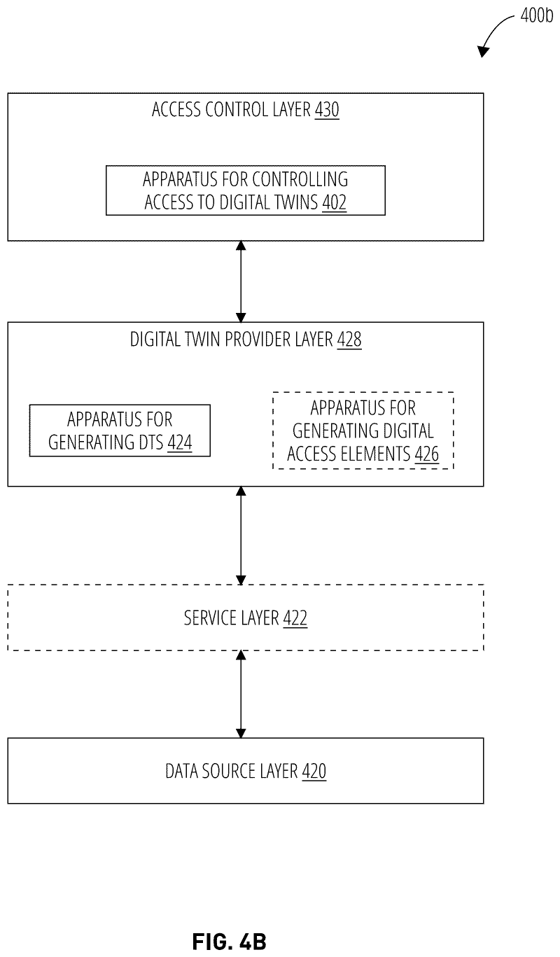

FIG. 5B illustrates a second example of a linkage between the digital twin 502, associated data sets 504, 506 and digital access elements 516, 522 via the decentral digital twin identifier 508 and decentral passport identifiers 520, 526. The digital twin 502 may be generated as described in in the context of FIGS. 7A and 8. The digital access elements 516, 522 associated with the physical entity of the chemical product may be generated as described in FIG. 7B. The data sets 504, 506 associated with the digital twin 502 are assigned to the decentral digital twin identifier 508. Use of said decentral digital twin identifier 508 thus allows to identify all existing data sets contained in digital twin 502.

In this example, a digital access element 516 is generated for data set 504 and a digital access element 522 is generated for data set 506. Digital access elements may be generated for each data set or for at least part of the data sets contained in a digital twin. Each digital access element is linked by the decentral passport identifier 520, 526 via the decentral digital twin identifier 508 to the respective data set. Each digital access element 516, 522 contains digital twin location data 518, 524. Said digital twin location data 518, 524 may include a digital representation pointing to the product data set as described in the context of FIG. 5A.

FIG. 5A and FIG. 5B only show two example embodiments and any number of digital access elements and any number of data sets within the digital twin may be possible. For instance, a first digital access element may be generated for a first number of data sets while a second digital access element may be generated for a second number of data sets. The number of data sets may include one or more data sets.

FIG. 6A illustrates an example of access data 602 including the decentral digital twin identifier and one or more authorization rule(s) 606, 610. The decentral digital twin (DT) identifier may be used to link the access data to a digital twin, hence allowing to control access to said particular digital twin based on the linked access data. This linking also allows the decentral data providing network node to determine the correct access data associated with the decentral digital twin identifier provided by a decentral data consuming network node requesting access to a digital twin. The access data 602 may include the decentral digital twin identifier. The access data 602 may include one or more authorization 606, 610 associated with the decentral digital twin identifier. The one or more authorization rules 606, 610 may be associated with the decentral digital twin identifier via a rule identifier associated with the decentral digital twin identifier and the respective authorization rule. As shown in FIG. 6A, the decentral digital twin (DT) identifier is associated with two rule identifiers (rule 1 ID and rule 2 ID). Each rule identifier is in turn associated with an authorization rule, e.g. authorization rule 1 606 and authorization rule 2 610. Each authorization rule 606, 610 may include the respective rule identifier and permission data defining access to and/or usage of at last part of the digital twin for decentral data consuming network node(s) associated with decentral participant identifier(s). Hence, at least one authorization rule may include decentral participant identifier(s) associated with decentral data consuming network node(s) allowed to access the digital twin or parts thereof. Said authorization rule may act as a whitelist and may be used by the decentral data providing network node associated with the digital twin to filter the decentral data consuming network node(s) requesting access to said digital twin. Only decentral data consuming network node(s) associated with decentral participant identifier(s) contained in said authorization rule may be able to negotiate an electronic contract for the access to the digital twin or a part thereof with the decentral data providing network node. After the electronic contract has been negotiated, access to the digital twin or a par thereof may be authorized by the decentral data providing network node, for example as described in the context of FIG. 11. Authorization rules may include the rules and instructions described in the context of FIG. 4A, such as local rules that are specific to a particular location, rules that are specific to attribute values associated with the participant within the chemical product ecosystem, regulatory instructions and prescribed rules relating to emission data, production data, recyclate content data, bio-based content data, provenance data, labour conditions data or combinations thereof. Authorization rule may include obligations of decentral data consuming network node(s) associated with respective decentral participant identifier(s) and/or obligations of decentral network node(s) using the digital twin or a part thereof accessed by data consuming network node(s) associated with respective decentral participant identifier(s).

FIG. 6B illustrates a further example of access data 612 including a decentral digital twin identifier and one or more authorization rule(s). The decentral digital twin (DT) identifier may be used to link the access data to a digital twin, hence allowing to control access to said particular digital twin based on the linked access data. This linking also allows the decentral data providing network node to determine the correct access data associated with the decentral digital twin identifier provided by a decentral data consuming network node requesting access to a digital twin. In this example, the access data includes the decentral digital twin identifier and two authorization rules 614, 616. Each authorization rule 614, 616 may include the decentral digital twin identifier and may hence be associated with the decentral digital twin identifier included in the access data 612. Each authorization rule 614, 616 may include permission data, such as the permission data mentioned in the context of FIG. 6A. At least one authorization rule may include decentral participant identifier(s) associated with decentral data consuming network node(s) allowed to access the digital twin or parts thereof. Said authorization rule may act as a whitelist as described in the context of FIG. 6A.

FIG. 7A illustrates an example of a digital twin management system and associated methods for controlling access to a digital twin of a chemical product produced from one or more chemical input materials by a chemical production. The digital twin management system 702 may comprise an apparatus for generating digital twins, for example apparatus 424 described below. Digital twin management system 702 may comprise an apparatus for controlling access to digital twins, for example apparatus 402 described in the context of FIG. 4A or system 400b described in relation to FIG. 4B (not shown). The digital twin management system 702 may be included in an operating system of a chemical production (see for example FIG. 2). The digital twin system may be communicatively coupled to the operating system of a chemical production (not shown).

The chemical production may be chemical production 204 described in relation to FIG. 2. The chemical production 204 may produce at least one chemical product 206 from one or more inbound material(s) 202. The inbound materials may be provided to the chemical production 204, for example as described in the context of FIG. 2. The inbound materials may enter the system boundary 704 of the chemical production 204 at the entry point, such as a production plant or a material storage associated with the chemical production 204. The amount of inbound material entering the system boundary 704 of the chemical production 204 may be measured, for example using sensor 210b described in the context of FIG. 2. Chemical and/or physical properties of the inbound material may be measured, for example using sensor 210a described in the context of FIG. 2, upon passing system boundary 704 of the chemical production 204. The measured data may be used to determine at least one chemical and/or physical property of the inbound material.

The inbound materials may be used in the chemical production 204 to produce one or more chemical product(s) from the inbound materials, for example as described in the context of FIG. 2. The operating system 208 of the chemical production 204 may monitor and/or control the chemical production 204 based on operating parameters of the different processes. The operating system 208 may receive production demand data associated with the production planning for the chemical production 204. The production demand data may be produced from target production capacities for one or more chemical product(s) produced by the chemical production 204. The production demand data may be produced from pre-defined production capacities or data-driven models that relate production capacities to market demand data or quantities consumed at the consumption location. The production demand data may include target capacities for chemical products produced by the chemical production 204. The operating system 208 may further receive a bill of materials associated with chemical products to be produced. The bill of materials may include material data associated with the materials used to produce the chemical product, process data associated with the production chain for producing the chemical product and/or chemical product data associated with the chemical product, such as a product specification data or data on the amount of chemical product to be produced.

Based on the received production demand data and the bill of materials, material demand data may be determined. The material demand data may include data on the amount of material required to produce the target capacities of chemical product. The material demand data may include material identifiers associated with materials required to produce the chemical product and data on amounts of material for respective materials. The material demand data may include one or more material specifier(s) per material identifier signifying the material specification. The material demand data may include data on the material amount per material identifier signifying the amount of material to be supplied. The material demand data may specify the production chain(s) of the chemical production 204. The material demand data may include a bill of materials for one or more production chain(s) of the chemical production 204. The material demand data may include one or more recipe(s) specifying one or more material(s) for production process(es) of the chemical production 204. The determined material demand data may be provided for access by a supplier system associated with a supplier outside the physical system boundary of the chemical production 204. Material supply may be triggered by the supplier system accessing the material demand data.

The amount of chemical product(s) resulting from processes performed within chemical production 204, such as chemical reactions and/or physical processing, may be measured using a sensor, such as sensor 210b described in the context of FIG. 2. Since chemical reactions may result in more than one reaction product, e.g. a chemical reaction is associated with a many-to-many relationship between starting materials and resulting reaction products (see also FIG. 2), measuring the amount of chemical product(s) resulting from each chemical reaction performed within chemical production 204 allows to track material flows within the chemical production 204. The measured data may be stored in one or more databases associated with operating system 208. Moreover, chemical reactions and/or physical processes may be monitored using sensors, such as sensors 210b, and the generated monitoring data may be stored in one or more databases associated with operating system 208. The measured amounts of produced chemical products as well as the monitoring data may be used to generate a digital twin of each production process performed within chemical production 204. The measured amounts of produced chemical products as well as the monitoring data may be used to generate a digital twin of the chemical production 204. This digital twin allows to reliably track and account for flows of inbound material, intermediate chemical products and chemical products despite the many-to-many relationships between starting materials and reaction products associated with chemical reactions. Physical and/or chemical properties of produced chemical products may be measured by sensors, such as sensors 210a, and/or determined as described in the context of FIG. 2. The measured and/or determined chemical and/or physical properties of the produced chemical products 206 may be stored in one or more databases associated with operating system 208.

The produced chemical products 206 may be provided at one or more exit points of the chemical production. The chemical product 206 may exit the system boundary 704 of the chemical production 204. Upon producing the chemical product 206 or upon exiting of the chemical product 206 of the chemical production 204, the digital twin may be generated. The digital twin may be generated by apparatus 424. Apparatus 424 may be configured to generate the digital twin as described in the context of FIG. 8. A requestor 706 may be configured to generate the request to generate the digital twin of the produced chemical product 206. The requestor 706 may be included in a labelling device, for example as described in the context of FIG. 3. The request may contain data related to the chemical product, such as a batch number and/or a LOT number. The request may further contain data associated with aspect model(s) related to chemical products, such as aspect model identifier(s). The request to generate the digital twin may be provided to apparatus 424. In response to the request, digital twin generator 708 of apparatus 424 may be configured to generate the digital twin, for example using the method described in FIG. 8.

Digital twin generator 708 may be configured to gather data associated with the chemical product, for example from a data layer such as data source layer 420 (not shown, see for example FIG. 4B), based on the data contained in the received request. Digital twin generator 708 may contain a data gathering unit to gather the data. The gathered data may contain at least one measured and/or determined physical and/or chemical property of the chemical product. Digital twin generator 708 may be configured to determine whether a digital twin associated with the produced chemical product 206 is already existing, for example is already stored in a data storage of apparatus 424, such as DT storage 414 (see FIG. 4A). This avoids generation of already existing digital twins and hence results in a more efficient generation of digital twins.

Digital twin generator 708 may be configured to request a decentral identifier associated with the gathered data and optionally a data owner from decentral ID generator 710. Said request may include at least one authentication mechanism or may include selecting at least one of multiple authentication mechanisms. The request may include an owner identifier and/or a chemical product identifier and/or digital twin location data.

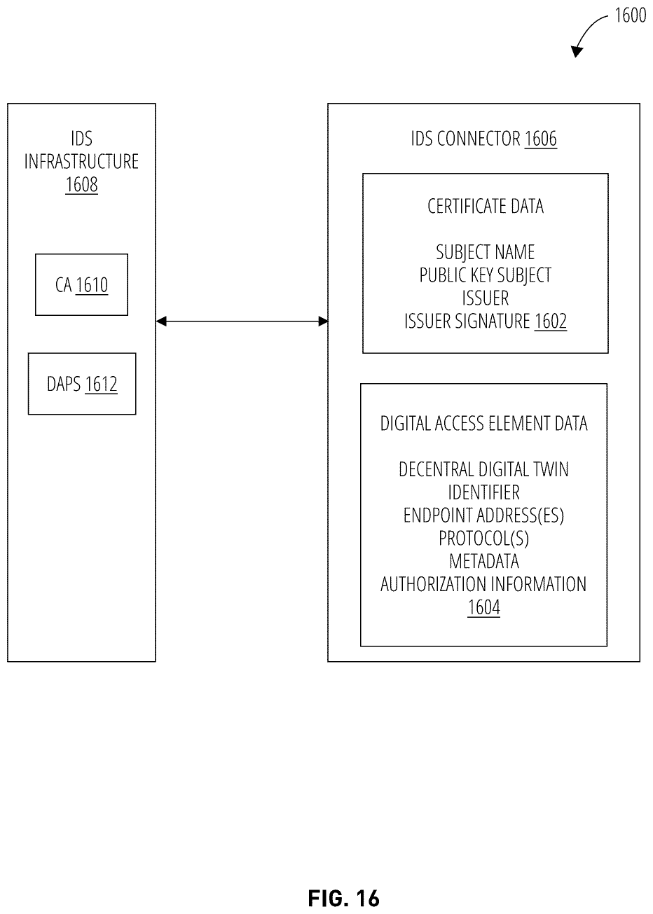

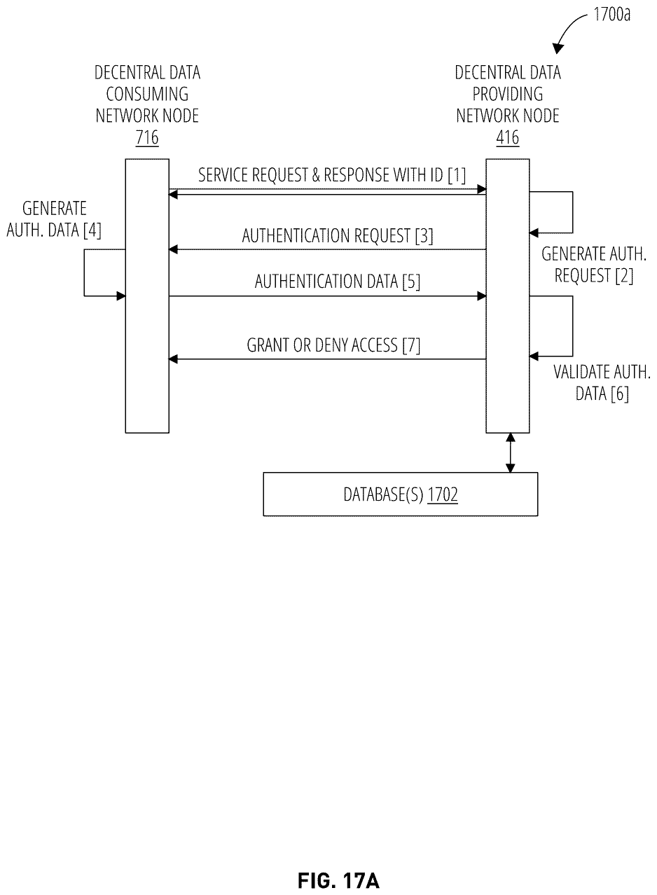

Decentral ID generator 710 may be configured to generate and provide a decentral identifier associated with the gathered data and optionally a data owner, such a data owner of the data associated with the chemical product. Decentral ID generator 710 may be configured to generate a decentral identifier including or being associated with further identifier, such as data set identifier(s). For instance, decentral ID generator 710 may be configured to generate a digital twin identifier, such as a DID or a UUID. Decentral ID generator 710 may be configured to generate digital twin data identifier(s), such as DID(s) and/or UUID(s). Decentral ID generator 710 may comprise a component configured to generate Decentralized Identifier(s) (DID(s)). Decentral ID generator 710 may comprise a component configured to generated Universally Unique Identifiers (UUID(s)). Decentral ID generator 710 may be part of apparatus 424. Decentral ID generator 710 may be communicatively coupled to apparatus 424, e.g. apparatus 424 may not comprise said decentral ID generator 710 (not shown). The decentral identifier generated by decentral ID generator may be one or more DID(s) and/or UUID(s). The one or more DID(s) and/or UUID(s) may be associated with the digital twin and/or the digital twin data. The one or more DID(s) and/or UUID(s) may further be associated with the chemical product. For instance, the decentral identifier may include a digital twin identifier associated with the digital twin and one or more digital twin data identifier(s) associated with digital twin data. The decentral identifier may further include a chemical product identifier associated with the chemical product. Decentral ID generator 710 may be a central or decentral node configured to generate a decentral ID, such as a DID or UUIDv4 as described in relation to FIGS. 15 and 16. Decentral ID generator 710 may be computing node that acts as a DID owner's management module, user agent, ID hub and/or certification issuer. Decentral ID generator 710 may be configured to receive a request to provide a decentral identifier associated with the data associated with the data gathered by digital twin generator 708 and optionally a data owner. Said request may include at least one authentication mechanism or may include selecting at least one of multiple authentication mechanisms. The request may include an owner identifier and/or a chemical product identifier and/or access data as previously described. Decentral ID generator 710 may be configured to generate the decentral identifier as well as data related to the authentication mechanism.

Decentral ID provider 712 may be configured to provide the received decentral identifier to the requestor 706 configured to associate the received decentral identifier with the chemical product. For this purpose, the requestor 706 may include an ID assignor (see for example FIG. 3). The decentral ID provider 712 may be configured to provide the received decentral identifier to an ID assignor configured to associate the received decentral identifier with the chemical product (not shown). Such association may include encoding the decentral identifier into a code, such as a bar code, a QR code, an embossed code, an optical holographic identifier, and providing the generated code for labelling of the chemical product. This way a physical identifier may be provided that relates the physical entity of the chemical product with the decentral identifier of the digital twin and hence the digital twin with the physical entity of the chemical product. Decentral ID provider 712 may be configured to provide the received decentral identifier to digital twin generator 708. Decentral ID generator 710 and decentral ID provider 712 may be separate devices as illustrated in FIG. 7A. Decentral ID generator 710 and decentral ID provider 712 may be contained within one device configured to generate the decentral identifier and to provide the generated decentral identifier (not shown).

In response to receiving the decentral identifier from decentral ID provider 712, digital twin generator 708 may be configured to retrieve at least one aspect model from an aspect model DB 416 (not shown) and to generate digital twin data by applying each retrieved aspect model to the gathered data. For instance, digital twin generator 708 may map the gathered data to the structure and/or properties of the respective aspect model. Each aspect model may include the structure of at least a portion of the digital twin data, and/or properties of the digital twin data. Aspect model database may contain aspect model(s) related to environmental attributes associated with the chemical products. The environmental attributes may relate to emission data, such as CO₂ footprint data, recyclate content, bio-based content, renewable content, certificates, or a combination thereof. Use of different aspect models allows to more granularly structure the digital twin data that is contained in the digital twin, thus allowing to control access and define access data for said digital twin data more granularly. For instance, digital twin data containing access restricted data, such as data related to environmental properties, the composition of the chemical product, etc., may be associated with access data strictly regulating access to said digital twin data while digital twin data containing data required from a regulatory point of view may not be associated with access data or may be associated with access data granting access to said data less strictly. At least part of the generated digital twin data may be stored on a data storage medium, such as DT storage 414 (see FIG. 4A). At least part of the digital twin data may contain a chemical product identifier to allow linkage of the generated digital twin data to the respective chemical product. Digital twin data generated by applying an aspect model to the gathered data and associated with the decentral identifier of the digital twin may be regarded as an asset or aspect of the digital twin. Each asset or aspect may be uniquely identified by the digital twin data identifier. Hence, the combination of decentral identifier and digital twin data identifier may allow to uniquely identify digital twin data associated with a chemical product. Moreover, said combination also allows to specifically retrieve such digital twin data, for example via a decentral data consuming network node using the decentral identifier and digital twin location data as described in the context of FIG. 12.

Digital twin generator 708 may be configured to generate the digital twin, for example in the context of FIG. 8. Generating the digital twin may include assigning the decentral identifier received from decentral ID provider 712 to at least part of the generated digital twin data. For instance, digital twin generator 708 may assign the chemical product identifier contained in at least part of the digital twin data to the received decentral identifier such that at least part of the digital twin data are associated with the decentral identifier. Assigning may include interrelating the decentral identifier with at least part of the digital twin data associated with the chemical product and stored in DT storage 414. The digital twin may include the decentral identifier and at least part of the generated digital twin data. The decentral identifier may include one or more DID(s) and/or UUID(s), for example as described above. The decentral identifier may include one or more DID(s) and/or one or more UUID(s). The one or more DID(s) and/or UUID(s) may be associated with the digital twin and/or at least part of the digital twin data. The one or more DID(s) and/or UUID(s) may further be associated with the chemical product. The digital twin may further include a chemical product identifier.

Digital twin generator 710 may be configured to generate digital twin location data. Digital twin location data may include digital representation(s) pointing to the digital twin data. Digital twin generator 710 to generate a DID document including the decentral identifier received from decentral ID provider 712 and the generated digital twin location data. The DID document may be propagated to a distributed ledger, such as a blockchain or a decentralized file storage system.

Digital twin generator 710 may be configured to store the generated digital twin in DT storage 414.

Apparatus for controlling access to generated digital twins 402 may be configured to generate access data, for example as described in the context of FIGS. 4A, 4B and 9. The access data may include the decentral digital twin identifier of the respective digital twin and one or more authorization rule(s) associated with said decentral digital twin identifier. The one or more authorization rule(s) may define access to and/or usage of at last part of the digital twin for decentral data consuming network node(s) associated with decentral participant identifier(s). Apparatus 402 may generate access data as described in FIGS. 10A and 10B. The access data may be provided to decentral data providing network node 416, for example as described in the context of FIG. 4A. Decentral data providing network node 416 may be associated with the chemical production 204 producing the chemical product 206. Decentral data providing network node 416 may be associated with the data owner of the digital twin, such as the chemical product producer. Decentral data providing network node 416 may be configured to control access to the digital twin or parts thereof, such as digital twins stored in DT storage 414, based on the access data provided by apparatus 402, for example as described in the context of FIG. 11. Use of the access data allows to filter decentral data consuming network nodes based on the decentral participant identifier associated with said decentral data consuming network nodes, hence ensuring that only decentral data consuming network nodes associated with decentral participants receiving and consuming the chemical product can access the digital twin or a part thereof.

FIG. 7B illustrates an example of an apparatus and associated methods for controlling access and authorizing access to a digital twin of a chemical product produced from one or more chemical input materials by a chemical production. The digital twin management system 702 may comprise an apparatus for generating digital twins, for example apparatus 424 described in the context of FIG. 7A. Digital twin management system 702 may comprise an apparatus for controlling access to digital twins, for example apparatus 402 described in the context of FIGS. 4A and 7A or system 400b described in relation to FIG. 4B (not shown). Digital twin management 702 may comprise an apparatus for generating digital access elements, such as apparatus 426. The digital twin management system 702 may be included in an operating system of a chemical production (see for example FIG. 2). The digital twin system may be communicatively coupled to the operating system of a chemical production (not shown).

The chemical production may be chemical production 204 described in relation to FIGS. 2 and 7A. The chemical production 204 may produce at least one chemical product 206 from one or more inbound material(s) 202, for example as described in the context of FIG. 7A. The produced chemical products 206 may be provided at one or more exit points of the chemical production. The chemical product 206 may exit the system boundary 704 of the chemical production 204. Upon producing the chemical product 206 or upon exiting of the chemical product 206 of the chemical production 204, the digital twin may be generated, for example as described in FIGS. 7A and 8. A requestor 706 may be configured to generate the request to generate the digital twin of the produced chemical product 206, for example as described in the context of FIG. 7A. The generated digital twin may be stored in DT storage 414. The digital twin may contain a decentral identifier and digital twin data. The decentral identifier may be assigned to chemical product 206 by an ID assignor 706, for example as described in the context of FIGS. 3 and 7A.

Apparatus for controlling access to generated digital twins 402 may be configured to generate access data, for example as described in the context of FIGS. 4A, 4B, 7A and 9. The access data may be provided to decentral data providing network node 416, for example as described in the context of FIGS. 4A and 7A.

Apparatus for generating digital access elements 426 may be configured to generate a digital access element associated with the chemical product. The digital access element allows for an indirect access to the digital twin or parts thereof, i.e. an access to the digital twin or parts thereof via the digital access element. Access to the digital access element itself can remain unrestricted while still allowing for controlled access to the digital twin or parts thereof. The digital access element may include a decentral passport identifier and digital twin location data. The decentral passport identifier is or is associated with the decentral digital twin identifier of the digital twin associated with the chemical product. The decentral identifier may further be associated with a data owner. The data owner may be the data owner of the digital twin data contained in the digital twin as described in the context of FIG. 7A. The data owner may be the chemical product producer as described in the context of FIG. 7A. The decentral identifier may include one or more UUID(s) and/or one or more DID(s), for example as described in the context of FIG. 7A. The one or more DID(s) and/or UUID(s) may be associated with the digital twin and/or the digital twin data contained in the digital twin. The one or more DID(s) and/or UUID(s) may further be associated with the chemical product.

The digital access element may correspond to a DID document including the decentral digital twin identifier as DID. Such DID document may further contain digital twin data identifiers associated with digital twin data contained in the digital twin and digital twin location data. Digital twin location data may include digital representations pointing to the digital twin or a part thereof, for example as described in the context of FIG. 7A. The digital access element may correspond to a DID document containing a decentral passport identifier associated with the digital twin identifier. Such DID document may further contain digital twin data identifiers associated with digital twin data contained in the digital twin and digital twin location data. The digital access element may correspond to a data structure comprising the decentral passport identifier and digital twin location data.

The digital access element may be generated in response to generating the digital twin. Hence, generation of the digital access element by apparatus 426 may be triggered by apparatus 424, e.g. when apparatus 424 has generated the respective digital twin. The request to generate the digital access element may contain an owner identifier and/or a chemical product identifier as described in the context of FIG. 7A.

The digital access element may be generated by providing the decentral passport identifier and digital twin location data. Providing the decentral passport identifier may include retrieving the decentral digital twin identifier contained in the respective digital twin and providing the retrieved decentral digital twin identifier. For instance, the decentral identifier included in the generated digital twin may be retrieved from digital twin storage 414. The respective digital twin may be identified using the chemical product identifier contained in the received request. For instance, the chemical product identifier may be used to retrieve the decentral digital twin identifier contained in the digital twin associated with said chemical product identifier. Use of the decentral identifier contained in the digital twin allows to avoid generation of a further decentral identifier, hence allowing a more effective generation of the digital access element.

Providing the decentral passport identifier may include generating a further decentral identifier and providing the generated further decentral identifier. The further identifier may include one or more DID(s) and/or one or more UUID(s) as mentioned previously. The further decentral identifier may be assigned to the decentral identifier contained in the digital twin. This allows to link the digital twin with the generated digital access element, hence allowing access to the digital twin or a part thereof using the digital access element. Use of a further decentral identifier allows to use different identifier schemes, such as UUID and DID. This may allow to store access data necessary to access the digital twin or a part thereof, such as chemical product data set(s) contained in the digital twin, in a decentralized manner using a DID document.

Providing digital twin location data may include generating digital twin location data and providing the generated digital twin location data. Providing digital twin location data may include retrieving digital twin location data stored in DT storage 414. The digital twin location data may point directly or indirectly to DT storage 414 storing the respective digital twin. The digital twin location data may refer to any data for accessing the digital twin or a part thereof, for example as described in the context of FIG. 7A. For instance, the digital twin location data may include an endpoint for data exchange or sharing (resource endpoint) or an endpoint for service interaction (service endpoint), that is uniquely identified via a communication protocol. The endpoint may be represented by the decentral data providing network node 416. The digital twin location data may include multiple digital representations, each digital representation pointing to different digital twin data contained in the digital twin. The decentral passport identifier and the digital twin location data may be associated with each other. Hence, for instance, the decentral passport identifier based on which the digital access element is generated may be associated with authentication information which is used as digital twin location data based on which the digital access element is generated.

A physical identifier associated with the chemical product may be assigned to the decentral passport identifier included in the generated digital access element. Apparatus 426 may be configured to provide the decentral passport identifier to the requestor 706 configured to associate the received decentral passport identifier with the chemical product. For this purpose, the requestor 706 may include an ID assignor as described in the context of FIGS. 3 and 7. This allows to link the decentral passport identifier and hence the digital twin associated with the decentral passport identifier with the physical entity of the chemical product. The physical identifier may correspond to a code, such as a bar code, a QR code, an embossed code, an optical holographic code, such as zero-order diffractive microstructures, or a tag, such as an RFID tag. The physical identifier may be produced by a labelling machine, for example as described in the context of FIG. 7A.

Apparatus 426 may be configured to provide the generated digital access element to an access element registry accessible by a decentral data consuming network node 716. The decentral data consuming network node may use the data contained in the digital access element, such as the decentral passport identifier and the digital twin location data, to access the digital twin associated with the decentral passport identifier from decentral data providing network node 416, for example as described in the context of FIG. 12. The decentral data providing network node 416 may authorize access to the digital twin based on the decentral digital twin identifier associated with the digital access element, the decentral participant identifier associated with the decentral data consuming network node requesting access to said digital twin and the access data provided by apparatus 402.

FIG. 8 illustrates a flow chart of a computer-implemented method for generating a digital twin of a physical entity of a chemical product in accordance with an example embodiment of the present disclosure. The digital twin may be generated for a chemical product 206 produced by a chemical production 204 from one or more inbound materials 202. The chemical production may be a chemical production 204 as described in relation to FIGS. 2 and 3. The digital twin may be generated by operating system 208 of the chemical production 204. The operating system may comprise an apparatus for generating digital twin(s) 424 as described in the context of FIG. 7A. The request to generate the digital twin may be triggered manually by a user via a user interface. The request to generate the digital twin may be triggered automatically, for example upon detection of a packaging of the produced chemical product as described in the context of FIG. 3 and FIG. 7A.

In block 802, a request to generate a digital twin of a chemical product may be received. The request may contain data related to the chemical product. The request may further contain data related to at least one aspect model associated with chemical products. The request may be generated manually or automatically, as previously described. Data related to the chemical product may include a chemical product identifier, such as a batch number, a LOT number, a chemical product name and/or a chemical product ID. Data related to at least one aspect model may include aspect model identifier(s).

In block 804, it is determined whether a digital twin for the chemical product is already existing. Hence, it may be determined whether the digital twin has already been generated and stored, for example in DT storage 414. This determination may be based on the data related to the chemical product contained in the received request, such as the chemical product identifier. For instance, the chemical product identifier may be used to determine whether a digital twin associated with said chemical product identifier is already existing, e.g. already stored in DT storage 414. If a digital twin of the chemical product is already existing, the method proceeds to block 806. Otherwise, the method proceeds to block 810 as described later on.

In block 806, it is determined whether the existing digital twin is to be updated. The determination may be made based on data contained in the received request. For instance, the request may contain data being indicative of updating the digital twin. If a digital twin is to be updated, the method proceeds to block 808. Otherwise, the method ends or proceeds to block 802.

In block 808, the digital twin is updated. Updating may include performing blocks 810, 814 and 816 described later on, e.g. generating further digital twin data. Updating may include changing digital twin data contained in the existing digital twin.

In block 810, data containing the at least one measured and/or determined physical and/or chemical property of the chemical product may be gathered based on the data related to the chemical product contained in the request received in block 802. The data may be gathered as described in the context of FIG. 7A from one or more data sources, for example distributed data sources of data source layer 420 (see FIG. 4B). The data may be gathered directly from the one or more distributed data sources of data source layer 420. The data may be consumed from service layer 422, for example as described in the context to FIG. 4B. Apparatus 424 may determine whether the request contains chemical product identifier(s). If this is the case, said chemical product identifier(s) may be used to gather the data from the distributed data source(s). Otherwise, apparatus 424 may determine the chemical product identifier(s) from the data contained in the received request. For instance, the chemical product identifier(s) may be retrieved from a database based on the data contained in the received request.

In block 812, a decentral digital twin identifier associated with the gathered data and optionally a data owner may be provided. The decentral digital twin identifier may be provided in response to a request generated, for example, by digital twin generator 708 of apparatus 424 (see FIG. 7A). The request may contain a data owner identifier and/or a chemical product identifier. The data owner may be the data owner of the gathered data and/or the data contained in the distributed data sources. The data owner may be the chemical product producer. The data owner may be a data owner as previously described. The decentral digital twin identifier may be requested from a central or decentral node, for example as described in the context of FIG. 7A. The decentral identifier may be one or more DID(s) and/or UUID(s), for example as described in the context of FIG. 7A. Block 812 may also be performed after any one of blocks 814 and 816.

In block 814, aspect model(s) associated with chemical products may be retrieved, for example as described in the context of FIG. 7A. At least part of the aspect model(s) may be associated with environmental attributes associated with chemical products. The aspect model(s) may be retrieved based on aspect model identifier(s) contained in the received request or based on data contained in the received request. The aspect model(s) may be retrieved from a data storage.

In block 816, digital twin data may be generated for each aspect model retrieved in block 808. The digital twin data may be generated by applying each aspect model retrieved in block 814 to the data gathered in block 810, for example as described in the context of FIG. 7A.

In block 818, the digital twin may be generated. The digital twin may include the decentral digital twin identifier received in block 812 and at least part of the digital twin data generated in block 810. The decentral digital twin identifier may be assigned to at least part of the digital twin data generated in block 810. The digital twin may further include a chemical product identifier. The chemical product identifier may be the chemical product identifier contained in the received request.

In block 820, the generated digital twin may be stored in a DT storage 414 as described in the context of FIG. 7A, this block being generally optional. Storage of the digital twin in DT storage 414 may improve security with respect to the access to the digital twin, since appropriate authentication and authorization schemes may be implemented between DT storage 414 and the decentral data providing network node providing the digital twin or a part thereof to authorized decentral data consuming network nodes.

In block 822, a physical identifier may be assigned to the decentral digital twin identifier included in the digital twin, this block being generally optional. This block may be performed, for example, if the decentral identifier contained in the digital twin is used to generate the digital access element (see for example FIG. 9). This allows to link the decentral identifier and thus the digital twin to the physical entity of the chemical product. Assigning the decentral identifier to the physical identifier may include generating a physical identifier having embedded the decentral identifier. The physical identifier may be generated by an ID assignor, for example as described in the context of FIG. 5, and may be attached to the chemical product, for example using a labelling device.

FIG. 9 illustrates a flow chart of a computer-implemented method for controlling access to a digital twin of a physical entity of a chemical product in accordance with an example embodiment of the present disclosure. The digital twin may be generated for a chemical product 206 produced by a chemical production 204 from one or more inbound materials 202. The chemical production may be a chemical production 204 as described in relation to FIGS. 2 and 3. The digital twin may be generated by operating system 208 of the chemical production 204. Access data for controlling access to the digital twin may b generated by apparatus 402 described in the context of FIG. 4A or system 400b described in the context of FIG. 4B. The operating system may comprise an apparatus for generating digital twin(s) 424 as described in the context of FIG. 7A. The operating system may comprise an apparatus or system for controlling access to the digital twin as described in the context of FIGS. 4A and 4B. The digital twin may be generated according to the method described in FIG. 8.

In block 902, the decentral digital twin identifier of the digital twin is provided. The decentral digital twin identifier may be provided by a decentral digital twin identifier providing unit, such decentral ID provider 404 of FIG. 4A. The decentral digital twin identifier may be provided as described in the context of FIG. 4A.

In block 904, mapping data is provided. The mapping data may include data related to the chemical product produced from the one or more chemical input materials interrelated with respective decentral participant identifier(s) associated with decentral participant node(s). The mapping data may be generated from the data related to the chemical product produced from the one or more input materials and data related to the decentral participant node(s), for example as described in the context of FIG. 4A. Generating mapping data may include verification of the data related to the decentral participant node(s) as described in the context of FIG. 4A.

In block 906, access data may be generated for at least part of the digital twin based on the provided mapping data. The access data may be generated as described in the context of FIG. 4A. The access data may include the decentral digital twin identifier provided by decentral ID provider 404 and one or more authorization rule(s) associated with the decentral digital twin identifier. The access data may further include a digital representation pointing to the digital twin or parts thereof. The digital representation may point to DT storage 414 storing the respective digital twin of the chemical product. The one or more authorization rule(s) may define access to and/or usage of at least part of the digital twin for decentral data consuming network node(s) associated with the decentral participant identifier(s) included in the provided mapping data, for example as described in the context of FIG. 4A.

In block 908, the generated access data may be provided to a decentral data providing network node, f or example as described in the context of FIG. 4A. The decentral data providing network node may be associated with the unit generating the access data (see for example FIGS. 4A and 4B). The decentral data providing network node may be configured to control access by decentral data consuming network nodes to the digital twin data based on the decentral digital twin identifier associated with the digital twin of the chemical product and respective access data stored in database 418. This enables to control access to digital twin by the decentral data providing network node based on the unique relationship between the decentral digital twin identifier and the one or more authorization rule(s) by using authorization rule(s) to filter decentral data consuming network node(s) requesting access to the digital twin or a part thereof based on the decentral participant identifier(s) associated with said decentral data consuming network node(s). Decentral data providing network node 416 may be associated with the data owner of the digital twin or a part thereof. The data owner may be the chemical product producer.

FIG. 10A illustrates an example of a relationship representation which may be used to generate mapping data. The relationship representation may be used by mapping data provider 406 of apparatus 402 to generate mapping data, for example as described in the context of FIGS. 4A, 4B and 9. The relationship representation may relate a chemical product 1002 to one or more consumers of the chemical product 1004, 1008, 1012.

The chemical product 1002 may be a chemical product produced by a chemical production, such as chemical production 204 described in the context of FIGS. 2, 7A and 7B. The chemical product 1002 may be a chemical product producible by a chemical production, such as chemical production 204 described in the context of FIGS. 2, 7A and 7B. The chemical product 1002 may be associated with data related to said chemical product. Such data may include a chemical product identifier, a chemical product name or a combination thereof. The chemical product 1002 may be associated with each batch of produced chemical product. The chemical product 1002 may represent a produced batch of chemical product.

The one or more consumers may be chemical product processors, e.g. may receive the chemical product and may process the chemical product to produce further chemical or discrete products. The one or more consumers of the chemical product 1004, 1008. 1012 may be associated with decentral participant network nodes 1006, 1010, 1014. The respective decentral participant network nodes may be operated by the respective consumer. The decentral network participant nodes may correspond to decentral data consuming network nodes. Said decentral data consuming network node(s) may be configured to request access to the digital twin of the chemical product at a decentral data providing network node associated with said digital twin. The relationship representation illustrated in FIG. 10A hence allows to identify consumers and associated decentral participant network node(s) of a chemical product.

The relationship representation may be a data structure defining the relationship between a chemical product 1002, customers of the chemical product and decentral network node(s) associated with said customers.

FIG. 10B illustrates a further example of a relationship representation which may be used to generate mapping data. The relationship representation may be used by mapping data provider 406 of apparatus 402 to generate mapping data, for example as described in the context of FIGS. 4A, 4B and 9. The relationship representation may relate a chemical product 1002 to data related to the chemical product produced from the one or more chemical input materials and data related to the decentral participant node(s).

The chemical product 1002 may be a chemical product produced by a chemical production, such as chemical production 204 described in the context of FIGS. 2, 7A and 7B. The chemical product 1002 may be a chemical product producible by a chemical production, such as chemical production 204 described in the context of FIGS. 2, 7A and 7B. The chemical product 1002 may be associated with data related to said chemical product. Such data may include a chemical product identifier, a chemical product name or a combination thereof. The chemical product 1002 may be associated with each batch of produced chemical product. The chemical product 1002 may represent a produced batch of chemical product.

The data related to the chemical product may contain consumer identifier(s) associated with consumers of the chemical product, such as consumer identifier 1 1018, consumer identifier 2 1020 and consumer identifier 3 1026. The consumer identifier(s) may be unique identifiers used within the chemical production producing the chemical product, such as chemical production 204 of FIGS. 2, 7A and 7B. The consumer identifier(s) may not be unique within a decentral network associated with the chemical production, for example via a decentral data providing network node associated with said chemical production (see FIGS. 2, 4A, 7A, 7B). The consumer identifier(s) may not be known to other decentral network participant(s). The data related to the chemical product may contain the chemical product identifier. This allows to relate the data related to the chemical product to chemical product 1002 to provide a relationship to the chemical product 1002.

The data related to decentral participant node(s) may include decentral participant identifier(s) associated with decentral participant node(s), such as decentral participant identifier 1 1016, decentral participant identifier 2 1022 and decentral participant identifier 3 1024. The respective decentral participant identifier may comprise any identifier uniquely associated with a participant of a decentral network and/or with a production site of a participant of the decentral network. The decentral participant identifier may include letters and/or numbers. The decentral participant identifier may include one or more Universally Unique Identifier(s) (UUID(s)) and/or one or more Decentralized Identifier(s) (DID(s)). The decentral participant identifier may be associated with or may include a verifiable claim or credential. The decentral participant node(s) may be associated with consumers of the chemical product the consumer identifier(s) are associated with. This allows to relate the consumer identifier(s) used within the chemical production to respective decentral participant identifier(s) associated with participant network nodes of consumers of the chemical product.

The relationship representation may be a data structure defining the relationship between a chemical product 1002, customers of the chemical product and decentral network node(s) associated with said customers. The data structure may contain chemical product identifier(s) interrelated with customer identifier(s) and associated decentral participant identifier(s).

FIG. 11 illustrates a flow chart of a computer-implemented method for authorizing access by a decentral data providing network node to a digital twin of a physical entity of a chemical product in accordance with an example embodiment of the present disclosure. The digital twin of the chemical product may be generated by an apparatus for generating digital twins, for example apparatus 424 described in the context of FIGS. 4B, 7A, 7B using the method described in FIG. 8. The digital twin may include the decentral digital twin identifier and at least one measured physical and/or chemical property of the chemical product and/or at least one physical and/or chemical property determined from collected data associated with the production and/or the use of the chemical product.

The chemical product may be produced by a chemical production from one or more input materials, for example as described in the context of FIGS. 2, 7A and 7B. The access may be authorized by an apparatus for authorizing access, such as digital twin management system 702 described in the context of FIGS. 7A and 7B. The digital twin management may be part of an operating system of a chemical production, such as operating system 208 of chemical production 204 (see for example FIGS. 2, 7A, 7B). The digital twin management system may be communicatively coupled to the operating system.

For accessing the digital twin or a part thereof, a request to access the digital twin of the chemical product may be received by a decentral data providing network node in block 1102. The decentral data providing network node may be associated with the digital twin. The decentral data providing network node may be identified using a digital access element associated with the digital twin, for example as described in the context of FIG. 12. The digital access element may be generated as described in the context of FIG. 7B. The request may be generated by a decentral data consuming network node and may be provided to the decentral data providing network node. The decentral data consuming network node may be associated with the consumer of the chemical product (see for example FIG. 12). The request may contain the decentral digital twin identifier included in the digital twin and the decentral participant identifier associated with the decentral data consuming network node. The request may be transmitted through a peer-to-peer communication channel between the decentral data providing network and the decentral data consuming network node. The decentral digital twin identifier may be encoded in the physical identifier of the chemical product (see for example FIG. 12) or may be retrieved from a database based on the physical identifier associated with the chemical product (see for example FIG. 12).

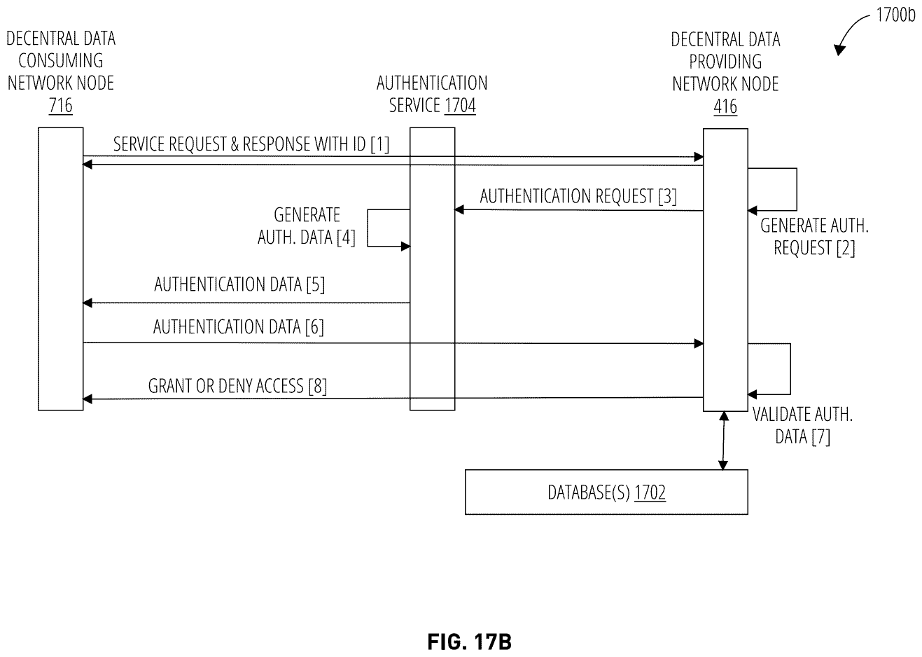

Authentication may be performed in block 1104, this block being generally optional. In particular, the decentral data consuming network node requesting to access the digital twin and/or the decentral data providing network node providing access to the digital twin may be authenticating, e.g. may perform authentication. Such authentication may be based on the decentral participant identifier(s) and data related to an authentication mechanism. The authentication mechanism may be associated with the decentral participant identifier as previously described. The authentication mechanism may be associated with certificate(s) associated with the respective decentral participant nodes. The decentral participant node may verify the received certificate via a central or decentral verifier. The authentication may be performed through different communication patterns, for example as described in the context of FIGS. 17A and 17B.

In block 1106, the decentral data providing network node and/or the decentral data consuming network node may determine whether the authentication is valid, this block being generally optional. If authentication is not valid, e.g. failed, the decentral data providing network node may deny access to the digital twin and the method ends.

If authentication is valid, access data may be determined in block 1108 based on the received decentral digital twin identifier. The access data may include the decentral digital twin identifier and one or more authorization rule(s). The access data may further include digital twin location data. The access data may be retrieved from a database of the decentral data providing network node, such as database 418 (see FIG. 4A). The authorization rule(s) may be associated with the decentral digital twin identifier as described in the context of FIGS. 6A and 6B. The authorization rule(s) may define access to and/or usage of at least part of the digital twin for decentral data consuming network node(s). The access to and/or usage of at least part of the digital twin may be associated with decentral participant identifier(s) of decentral data consuming network nodes. For instance, authorization rule(s) may define decentral participant identifier(s) allowed to access the digital twin data. This allows to filter decentral data consuming network nodes requesting access based on associated decentral participant identifiers The one or more authorization rules may include rules and obligations as described in the context of FIG. 4A.

In block 1112, the decentral data providing network node validates the request by applying at least part of the access data determined in block 1110 to the received request. This may include applying access data retrieved in block 1110 to the received request based on the received decentral participant identifier. Applying access data to the received request may include determining whether the decentral participant identifier received with the request is associated with one or more determined authorization rule(s). For instance, one or more authorization rule(s) associated with the decentral digital twin identifier may contain decentral participant identifier(s) associated with decentral data consuming network nodes allowed to access the digital twin or a part thereof. Applying access data to the received request may include determining whether the decentral participant identifier received with the request is not associated with one or more determined authorization rule(s). For instance, one or more authorization rule(s) associated with the decentral digital twin identifier may contain decentral participant identifier(s) associated with decentral data consuming network nodes not allowed to access the digital twin or a part thereof. Validating the request allows to filter decentral data consuming network nodes based on the associated decentral participant identifier, hence ensuring that only authorized decentral data consuming network node, such as decentral data consuming network nodes associated with consumers of the chemical product, get access to the digital twin or the part thereof. This allows to control access to the digital twin or the part thereof, hence ensuring that the digital twin or the part thereof can be shared within a decentral network under the control of the data owner of the digital twin. If the request is not valid, e.g. if the decentral data consuming network node is not authorized, the method proceeds to block 1114 and denies access to the digital twin or the part thereof. If the request is valid, the method proceeds to block 1116.

In block 1116, the digital twin or a part thereof may be provided based on the decentral digital twin identifier contained in the received request. The digital twin may further be provided based on digital twin location data contained in the determined access data. Providing the digital twin may include retrieving the digital twin from a data storage, such as DT storage 414 (see FIGS. 4A, 7A, 7B). The data storage may be connected to the decentral data providing service via a further authentication network node. This improves security because it ensures that only properly authenticated decentral data providing service(s) can access the database storing the digital twins and hence avoids unauthorized access to said database. Providing the digital twin may include requesting the digital twin from a component or unit storing the digital twin, such as apparatus 424. The component or unit may provide the digital twin in response to a request of the decentral data providing network node. Block 1116 may further include, prior to providing the digital twin, signature of an electronic contract as described in the context of FIG. 12. Use of the electronic contract ensures that the decentral data consuming network node and further systems handling the digital twin are complying to one or more authorization rule(s) associated with the digital twin. Upon signature of the electronic contract, decentral data providing network node 416

In block 1118, at least part of the determined access data may be applied to the provided digital twin or a part thereof. Applying at least part of the access data may include applying one or more authorization rule(s) contained in the determined access data to the digital twin data or the part thereof. Applying at least part of the access data may include adapting access to the digital twin or the part thereof to be in line with the one or more authorization rule(s). The access data applied in block 1118 may differ from the access data applied in block 1112 used to validate the received request. The access data applied in block 1118 may include access data applied in block 1112. This allows to ensure that the request has been validated appropriately and avoids unauthorized access to the digital twin or a part thereof. Access data may be applied prior to access of the digital twin or the part thereof or during run-time on access of the digital twin or the part thereof

In block 1120, the digital twin or a part thereof may be provided to the decentral data consuming network node according to the applied access data. Providing the digital twin or the part thereof may include pushing the data resulting from applying the access data to the provided digital twin or the part thereof to the decentral data consuming network node. Providing the digital twin or the part thereof may include providing the data resulting from applying the access data to the provided digital twin or the part thereof to decentral data consuming network node.

FIG. 12 shows a schematic illustration of authorizing access by a decentral data providing network node to a digital twin or a part thereof associated with a chemical product using a digital access element. Access to the digital twin or the part thereof may be requested by a decentral data consuming service. The chemical product 206 may be produced by a chemical production, such as chemical production 204 described in the context of FIGS. 2, 7A and 7B. The digital twin may include the decentral digital twin identifier and at least one measured physical and/or chemical property of the chemical product and/or at least one physical and/or chemical property determined from collected data associated with the production and/or the use of the chemical product.

A digital access element may be generated upon or after production of the chemical product, for example as described in the context of FIG. 7B. The digital access element may be associated with the digital twin or the part thereof. The digital access element may contain a decentral passport identifier and digital twin location data. The decentral passport identifier may correspond to or be associated with the decentral digital twin identifier of the digital twin. The digital twin location data may include digital representation(s) pointing to the digital twin or parts thereof. The digital twin location data may include digital twin data identifier(s) associated with digital twin data contained in the digital twin (see for example FIG. 15 and FIG. 16). Examples of digital access elements are illustrated in FIGS. 15 and 16. The digital access element may further include or relate to authentication and/or authorization information linked to the decentral passport identifier. The authentication and/or authorization information may be provided for authentication and/or authorization of the decentral data providing network node 416 and/or the decentral data providing network node 716. The digital access element may be provided to a decentral registry 718, for example as described in the context of FIG. 7B. Decentral registry 718 may store decentral passport identifier(s) and associated digital twin location data.

The chemical product 202 as produced by the chemical production network 204 may be provided in association with the digital access element to a consumer. The consumer may process the chemical product to produce further chemical and/or discrete products. The chemical product 206 may be connected to a code, such as a bar code or QR-code, having encoded the decentral passport identifier. The consumer of the chemical product 206 may read the code through a code reader 1202. The code reader 1202 may be a smartphone running a code reading application, such as a QR code reader app. The data obtained by the code reading application may be used to determine the decentral passport identifier. The data obtained by the code reading application may be used to determine the decentral digital twin identifier. The data obtained by the code reading application may be used to determine the chemical product identifier. The data obtained by the code reading application may be used to determine the digital twin location data. The decentral passport identifier, decentral digital twin identifier, chemical product identifier and digital twin location data may be determined by code reader 1202. For instance, the decentral passport identifier determined by the code reader 1202 may be a DID and the code reader 1202 may be configured to retrieve the associated DID document containing the decentral digital twin identifier and the digital twin location data, for example using a DID resolver (see also FIG. 15). In another instance, the chemical product identifier is determined by code reader 1202 and used to retrieve the decentral passport identifier and associated digital twin location data, for example from a database, such as decentral registry 718. Hence, code reader 1202 may be configured to retrieve the digital access element containing the decentral passport identifier and digital twin location data from decentral registry 718. Code reader 1202 may be configured to provide the decentral passport identifier and/or the decentral digital twin identifier to a database 1206 associated with the consumer of the chemical product. Code reader 1202 may be configured to provide the determined decentral passport identifier, decentral digital twin identifier and digital twin location data to decentral data consuming network node 716.

Code reader 1202 may be configured to display determined/retrieved data on a user interface as illustrated by reference sign 1204. The user interface may display the determined decentral passport identifier (PP identifier), the determined decentral digital twin identifier (DT identifier) and the determined digital twin location data (DT location). In this embodiment, the decentral passport identifier and the decentral digital twin identifier differ from each other. In another embodiment, the decentral passport identifier is equal to the decentral digital twin identifier. The user interface may further display the determined chemical product identifier (CP identifier). The user interface may also allow to initiate retrieval of the digital twin or a part thereof based on the decentral passport identifier and the digital twin location data as described in the following. This process may be initiated by the button denoted “Access DT”. Upon pressing said button, code reader 1202 may send a request to access the digital twin or the part thereof to decentral data consuming network node 716.

The decentral data consuming network node may generate a request to access the digital twin or a part thereof. Decentral data consuming network node may generate the request based on the data received from code reader 1202. For instance, decentral data consuming network node may generate the request based on the decentral digital twin identifier received from code reader 1202. Data consuming network node may generate the request based on the decentral passport identifier and/or decentral digital twin identifier provided to database 1206. For example, decentral data consuming network node may be configured to retrieve the decentral digital twin identifier and digital twin location data from decentral registry 718 based on the decentral passport identifier stored in database 1206. The request generated by decentral data consuming network node may include the decentral digital twin identifier and the decentral participant identifier associated with decentral data consuming network node 716. Decentral data consuming network node 716 may be configured to determine the decentral data providing network node 416 associated with the digital twin based on the digital twin location data provided by code reader 1202 or retrieved from decentral registry 718.

Decentral data consuming network node 716 may sent the request to access the digital twin or a part thereof to the determined decentral data providing network node 416 as signified by arrow 1208. The decentral data providing network node 416 may be associated with the chemical product producer. The decentral data providing network node 416 may be associated with the chemical production producing the chemical product. The decentral data providing network node 416 may be associated with the data owner of the digital twin. In addition to the request, authentication and/or authorization information may be provided by decentral data consuming network node 716, for example as described in the context of FIGS. 17A and 17B.

The request may be authenticated (see FIGS. 17A and 17B). The request may be validated by the decentral data providing network node 416, for example as described in the context of FIG. 11. For instance, the decentral data providing network node may retrieve access data from DB 418 based on the decentral digital twin identifier contained in the received request. At least part of the retrieved access data may be applied to the received request as described in the context of FIG. 11. This allows to filter decentral data consuming network nodes requesting access based on the decentral participant identifier(s) associated with said network nodes. If the request is not valid, e.g. if the decentral data consuming network node is not authorized to access the digital twin data, the peer-to-peer communication channel will be terminated by decentral data providing network node and no digital twin will be provided.

If the request is valid, decentral data providing network node 416 may initiate contract negotiations with decentral data consuming network node. Decentral data providing network node 416 may provide an electronic contract to decentral data consuming network node. The electronic contract may include one or more authorization rule(s) associated with the decentral digital twin identifier. This allows the data consumer to determine access and usage conditions associated with the desired data. Decentral data providing network node 416 and decentral data consuming network node 716 may be configured to negotiate an electronic contract and to sign the negotiated electronic contract. Use of the electronic contract ensures that the decentral data consuming network node and further systems handling the digital twin are complying to one or more authorization rule(s) associated with the digital twin. Upon signature of the electronic contract, decentral data providing network node 416 may retrieve or request the digital twin stored in DT storage 414 based on the decentral digital twin identifier contained in the received request as designated by arrows 1210 and 1212 (see also FIG. 11). Decentral data providing network node 416 may apply determined access data to the retrieved or received digital twin, for example as described in the context of FIG. 11. Afterwards, decentral data providing network node may provide the digital twin or parts thereof according to the applied access data to the decentral data consuming network node 716 as signified by arrow 1214 (see also FIG. 11).

The digital twin provided by decentral data providing network node 416 may be stored in database 1206 associated with the decentral data consuming network node according to the access data as signified by arrow 1216.

Through the decentral digital twin identifier, the digital twin data can be uniquely associated with the chemical product. Through the decentral network, the digital twin or a part thereof may be transferred between the producer of the chemical product and the consumer of the chemical product in a standardized and secure way, allowing the producer of the chemical product to control access to the digital twin or the part thereof by multiple decentral data consuming network nodes existing within the decentral network. This way, the digital twin or the part thereof can be shared with unique association to the chemical product and without central intermediary directly between the participants of the chemical product ecosystem. This allows for transparency of digital twins within the chemical product ecosystem.

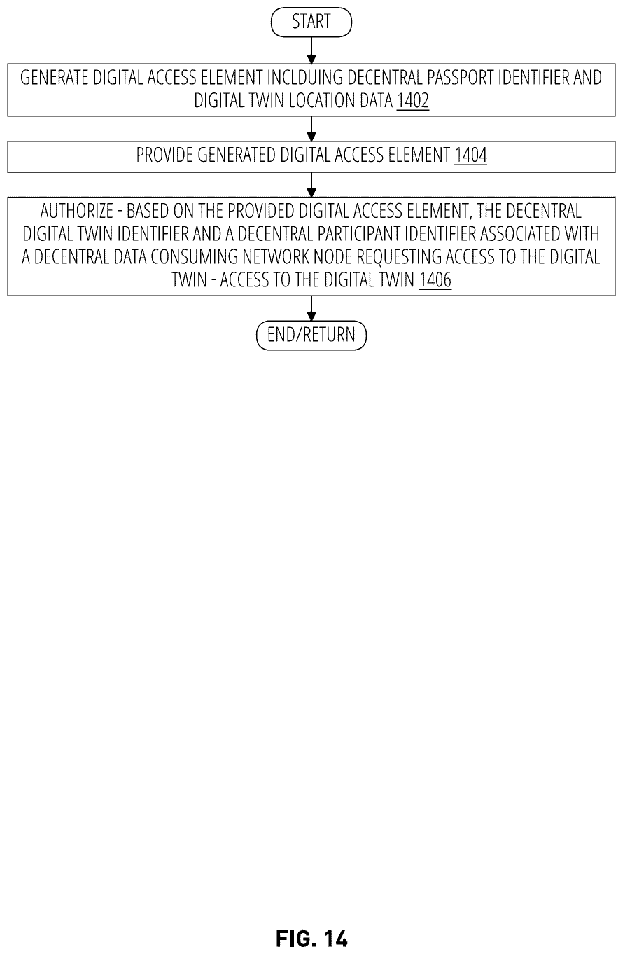

FIG. 13 illustrates a flow chart a computer-implemented method for processing a digital twin or a part thereof of a physical entity of a chemical product in accordance with an example embodiment of the present disclosure. The chemical product may be produced by a chemical production, such as chemical production 204 described in the context of FIGS. 2, 7A and 7B. The digital twin may include the decentral digital twin identifier and at least one measured physical and/or chemical property of the chemical product and/or at least one physical and/or chemical property determined from collected data associated with the production and/or the use of the chemical product.

In block 1302, access to the digital twin or a part thereof is requested. The access may be requested by a decentral data consuming network node, such as a node associated with the consumer of the chemical product (see also FIG. 12). The access may be requested at the decentral data providing network node being associated with the digital twin (see for example FIG. 12). The request may contain the decentral digital twin identifier associated with digital twin and a decentral participant identifier associated with the decentral data consuming network node.

In response to the request, access to the digital twin or a part thereof may be authorized by the decentral data providing network node, for example as described in the context of FIGS. 11 and 12. In case access to the digital twin is authorized, the digital twin or a part thereof may be provided to the decentral data consuming network node in block 1304 (see also FIGS. 11 and 12). Providing may include pushing the digital twin to the database associated with the decentral data consuming network node. Providing may include receiving the digital twin from the decentral data providing network node.

The digital twin or the part thereof may be processed in block 1306. Processing may include determining further data using the provided digital twin or a part thereof. Processing may include aggregation of provided data. Processing may include use of the provided data to generate control data to control the production of further chemical and/or discrete products from the received chemical product.

The output resulting from the processing may be provided in block 1308.

FIG. 14 illustrates a flow chart of a computer-implemented method for authorizing access to a digital twin or a part thereof of a physical entity of a chemical product by a decentral data consuming network node using a digital access element associated with the chemical product. The chemical product may be produced by a chemical production, such as chemical production 204 described in the context of FIGS. 2, 7A and 7B. The digital twin may include the decentral digital twin identifier and at least one measured physical and/or chemical property of the chemical product and/or at least one physical and/or chemical property determined from collected data associated with the production and/or the use of the chemical product.

In block 1402, a digital access element may be generated. The digital access element may be generated as described in the context of FIG. 7B. The digital access element may include a decentral passport identifier and digital twin location data. The decentral passport identifier may correspond to or be associated with the decentral digital twin identifier, for example as described in the context of FIGS. 7A and 12. The digital access element may correspond to a DID document associated with the decentral passport identifier being a DID.

The generated digital access element may be provided in block 1404. This may include providing the digital access element to a decentral registry, such as decentral registry 718 (see for example FIGS. 7B and 12). This may include encoding the digital access element in a physical identifier attached to the chemical product.

Access to the digital twin or a part thereof may be authorized based on the provided digital access element, the decentral digital twin identifier and a decentral participant identifier associated with a decentral data consuming network node requesting access to the digital twin in block 1406. Authorization of access may be performed as described in the context of FIGS. 11 and 12.

FIG. 15 shows an example of decentral identifier-based owner data 1502, a decentral identifier-based digital access element 1504 and a decentralized identity manager 1506.

The decentral identifier may include a Decentralized Identifier (DID). The decentral identifier-based digital access element may in this case be a DID document 1504 associated with the DID. Besides the DID document 1504 serving as digital access element, FIG. 15 shows a DID owner data element 1502 including decentral identifier-based owner data. Generally, the decentral identifier-based owner data may include the decentral identifier associated with a subject such as chemical product data set(s) and may include one or more authentication mechanism(s). The decentral identifier-based owner data 1502 may include owner data that is electronically owned and controlled by the DID owner. In this context electronically owned may refer to data that is stored in an owner repository or wallet. Such data may be securely stored and/or managed on an organizational server or client device. The decentral identifier-based owner data 1502 may include a DID, a private key and a public key. The DID owner may own and control the DID that represents an identity associated with the DID subject, a private key and public key pair that are associated with the DID. DID may be understood as an identifier and authentication information associated with or uniquely linked to the identifier.

The DID subject may be a raw material, a basic substance, a chemical product, or an end product. The DID subject may be a machine, a system, or a device used for producing the raw material, the basic substance, the chemical product, the intermediate product, or the end product, or a collection of such machine(s), device(s) and/or system(s). The DID owner may be a supply chain participant or a manufacturer such as a chemical manufacturer producing chemicals. The DID owner may be an upstream participant in the supply chain of the chemical manufacturer such as a supplier that supplies raw chemical products or precursors to produce the chemical product. The DID owner may be a downstream participant in the supply chain of the chemical manufacturer such as a customer that consumes chemical products to produce an intermediate product, the component, the component assembly or the end product. The DID owner may be any participant of the supply chain including raw chemical product supplier, intermediate chemical products manufacturer, intermediate part manufacturer, component manufacturer, component assembly manufacturer or end product manufacturer.

The DID may be any identifier that is associated with the DID subject and/or the DID owner. Preferably, the identifier is unique to the DID subject and/or DID owner. The identifier may be unique at least within the scope in which the DID is anticipated to be in use. The identifier may be a locally or globally unique identifier for the raw material, the precursor, the basic substance, the chemical product, the intermediate product, the component, the component assembly, the end product or a collection thereof; the machine, the system, or the device used for producing the raw material, the basic substance, the chemical product, the intermediate product, the component, the component assembly or the end product, or the collection of such machine(s), device(s) and/or system(s); the chemical manufacturer producing chemicals, the upstream participant in the supply chain of the chemical manufacturer, the downstream participant in the supply chain of the chemical manufacturer or a collection thereof; any participant of the supply chain including raw chemical product supplier, intermediate chemical products manufacturer, intermediate part manufacturer, component manufacturer, component assembly manufacturer or end product manufacturer or a collection thereof.

The DID may be any identifier that is associated with the DID subject and the DID owner. Preferably, the DID is unique to the DID subject and/or DID owner. The DID may be unique at least within the scope in which the DID is anticipated to be in use. The DID may be a locally or globally unique identifier for any of the above mentioned possible DID subjects. The DID may also be a Uniform Resource Identifier (URI) such as a Uniform Resource Locator (URL). Moreover, the DID may be an Internationalized Resource Identifier (IRI). The DID may be a Uniform Resource Identifier (URI) such as a Uniform Resource Locator (URL). The DID may be an Internationalized Resource Identifier (IRI). The DID may be a random string of numbers and letters for increased security. In one embodiment, the DID may be a string of 128 letters and numbers e.g. according to the scheme did: method name: method specific-did such as did:example:ebfeb1f712ebc6f1c276e12ec21. The DID may be decentralized ID independent of a centralized, third party management system and under the control of the DID owner.

The digital access element as DID document 1504 may be associated with the DID, i.e. the DID included in the decentral identifier-based owner data 1502. Accordingly, the digital access element may include a reference to the DID, which is associated with the DID subject that is described by the DID document 1504. The DID document 1504 may also include an authentication information such as the public key. The public key may be used by third-party entities that are given permission by the DID owner/subject to access information and data owned by the DID owner/subject. The public key may also be used for verifying that the DID owner, in fact, owns or controls the DID. The DID document may include authentication information, authorization information e.g. to authorize third party entities to read the DID document or some part of the DID document e.g. without giving the third party the right to prove ownership of the DID.

The digital access element 1504 may include one or more representations that digitally link to digital twin data included in the digital twin the digital access element is associated with, e.g. by way of service endpoints. A service endpoint may include a network address at which a service operates on behalf of the DID owner. In particular, the service endpoints may refer to services, such as data providing services, of the DID owner that give access to digital twin data. Such services may include services to read or analyze data contained in the digital twin data. Data contained in the digital twin data may include chemical product declaration data, chemical product safety data, certificate of analysis data, emission data, product carbon footprint data, product environmental footprint data, chemical product specification data, product information, technical application data, production data, chemical composition data or combinations thereof.

The digital access element 1504 may include further identifiers, such as digital twin data identifier(s) and a chemical product identifier.

The digital access element 1504 may include various other information such metadata specifying when the digital access element was created, when it was last modified and/or when it expires.

The DID and digital access element 1504 may be associated with a data registry node such as a centralized data service system or a decentralized data service system 1506, e.g. a distributed ledger or blockchain or a decentralized file system. The distributed ledger or blockchain may be used to store a representation of the DID that points to the digital access element 1504. A representation of the DID may be stored on distributed computing nodes of the distributed ledger or blockchain 1506. For example, DID hash may be stored on multiple computing nodes of the distributed ledger and point to the location of the digital access element 1504. In some embodiments, the digital access element 1504 may be stored on the distributed ledger 1506. Each of the computing nodes may store a copy of the distributed ledger 1506. In this way, each DID hash can be stored redundantly, thereby allowing for an increased data safety. DIDs associated with a plurality of different digital access element 1504 may be included in the distributed ledger 1006.

In some embodiments, the digital access element 1504 may be stored on the distributed ledger 1506, i.e. either additionally or alternatively to the associated DID representation being stored on the distributed ledger 1506. In other embodiments, the digital access element 1504 may be stored in a data storage (not illustrated) that is associated with the distributed ledger or blockchain or decentralized file system.

The distributed ledger or blockchain 1506may be any decentralized, distributed network that includes various computing nodes that are in communication with each other. For example, the distributed ledger 1506 may include a first distributed computing node, a second distributed computing node, a third distributed computing node, and any number of additional distributed computing nodes (not shown). The distributed ledger or blockchain 1506 may include known technology stacks like Bitcoin (see e.g. Bitcoin documentation of Nov. 11, 2022 published https://en.bitcoin.it/wiki/Protocol_documentation), Ethereum (see e.g. Ethereum documentation of Aug. 15, 2022 published on https://ethereum.org/en/developers/docs/), Solana (see e.g. Solana documentation of Nov. 11, 2022 published on https://spl.solana.com/), Polygon (see e.g. Polygon documentation of Nov. 11, 2022 published on https://wiki.polygon.technology/) or other implementations with varying degree of data transactions performed on the distributed ledger. The description of the example framework is only for illustrative purposes and shall not be considered limiting.

FIG. 16 shows an example of certificate data 1602, digital access element data 1604 and an international data space (IDS) infrastructure 1608.

In contrast to the example of FIG. 15, the example of FIG. 16 is certificate-based. Certificate data 1602 may include authentication data of the subject and the certificate issuer. The subject may be the data owner or the IDS connector 1606 operated by or being under control of the data owner. Certificate data 1602 may further include the subject name the certificate is issued for, such as a data owner name, the data owner ID, the IDS connector name, the IDS connector ID or a combination thereof. The certificate may be a X.509 certificate such as X509v3. The certificate data 1602 may be associated with an IDS infrastructure 1608 including e.g. a certificate issuing service (CA) 1610 and/or a dynamic provisioning service (DAPS) 1612 providing dynamic attribute tokens (e.g. OAuth Access Tokens). Certificate data 1602 may further include various other information such metadata specifying when the certificate was created, when it was last modified and/or when it expires. The information required to verify the certificate data 1102 may be provided via an authentication registry associated with the certificate issuing service and/or a dynamic provisioning service. For instance, in the IDSA Reference Architecture Model, Version 3.0 of April 2019, an IDS connector 1606 associated with or under control of the data owner, a Certification Authority (CA) 1610, a Dynamic Attribute Provisioning Service (DAPS) 1612 and an IDS connector associated with the data consuming service (not shown) are used to verify the identity prior to performing a data exchange (see for example FIGS. 11, 12, 17A and 17B).

The certificate data 1602 and the digital access element data 1604 may be stored within the IDS connector 1606 (also denoted as data providing service). The IDS connector 1606 may be associated with or under control of the data owner of the chemical product data.

The digital access element data 1604 may include a decentral identifier, authorization data and endpoints associated with the chemical product data. The decentral identifier may be a Universally Unique Identifier (UUID), such as a UUIDv4. The UUIDv4 may conform to the following format: [0-9a-fA-F]{8}-[0-9a-fA-F]{4}-[0-9a-fA-F]{4}-[0-9a-fA-F]{4}-[0-9a-fA-F]{12}. The authorization information may be used to control access to the chemical product data or a part thereof, for example as described in the context of FIGS. 17A and 17B. Endpoints may include any digital representation pointing to the digital twin data or a part thereof (see for example FIG. 12). Digital twin data may include the data mentioned in the context of FIG. 15.

The digital access element data 1604 may include various other information such metadata specifying when the digital access element was created, when it was last modified and/or when it expires.

FIG. 17A and FIG. 17B each show an example method for authentication to access a digital twin or a part thereof associated with a chemical product.

In the process of authentication, various communication patterns may be implemented to verify identities. FIG. 17A illustrates one example communication pattern that may occur between a decentral data providing network node 416 and a decentral data consuming network node 716. In this case, the decentral data providing network node 416 may act as verifying entity and no separate service may be used for authentication. The decentral data consuming network node 716 may request a service from the decentral data providing network node 416 (see step [1] of FIG. 17A). The request may include the decentral participant identifier, such as a DID, a certificate of the decentral data consuming network node 716, an access token associated with a certificate of the decentral data consuming network node 716 or a verifiable credential associated with the owner of the decentral data consuming network node 716.

In response to the request, the decentral data providing network node 416 may access a registry such as a central or decentral authentication registry to retrieve data related to the authentication mechanism(s) associated with the decentral identifier. For instance, the central authentication registry may provide data related to authentication mechanism via an authentication service issuing access token. Further for instance, the decentral authentication registry may provide data related to authentication mechanism by generating a request token. Data related to authentication mechanism may include a public key of the decentral data consuming network node 716.

Based on the retrieved data related to the authentication mechanism(s), the decentral data providing network node 416 may generate an authentication request (corresponding for example to authentication request tokens or dynamic attribute tokens) (see step [2] of FIG. 17A). The authentication request may be generated based on a public key of the decentral data consuming network node 716 and/or the private key of the decentral data providing network node 416. The generated authentication request may be sent to the decentral data providing network node 416 (see step [3] of FIG. 17A).

Based on the received authentication request, the decentral data consuming network node 716 may generate authentication data for responding to the authentication request (see step [4] of FIG. 17A). The generated authentication data may be sent back to the decentral data providing network node 716 (see step [5] of FIG. 17A).

Receiving the response including the authentication data from decentral data consuming network node 716, the decentral data providing network node 416 may then validate the authentication data (see step of FIG. 17A). In response to the validation, decentral data providing network node 416 may grant or deny the service request of the decentral data consuming network node 716 (see step [7] of FIG. 17A). In case access is authenticated, the decentral data consuming network node 716 may provide the decentral digital twin identifier of the digital twin and the decentral participant identifier associated with the decentral data consuming network node 716 and the decentral data providing network node 416 may authenticate the received request and—upon authentication—may provide the digital twin or a part thereof, for example as described in FIGS. 11 and 12.

FIG. 17B illustrates another example communication pattern that may occur between decentral data providing network node 416, a decentral data consuming network node 716 and an authentication service 1704.

First, the decentral data consuming network node 716 may request a service or initiates a communication with the decentral data providing network node 416 (see step [1] of FIG. 17B). The request may include the decentral participant identifier, such as a DID, of the decentral data consuming network node 716 as described in relation to FIG. 17A.

Receiving the request, the decentral data providing network node 416 may access a distributed ledger to retrieve one or more authentication mechanism(s) associated with the decentral identifier. Based on the retrieved authentication mechanisms(s), the decentral data providing network node 416 may generate an authentication request (see step [2] of FIG. 17B).

Here, the at least one of the retrieved authentication mechanism(s) may be provided via the authentication service 1704. As such, in some embodiments, the generated authentication request may be sent to the authentication service 1704 directly (see step [3] of FIG. 17B). Receiving the authentication request from the decentral data providing network node 416, the authentication service 1704 may generate the authentication data (see step [4] of FIG. 17B).

The authentication data generated by the authentication service 1704 may be sent to the decentral data consuming network node 716 (see step [5] of FIG. 17B).

Decentral data consuming network node 716 then, in turn, may pass on the authentication data to the decentral data providing network node 416 (see step [6] of FIG. 17B). Receiving the authentication data, the decentral data providing network node 416 may then validate the authentication data (see step [7] of FIG. 17B). In response to the validation, decentral data providing network node 416 may grant or deny the service request of the decentral data consuming network node 716 (see step [8] of FIG. 17B). In case access is authenticated, the decentral data consuming network node 716 may provide the decentral digital twin identifier of the digital twin and the decentral participant identifier associated with the decentral data consuming network node 716 and the decentral data providing network node 416 may authenticate the received request and—upon authentication—may provide the digital twin or a part thereof, for example as described in FIGS. 11 and 12.

Alternatively, in some embodiments, after the decentral data providing network node 416 may generate an authentication request, the decentral data providing network node 416 may send the authentication request to decentral data consuming network node 716. The decentral data consuming network node 716 may pass on the authentication request to the authentication service 1704.

Further, after the authentication service 1704 may generate the authentication data, in some embodiments, the authentication service 1704 merely contacts the decentral data consuming network node 716 to notify the receipt of the authentication request and to obtain consent. When the decentral data consuming network node 716 receives the notification, the decentral data consuming network node 716 consents and sends the consent back to the authentication service 1704. Receiving the consent, the authentication service 1704 then sends the authentication data directly to the decentral data providing network node 416.

Finally, in many transactions, the authentication may be mutually performed by both parties. In such a mutual authentication situation, each involved party is both a subject entity and a verifying entity.

Decentral data consuming network node 716 and decentral data providing network node 416 have control over their decentral identities. At the beginning, services exchange their decentral identities. Next, each of the services accesses a distributed ledger to obtain each other's authentication mechanism(s). Each service then generates its own authentication request based on the other ID's authentication method(s). The generated authentication data is then sent to the other service. Receiving each other's authentication data, each service validates the received authentication data. Based on the validation results, the services may then perform additional communications, e.g. one service may grant or deny the service request of the other service as previously described.

FIG. 17A and FIG. 17B only show examples of authentication protocols. Also, although the communication arrows were discussed in a certain order or illustrated in a sequence of communications, no particular ordering is required unless specifically state, or required because a communication is dependent on another communication being completed prior to the communication being transmitted.

The present disclosure has been described in conjunction with preferred embodiments and examples as well. However, other variations can be understood and effected by those persons skilled in the art and practicing the claimed invention, from the studies of the drawings, this disclosure and the claims.

Any steps presented herein can be performed in any order. The methods disclosed herein are not limited to a specific order of these steps. It is also not required that the different steps are performed at a certain place or in a certain computing node of a distributed system, i.e. each of the steps may be performed at different computing nodes using different equipment/data processing.

As used herein “determining” also includes “initiating or causing to determine”, “generating” also includes “initiating and/or causing to generate” and “providing” also includes “initiating or causing to determine, generate, select, send and/or receive”. “Initiating or causing to perform an action” includes any processing signal that triggers a computing node or device to perform the respective action.

In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

1. An apparatus for controlling access to a digital twin of a physical entity of a chemical product produced from one or more chemical input materials, wherein the access to the digital twin by one or more decentral data consuming network node(s) of a decentral network is controlled by a decentral data providing network node associated with the digital twin and wherein the digital twin includes a decentral digital twin identifier and at least one measured physical and/or chemical property of the chemical product and/or at least one physical and/or chemical property determined from collected data associated with the production and/or the use of the chemical product, the apparatus comprising:
at least one decentral digital twin identifier providing unit configured to provide the decentral digital twin identifier,
at least one mapping data providing unit configured to provide mapping data including data related to the chemical product produced from the one or more chemical input materials interrelated with respective decentral participant identifier(s) associated with decentral participant node(s), wherein the mapping data is generated from the data related to the chemical product produced from the one or more chemical input materials and data related to the decentral participant node(s),
at least one access data generating unit configured to generate access data for at least part of the digital twin based on the mapping data, wherein the access data include the decentral digital twin identifier and one or more authorization rule(s) associated with the decentral digital twin identifier, wherein the one or more authorization rule(s) define access to and/or usage of at least part of the digital twin for decentral data consuming network node(s) associated with the decentral participant identifier(s) included in the mapping data, and
the decentral data providing network node associated with the digital twin, wherein the decentral data providing network node is configured to control access by the one or more decentral data consuming network node(s) to at least part of the digital twin according to the generated access data.

2. A system for controlling access to a digital twin of a physical entity of a chemical product produced from one or more chemical input materials, wherein the access to the digital twin by one or more decentral data consuming network node(s) of a decentral network is controlled by a decentral data providing network node associated with the digital twin and wherein the digital twin includes a decentral digital twin identifier and at least one measured physical and/or chemical property of the chemical product and/or at least one physical and/or chemical property determined from collected data associated with the production and/or the use of the chemical product, the system comprising:
optionally a digital twin provider layer configured to provide the digital twin of the physical entity of the chemical product, and
an access provider layer configured to
provide the decentral digital twin identifier included in the digital twin
provide mapping data including data related to the chemical product produced from the one or more chemical input materials interrelated with respective decentral participant identifier(s) associated with decentral participant node(s), wherein the mapping data is generated from the data related to the chemical product produced from the one or more chemical input materials and data related to the decentral participant node(s),
generate access data for at least part of the digital twin based on the mapping data, wherein the access data include the decentral digital twin identifier and one or more authorization rule(s) associated with the decentral digital twin identifier, wherein the one or more authorization rule(s) define access to and/or usage of at last part of the digital twin for decentral data consuming network node(s) associated with the decentral participant identifier(s) included in the mapping data, and
control—by the decentral data providing network node according to the generated access data—access by the one or more decentral data consuming network node(s) to at least part of the digital twin.

3. The apparatus of claim 1, wherein the data related to the chemical product produced from the one or more chemical input materials includes a consumer identifier associated with the chemical product.

4. The apparatus of claim 1, wherein generating the mapping data includes interrelating data related to the chemical product produced from the one or more chemical input materials with respective decentral participants identifier(s) contained in the data related to the decentral participant node(s) based on a relationship representation according to which the data related to the chemical product is associated with the data related to the decentral participant node(s).

5. The apparatus of claim 1, wherein the one or more authorization rule(s) include computer-executable instructions to allow access to the digital twin associated with the decentral digital twin identifier, deny access to the digital twin associated with the decentral digital twin identifier, to modify access to the digital twin associated with the decentral digital twin identifier or to modify the digital twin associated with decentral digital twin identifier.

6. The apparatus of claim 1, wherein one or more authorization rules include one or more rules that are specific to the decentral participant identifier(s).

7. The apparatus of claim 1, wherein the one or more authorization rules include one or more local rules that are specific to a particular location, wherein the location is associated with a jurisdiction and the local rule for the location is associated with legal requirements related to the supply of chemical products.

8. The apparatus of claim 1, wherein the one or more authorization rules include one or more rules that are specific to attribute values associated with a decentral network participant.

9. The apparatus of claim 1, wherein one or more authorization rule(s) include at least one regulatory instruction configured to provide access to digital twin or a part thereof relating to regulatory requirements for the supply of chemical products.

10. The apparatus of claim 1, wherein one or more authorization rule(s) include one or more of prescribed rules relating to emission data, production data, recyclate content data, bio-based content data, provenance data, labour conditions data or combinations thereof.

11. The apparatus of claim 1, wherein one or more authorization rule(s) include obligations of decentral data consuming network node(s) associated with respective decentral participant identifier(s) and/or obligations of decentral network node(s) using the digital twin or a part thereof accessed by data consuming network node(s) associated with respective decentral participant identifier(s).

12. A computer-implemented method for controlling access to a digital twin of a physical entity of a chemical product produced from one or more chemical input materials, wherein the access to the digital twin by one or more decentral data consuming network node(s) of a decentral network is controlled by a decentral data providing network node associated with the digital twin and wherein the digital twin includes a decentral digital twin identifier and at least one measured physical and/or chemical property of the chemical product and/or at least one physical and/or chemical property determined from collected data associated with the production and/or the use of the chemical product, the method comprising:
providing the decentral digital twin identifier,
providing mapping data including data related to the chemical product produced from the one or more chemical input materials interrelated with respective decentral participant identifier(s) associated with decentral participant node(s), wherein the mapping data is generated from the data related to the chemical product produced from the one or more chemical input materials and data related to the decentral participant node(s),
generating access data for at least part of the digital twin based on the mapping data, wherein the access data include the decentral digital twin identifier and one or more authorization rule(s) associated with the decentral digital twin identifier, wherein the one or more authorization rule(s) define access to and/or usage of at last part of the digital twin for decentral data consuming network node(s) associated with the decentral participant identifier(s) included in the mapping data, and
providing the generated access data to the decentral data providing network node for controlling access to at least part of the digital twin by the one or more decentral data consuming network node(s) according to the access data.

13. An apparatus for authorizing access by a decentral data providing network node to a digital twin of a physical entity of a chemical product, wherein the digital twin includes a decentral digital twin identifier and at least one measured physical and/or chemical property of the chemical product and/or at least one physical and/or chemical property determined from collected data associated with the production and/or the use of the chemical product and wherein access data for at least part of the digital twin has been generated and provided to the decentral data providing network node by the apparatus of claim 1, the apparatus comprising:
a digital twin provider configured to provide the digital twin of the physical entity of the chemical product, and
the decentral data providing network node configured to
receive a request to access the digital twin or a part thereof from a decentral data consuming network node, the request including a decentral digital twin identifier associated with the digital twin and a decentral participant identifier associated with the decentral data consuming node,
gathering the digital twin or a part thereof from the digital twin provider based on the received decentral digital twin identifier,
determining, based on the received decentral digital twin identifier and decentral participant identifier, access data and applying the determined access data to the gathered digital twin or the part thereof, and
providing the digital twin or the part thereof according to the applied access data to the decentral data consuming network node or denying access to the digital twin or the part thereof according to the applied access data.

14. A computer-implemented method for authorizing access to a digital twin or a part thereof of a physical entity of a chemical product by a decentral data consuming network node using a digital access element associated with the chemical product, wherein the digital twin includes a decentral digital twin identifier and at least one measured physical and/or chemical property of the chemical product and/or at least one physical and/or chemical property determined from collected data associated with the production and/or the use of the chemical product, the method comprising the steps:
providing the digital access element including a decentral passport identifier and digital twin location data, wherein the decentral passport identifier is or is associated with the decentral digital twin identifier, and
providing-based on the provided digital access element, the decentral digital twin identifier and a decentral participant identifier associated with a decentral data consuming network node requesting access to the digital twin-access to the digital twin as authorized by the apparatus of claim 13.

15. A computer element with instructions, which when executed on one or more computing node(s) are configured to carry out the steps of the method as claimed in claim 12.

16. A computer element with instructions, which when executed on one or more computing node(s) are configured to carry out the steps of the method as claimed in claim 14.

17. A computer element with instructions, which when executed on one or more computing node(s) are configured to be carried out by the apparatus as claimed in claim 1.

18. A computer element with instructions, which when executed on one or more computing node(s) are configured to be carried out by the apparatus as claimed in claim 13.
